(19) United States
(12) Patent Application Publication
(10) Pub. No.: US 2013/0103484 A1
(43) Pub. Date: Apr. 25, 2013

(54) System and Methods for Fulfilling Loyalty Points Redemption Program Rewards

(71) Applicant: Craig McLaughlin, Suwanee, GA (US)

(72) Inventor: Craig McLaughlin, Suwanee, GA (US)

(73) Assignee: Bridge2 Solutions, Inc., Alpharetta, GA (US)

(21) Appl. No.: 13/280,829

(22) Filed: Oct. 25, 2011

(51) Int. Cl. G06Q 30/02

(52) U.S. Cl. 705/14.33

(57) ABSTRACT

Systems and methods for managing a variety of loyalty points redemption programs offered by loyalty program providers (LPPs) for providing fulfillment of loyalty points redemption program rewards to customers who are members of the loyalty points redemption program. Customers are able to redeem loyalty points for eligible goods and services offered by various suppliers and merchants associated with particular loyalty programs, especially enabled for instore pickup. A loyalty points management system hosts a portal that provides a user interface, manages multiple redemption catalogs of eligible goods/services, and manages loyalty points redemption programs for multiple LPPs. Each loyalty points redemption program is subjected to predetermined rules and regulations (business rules) that determine conditions for transactions involving loyalty points. Redeemed goods and services can be picked up by customers at store location of participating suppliers and merchants, or alternatively, can be shipped to a convenient location via a shipping service.

### TECHNICAL FIELD

The present invention relates generally to aspects of a system for fulfillment of loyalty points redemption program rewards using loyalty points, more particularly to systems and methods that allow customers who are members of a loyalty points redemption program to fulfill their desire to redeem their loyalty points for eligible goods or services offered by eligible suppliers associated with the loyalty points redemption program, wherein the system enables customers to order and receive their fulfillment items either in real time while on premises within a supplier's retail establishment, or ordering remotely and then receiving their fulfillment items upon travel to a supplier's retail establishment.

### BACKGROUND

As is known, many different business entities maintain “loyalty points redemption programs” for repeat and high volume customers, as an incentive etc. Such programs are believed to encourage customers to continue to purchase goods or services from the business entity or transact in specific ways such as the use of a specific credit card. These business entities are called “loyalty point issuers” or “loyalty point providers” (LPPs).

A LPP, typically a retailer or service provider, gives “points” to customers who do business with that loyalty point issuer, begin a new relationship with a loyalty point issuer, provide a referral, etc. Those loyalty points are issued by the LPP and accumulated by the issuer in response to repeated or high value transactions by the customer. For example, credit card companies have various loyalty points redemption programs associated with different credit cards. Customers who own a specific type of card that are associated with a particular loyalty points redemption program earn points every time the credit card is used. In another example, an airline company issues points to customers who are members of a particular loyalty points redemption program. Such customers earn points in the form of air miles for flying with the airline.

In many situations, business entities and corporate organizations also participate in “loyalty points redemption programs” for providing performance incentives to productive internal employees and external suppliers or dealers. For example, a car manufacturer can provide incentives in the form of “points” to car dealerships, or sales representatives for generating high sales.

The loyalty points associated with a particular program are recorded and accumulated in a database as part of a loyalty points management system (LPMS). Loyalty points may be redeemed to obtain goods or services, or obtain discounts from the business, etc. The LPMS handles transactions associated with the accumulation of loyalty points and subsequent redemption of such loyalty points for eligible goods and services from a variety of suppliers, merchants and retailers.

Generally, the LPMS maintains business relationships with wholesalers, retailers, suppliers, and merchants to provide goods or services in redemption of loyalty points. In some scenarios, the LPPs also have business relationships with the above-mentioned entities who provide goods and services that can be redeemed by customers using their loyalty points. A customer who is a member of a particular loyalty points redemption program typically receives a written notice about or logs into a web site that displays the details of the loyalty points redemption program and the loyalty points balance for that customer. In turn, the LPMSs allow a loyalty points redemption program member to view a catalog of eligible goods or services available for the redemption of loyalty points, and henceforth select goods or services in the catalog of goods or services.

Those skilled in the art will understand that eligible goods or services having a related dollar value cost that is usually converted by the entity that hosts the LPMS (in association with the LPP) into an equivalent loyalty points value. Members who wish to redeem their loyalty points may then select a particular item from eligible goods or services, and those item(s) are typically drop-shipped to an address selected by the member, via a known shipping service. After the item is redeemed by the customer, the customer's loyalty points are then decreased by an amount corresponding to the points value of the redeemed product.

In recent times, the unprecedented world-wide spread of the use of mobile devices and applications in our everyday life has had a significant effect in the ways in which people find, research, and purchase products and services. As a result of such a ubiquitous use of mobile devices and applications, businesses, merchants, retail establishments heavily rely on the power of mobile technologies in reaching out to customers. From consumers' perspective, the shopping experience becomes more convenient, easy and streamlined with the use of mobile technologies and applications that are designed for online shopping. However, most online shoppers have to wait for a few days (at least overnight under expedited shipping) and consequently do not obtain the benefit of a quick “in-store” pick-up of the purchased items. Even if online shoppers receive the benefit of in-store pick-up of the purchased items, their shopping options are restricted to specific retailers and merchants only who allow the in-store pickup at their retail outlets. To complicate things even further, combining the benefits of online shopping with in-store pickup for members of loyalty points redemption program who can redeem goods and services (using their loyalty points) across a variety of merchants and retailers is a challenging task. It is believed that prior to the present disclosure, no attempt has been in made in the prior art to combine aspects of an inventory management system with an online ordering system, and further in conjunction with a loyalty based system, thus in turn providing the benefit of in-store pickup to customers in a real time (or, virtually real time) manner.

Therefore, there is a long-felt but unresolved need to develop a consolidated approach in developing systems and methods that facilitate customers who are members of particular loyalty points redemption program to shop online by accessing online catalogs of available goods or services via the web or mobile device, across multiple retailers, and to select one or more eligible item(s) for redemption against loyalty points while “in store” in real time, or elect to pick up an item from a near-by store. Most of the prior art systems provide the functionality of in store pickup through specific retail outlets. In other words, businesses, merchants, retail establishments offer in store pickup that is limited mostly to their own retail outlets, and consequently the associated technologies are not versatile to different merchants and retailers.

Since a plurality of retailers or service providers can provide items of goods or services for use in redemption, it is desirable that the system presents to members of particular loyalty points redemption programs a single consolidated catalog containing goods and services across multiple merchants and retailers. Such a system will provide a customer the ability to select a particular item from a particular store, or select a particular item from different stores (even different retail establishments), or to select items from different retail establishments. Furthermore, the system should allow for redemption by customers of a plurality of different loyalty points redemption programs offered by the same or different business entities (LPPs), yet still provide the variety and capability of allowing a customer to redeem their loyalty points at one of a number of different retail or service businesses.

Even further, it is desirable that the system provides customers the ability to manually enter or scan a UPC bar code, SKU, QR code, RFID tag or other such identifiers on an item, using a camera on the mobile device while in-store to determine if that item is in the online catalog of eligible goods or services offered by a particular loyalty points redemption program.

### BRIEF SUMMARY

Briefly described and generally stated, aspects of the present invention relate to a system and methods for allowing customers who are members of a particular loyalty points redemption program to redeem loyalty points for an eligible item of goods or services by looking up an online catalog maintained by a LPMS, and accessible to the customer and then selecting, ordering, and receiving one or more redeemable item(s) within that program catalog, while on premises in a retail establishment, or upon travel to a particular store. Customers who are members of a loyalty points redemption program can access the catalog associated with that loyalty points redemption program via a web browser on a customer's electronic device (such as desktops, laptops, PDAs, tablets, smart phones etc.) or through an app on a customer's mobile device. The system communicates with the LPMS to display the loyalty points available, and an online catalog maintained by the LPMS, and further allows the customer to view details of selected items that are available in the catalog for loyalty points fulfillment. If the customer selects one or more items and places an order, the LPMS communicates with one or more retail or other service establishments that provide fulfillment items (suppliers) to ensure that the item(s) are still available and begins processing the customer's order. Customers can elect via a web-based interface or a mobile device interface to pick up the item while in store (real time) or upon travel to that particular store.

Processing a customer's order usually involves the LPMS automatically communicating an order for the particular item(s) to a selected merchant (and/or to the store where the customer is present), and the customer then can pick up the item(s) while in store. After the order is placed, the LPMS deducts an appropriate predetermined number of loyalty points corresponding to the item(s) chosen by the customer. In turn, the merchant or retailer informs the respective store inventory system that the item is (a) deemed sold for POS and accounting purposes, and (b) for purpose of inventory management and reorder.

According to one aspect, a merchant or retailer can also provide the functionality of accessing an online catalog and looking up available goods or services to customers while customers are inside a store location. Such a look up is performed via a general purpose computer at the store, a smartphone device, a tablet PC, or any other computing device capable of communicating via the internet, or, linked through a merchant store's POS system.

According to another aspect, customers can scan a UPC bar code, SKU, QR code, RFID tag or other such identifiers on an item, using a camera on the mobile device while in-store to determine if that item is in the online catalog of eligible goods or services. As can be understood, a customer who is a member of a particular loyalty points redemption program can also redeem loyalty points for an eligible item of goods or services by looking up an online catalog while not inside a store and choosing to pick up the item later from a nearby store, or having it shipped to a convenient location via a shipping service. Customers can access the online catalog via a computer or a mobile device prior to pick-up of the item.

According to yet another aspect, a plurality of retailers or service providers may provide items of goods or services for use in redemption, so that a customer has the ability to select a particular item from a particular store, or select a particular item from different stores (even different retail establishments), or to select items from different retail establishments. Similarly, the sstem allows for redemption by customers of a plurality of different loyalty points redemption programs, for different business entities, yet still provide the variety and capability of allowing a customer to redeem their loyalty points at one of a number of different retail or service businesses.

### BRIEF DESCRIPTION OF THE DRAWINGS

The accompanying drawings illustrate one or more non-limiting and non-exhaustive embodiments of the present disclosure, and, together with the written description, serve to explain the principles of the disclosure. Wherever possible, the same reference numbers are used throughout the drawings to refer to the same or like elements of an embodiment, and wherein:

FIG. 1 illustrates a high-level overview of an embodiment of a loyalty points management system (LPMS), in an exemplary loyalty points transaction environment.

FIG. 2 shows an exemplary LPMS architecture comprising various software modules, engines and other similar elements, according to one embodiment of the present system.

FIG. 3 shows a sequence diagram illustrating computer-implemented method steps involving various components of an embodiment of the present system and their interactions with each other, according to one embodiment of the present system.

FIG. 4 is a flowchart showing an exemplary computer-implemented process illustrating various steps performed by a loyalty points provider (LPP) in processing a loyalty points transaction, according to one embodiment of the present system.

FIG. 5 (consisting of FIG. 5A, FIG. 5B, FIG. 5C, and FIG. 5D) is a flowchart showing details of computer-implemented steps performed by an embodiment of the LPMS in processing a loyalty points transaction.

FIG. 6 is an exemplary catalog table illustrating a LPMS-maintained catalog related to redeemable goods and services available to members of loyalty points redemption programs, according to one embodiment of the present system.

FIG. 7 is an exemplary merchant table illustrating a LPMS-maintained list of several merchants and retailers who supply goods and services to members of loyalty programs, according to one embodiment of the present system.

FIG. 8A is an exemplary LPMS-maintained loyalty points conversion table indicating various loyalty points providers, their rates of conversion of loyalty-points to dollars, and other exemplary representative details of their respective loyalty points redemption programs, according to one embodiment of the present system.

FIG. 8B is an exemplary LPMS-maintained merchant eligibility table indicating various eligibility conditions for merchants and retailers who are suppliers of goods and services associated with respective loyalty points redemption programs, according to one embodiment of the present system.

FIG. 8C is an exemplary LPMS-maintained catalog presentment table indicating various presentment criteria as displayed in connection with a redemption catalog to members of loyalty points redemption programs, according to one embodiment of the present system.

FIG. 9 is an exemplary LPMS-maintained customer table illustrating customer information of members associated with a loyalty points redemption program, according to one embodiment of the present system.

FIG. 10 is an exemplary LPMS-maintained order history table illustrating transaction history information of members associated with a loyalty points redemption program administered by the LPMS, according to one embodiment of the present system.

FIG. 11 is a screenshot of an exemplary LPMS user interface for members to enter their login credentials.

FIG. 12 is a screenshot of an exemplary LPMS user interface displaying a catalog of eligible goods and services, associated with a particular loyalty points redemption program, according to one embodiment of the present system.

FIG. 13 is a screenshot of an exemplary LPMS user interface displaying various product sub-categories in a catalog of eligible goods and services, associated with a particular loyalty points redemption program, according to one embodiment of the present system.

FIG. 14 is a screenshot of an exemplary LPMS user interface displaying a list of items in a product sub-category in a catalog of eligible goods and services, associated with a particular loyalty points redemption program, according to one embodiment of the present system.

FIG. 15 consisting of FIG. 15A, FIG. 15B and FIG. 15C are screenshots of exemplary LPMS user interfaces showing detailed specifications (including features, summary and attributes respectively) of an item in a catalog of eligible goods and services, associated with a particular loyalty points redemption program, according to one embodiment of the present system.

FIG. 16 is a screenshot of an exemplary LPMS user interface illustrative of an online “shopping cart” prior to placement of an order by members of a particular loyalty points redemption program, in an exemplary transaction using loyalty points, according to one embodiment of the present system.

FIG. 17 is a screenshot of an exemplary LPMS user interface displaying a list of merchant store locations where an item is available to be picked up, according to one embodiment of the present system.

FIG. 18 is a screenshot of an exemplary LPMS user interface showing summary of an order in a transaction using loyalty points, according to one embodiment of the present system.

FIG. 19 is a screenshot of an exemplary LPMS user interface showing LPMS-provided final confirmation of an order to a customer, in a transaction using loyalty points, according to one embodiment of the present system.

### DETAILED DESCRIPTION OF DISCLOSED EMBODIMENT

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims.

### DEFINITIONS/GLOSSARY

Customer: an entity (individual, business, etc.) that participates in one or more loyalty points redemption program (defined below), offered by one or more loyalty points provider (defined below), and completes transactions, earns loyalty points and places orders for redeeming loyalty points (defined below) from retailers and merchants who provide fulfillment items. According to aspects of the present disclosure, a customer performs transactions and places orders by interacting with an online portal hosted within an embodiment of the loyalty points management system (defined below). Generally synonymous with members of a loyalty points redemption program.
Distributor: Generally synonymous with Merchant (defined below) or Supplier (defined below) of goods and services
Loyalty Points: a form of an incentive reward currency offered by loyalty points providers (defined below) to customers, productive employees, suppliers, business partners and the like. As referred to herein, loyalty points are usually disbursed through a loyalty points redemption program (defined below), wherein loyalty points comprise a generic unit of reward currency in the form of numerical points, cash-back dollars, rebates, frequent flyer miles, gift cards, and the like.
Loyalty points redemption program: a marketing and/or promotions utility to reward loyalty points to members of loyalty points redemption programs. Generally, a loyalty points redemption program comprises a predetermined criteria defined by the LPP in conjunction with the entity that hosts the LPMS. Such criteria generally determine eligibility conditions for redeeming loyalty points through eligible goods and services from suppliers (defined below). Loyalty points redemption programs can be further subdivided into different tiers or sub-programs that are offered by the same LPP, but are generally associated with slightly different criteria. As will be understood, customers can typically qualify to move from one tier to another based on various business or marketing criteria.
Loyalty Points Provider (LPP): an entity that provides or issues loyalty points, according to one or more loyalty points redemption program (defined above). Examples of LPPs include (but not limited to) retailers, merchants, corporate organizations, car dealerships, banks or financial institutions, airline companies, hotels, restaurants, movie theaters, and the like.
Loyalty Points Management Systems (LPMS): a system constructed as described in this document, that enables administering, management, monitoring, of one or more loyalty points redemption programs offered by loyalty points providers according to predefined criteria set by the loyalty points redemption programs. Generally, entities that host an embodiment of the LPMS maintains business relationships with multiple merchants and retailers who sell or provide goods and services in the redemption of loyalty points.
Merchant: an entity or supplier that provides or sells goods and/or services to customers. As used herein, generally comprises an entity that provides a store location and/or a warehouse location for sale and/or storage and fulfillment of goods and services. Generally, merchants can also provide availability of shipping options to customers (defined above) as a method of delivery of sold items and products. As used herein, merchants communicate with the LPMS (defined above) for inventory management of goods and services that can be redeemed by customers who are members of a loyalty points redemption program.
Redeem: an act of trading loyalty points via a loyalty points redemption program involving placing an order and receiving goods and services offered by merchants (defined above), wherein the loyalty points are usually redeemed for redeemable and available goods and services.
Redemption: realization or fulfillment of a reward (usually in the form of goods and services) using loyalty points (defined above) offered by a loyalty points provider (defined above) through a loyalty points redemption program (defined above), i.e. this is the act of trading points for goods and/or services.
Redemption item: a particular item of goods or services that are eligible for provision to a customer in redemption of a number of loyalty points via a loyalty points redemption program.
Retailer: Generally synonymous with Merchant.
Supplier: Generally synonymous with Merchant.
Wholesaler: Generally synonymous with Merchant.

### Overview

For the purpose of promoting an understanding of the principles of the present disclosure, reference will now be made to the embodiments illustrated in the drawings and specific language will be used to describe the same. Reference throughout this specification to “one aspect” or “an aspect” means that a particular feature, methodology or characteristic described in connection with the embodiment is included in at least one embodiment of the present invention. Furthermore, the appearances of the phrases “in one embodiment” or “in an embodiment” in various places throughout this specification are not necessarily all referring to the same embodiment. Furthermore, the particular features, methodologies or characteristics may be combined, for example, into any suitable combinations and/or sub-combinations as will occur to one skilled in the art. Nevertheless, it will be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Briefly described, one form of the present disclosure describes a system and method for the transformation of loyalty points (associated with loyalty points redemption programs) offered by a variety of LPPs, such as (but not limited to) airline companies, hotels, restaurants, credit card companies, financial institutions, etc. into fulfillment of rewards earned by members of loyalty points redemption programs, wherein members of the loyalty points redemption programs are able to select eligible goods and services from suppliers, merchants and retailers in real-time by the use of a mobile device while inside the premises of the establishments of suppliers, merchants and retailers. The system, herein referred to as the LPMS, determines the availability and eligibility of goods and services to members of loyalty points redemption programs. For example, in a particular loyalty points redemption program offered by an airline company, members of the loyalty program earn two (2) loyalty points to members for every mile flown by members. In another example, a credit card company can issue 5 (five) loyalty points for every dollar transaction performed using a particular type of credit card to members who use their credit cards.

Aspects of the present disclosure generally relate to systems and methods for fulfilling loyalty points redemption program rewards using loyalty points, offered by loyalty points providers (LPPs) to members of a loyalty points redemption program through a loyalty points management system (LPMS). Loyalty points are typically redeemed for loyalty points redemption program eligible goods or services from multiple distributors, wholesalers, merchants and retailers who are suppliers of goods and services and who have business relations with the entity that hosts the LPMS, and/or with LPPs. As will be understood, these terms generally referring to suppliers of goods and services have been used synonymously in the present disclosure. It will be even further understood that although the description which follows is primarily discussed with the LPMS being a separate system than the LPP and suppliers of goods/services, embodiments of the disclosed LPMS have broader applicability that allow the LPMS to be housed in one or more LPPs, in alternate embodiments of the present system. Even further, embodiments of the present LPMS can be utilized in scenarios where the entity that hosts the LPMS can provide eligible goods/services to customers by itself, or in connection with loyalty points redemption programs offered by various LPPs.

Additional aspects of the disclosure include the ability of members of a loyalty points redemption program to browse an online catalog of eligible goods and services maintained by the LPMS, and offered by various merchants and retailers who are suppliers of eligible goods and services. Further aspects of the disclosure include storage of various kinds of information associated with members of a loyalty points redemption program. Examples of such information include names, addresses, loyalty points balance for respective members, history of previous orders, and several other member-related attributes. Even further, aspects of the disclosure include the ability to allow members of a loyalty points redemption program to select eligible goods and services across multiple retailers and merchants, for redemption against loyalty points while “in store,” or elect to pick up an item in a near-by store, or alternatively, have the item drop-shipped to a member-specified location.

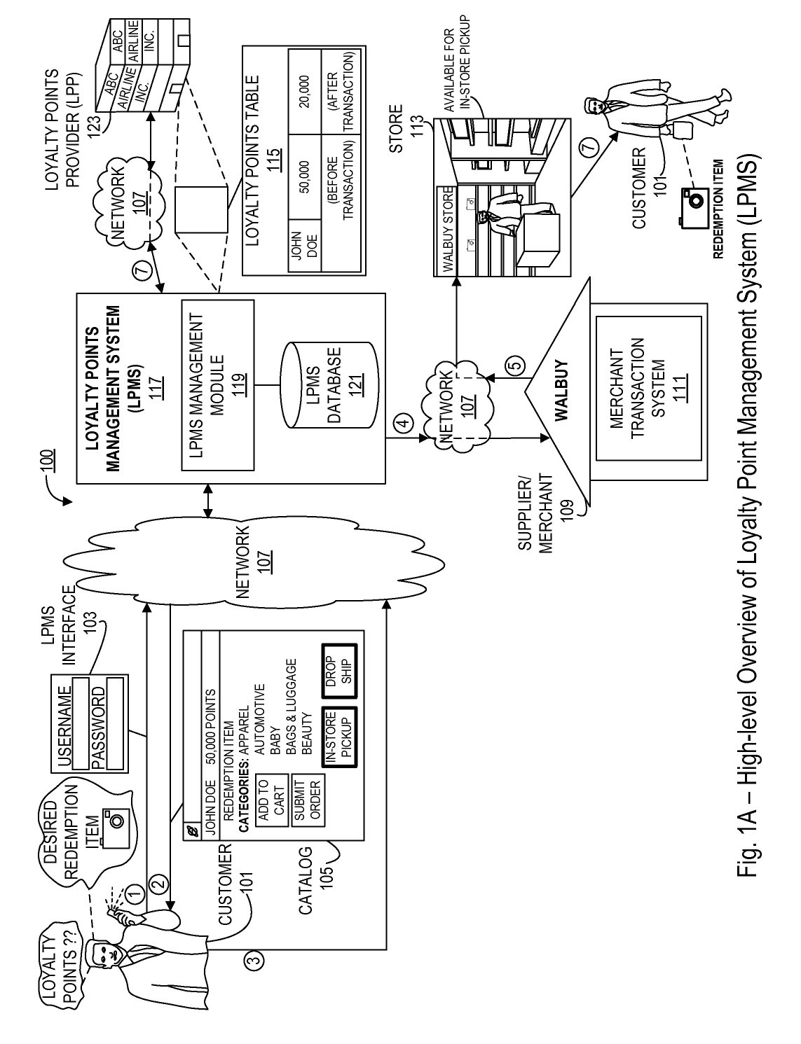

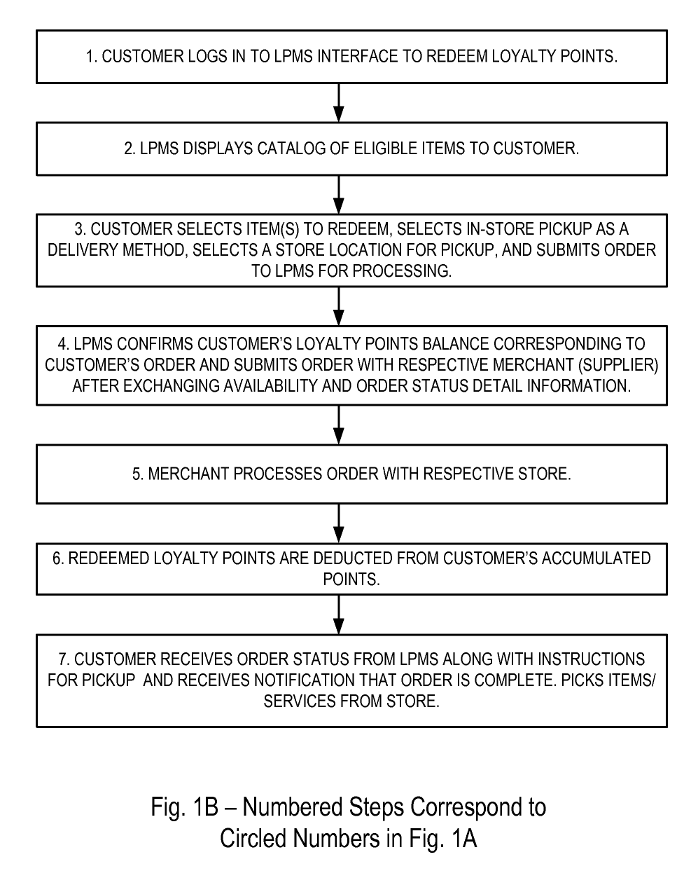

Referring now to the figures, FIG. 1 illustrates an exemplary environment 100 wherein an embodiment of a loyalty points management system (LPMS) 117 manages a loyalty points redemption program for a loyalty points provider (LPP) 123, in accordance with various aspects of the present disclosure. Also shown is an exemplary loyalty points transaction involving a customer 101 who is a member of a particular loyalty points redemption program offered by the LPP 123, and a merchant 109 that offers eligible items (goods and services) redeemable by the customer's loyalty points. As will be understood, according to one aspect, a loyalty points transaction begins with a customer 101 logging into the LPMS 117 to redeem items using the customer's loyalty points, and eventually ends with the customer picking up the redeemed items from a store 113 (owned or operated by the merchant 109). Further, it will be understood and appreciated that customers 101 can pick up redeemed items while inside the premises of a store 113 or, alternatively by traveling to the store 113.

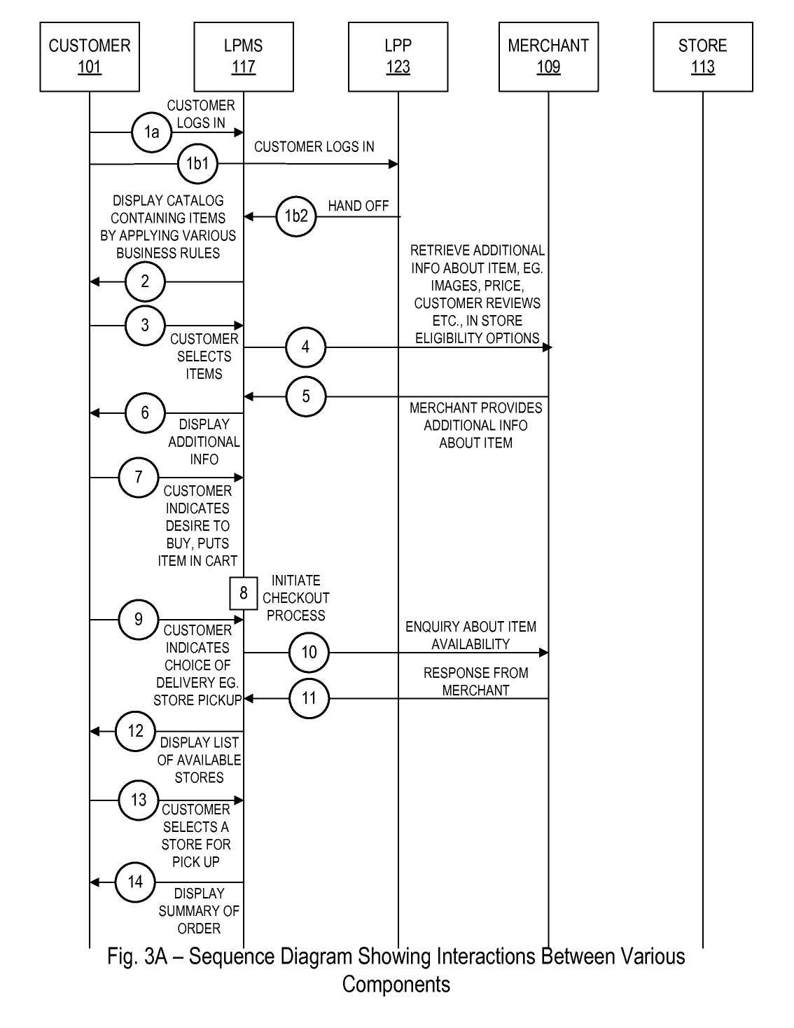

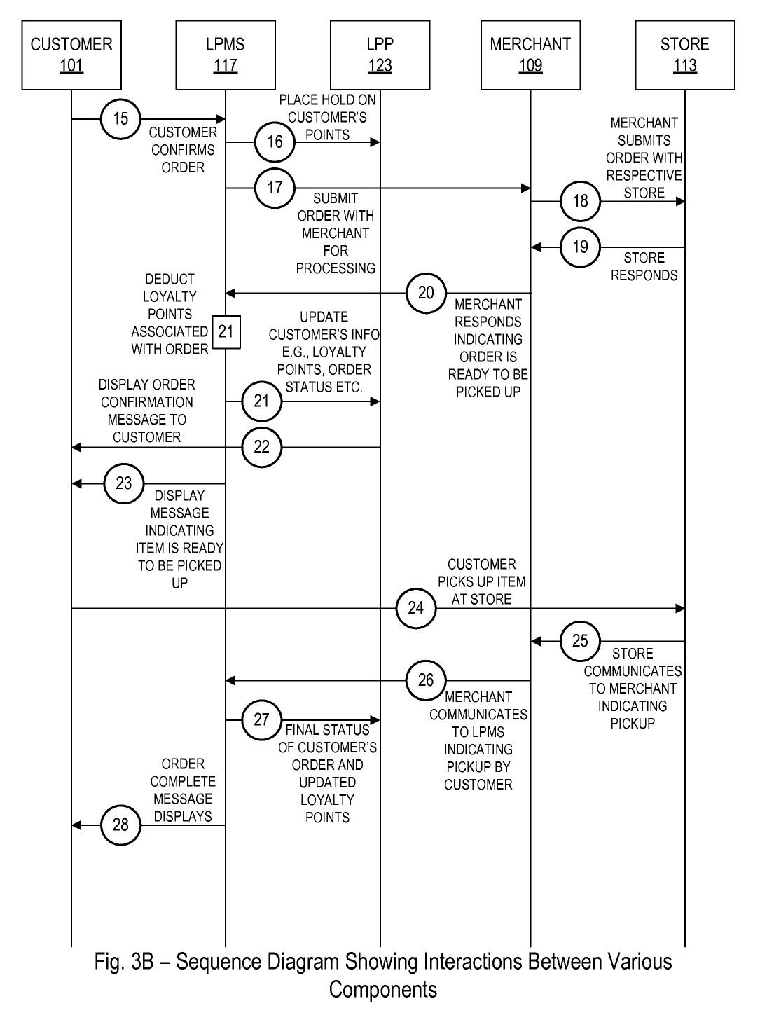

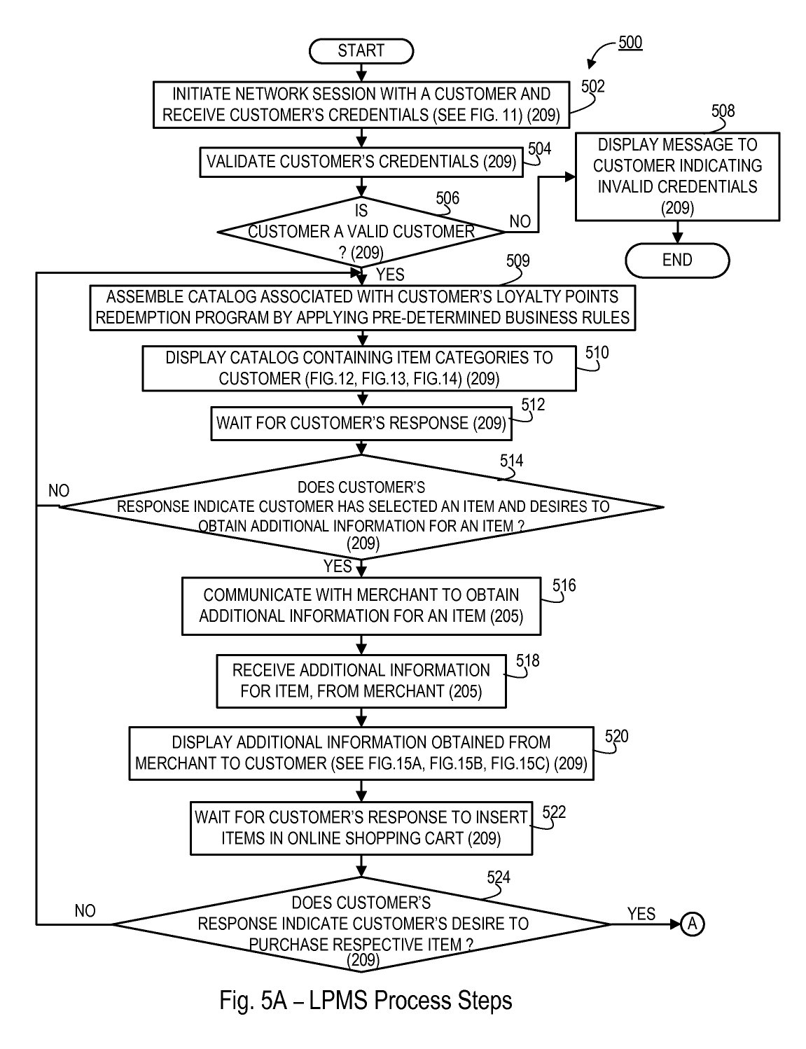

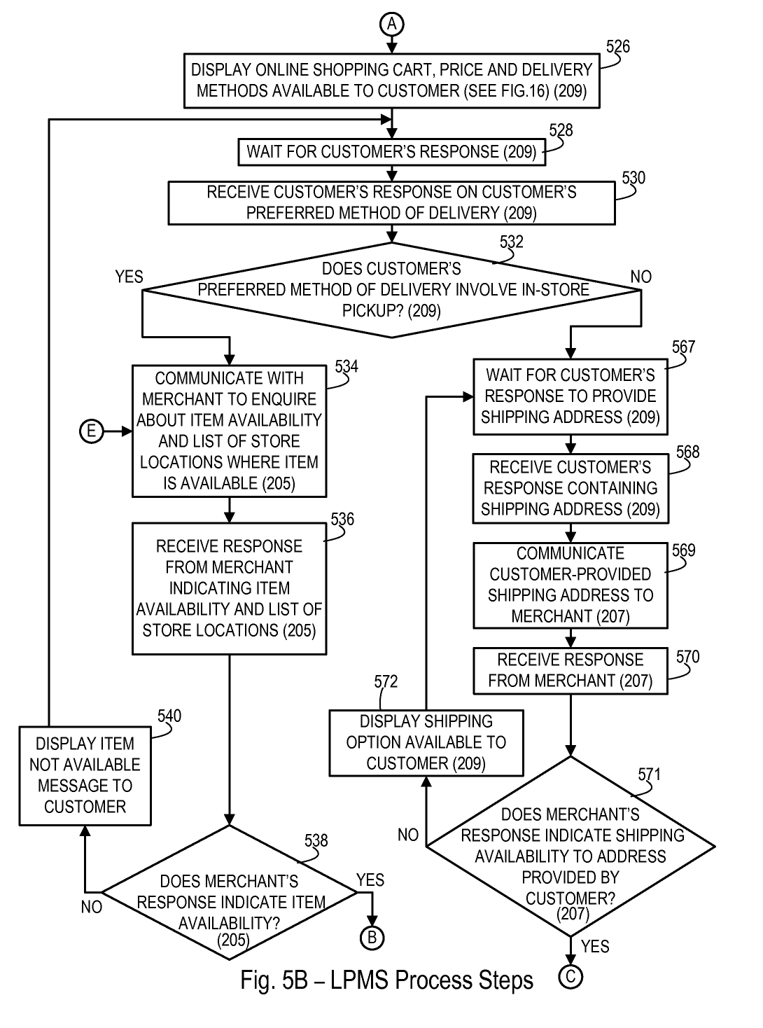

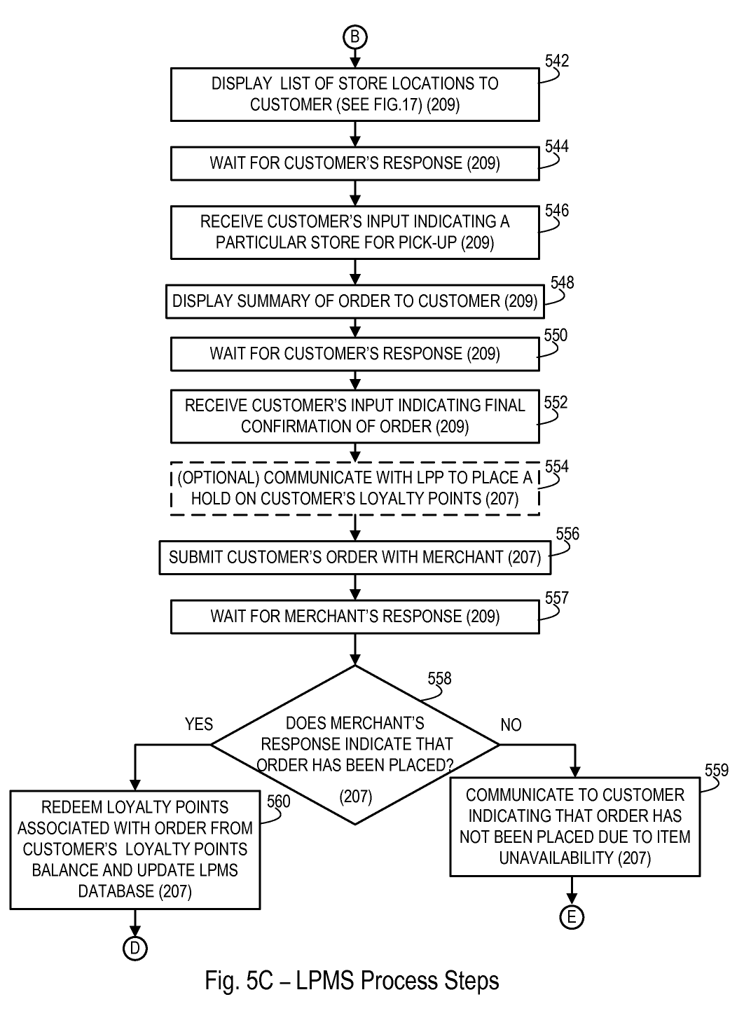

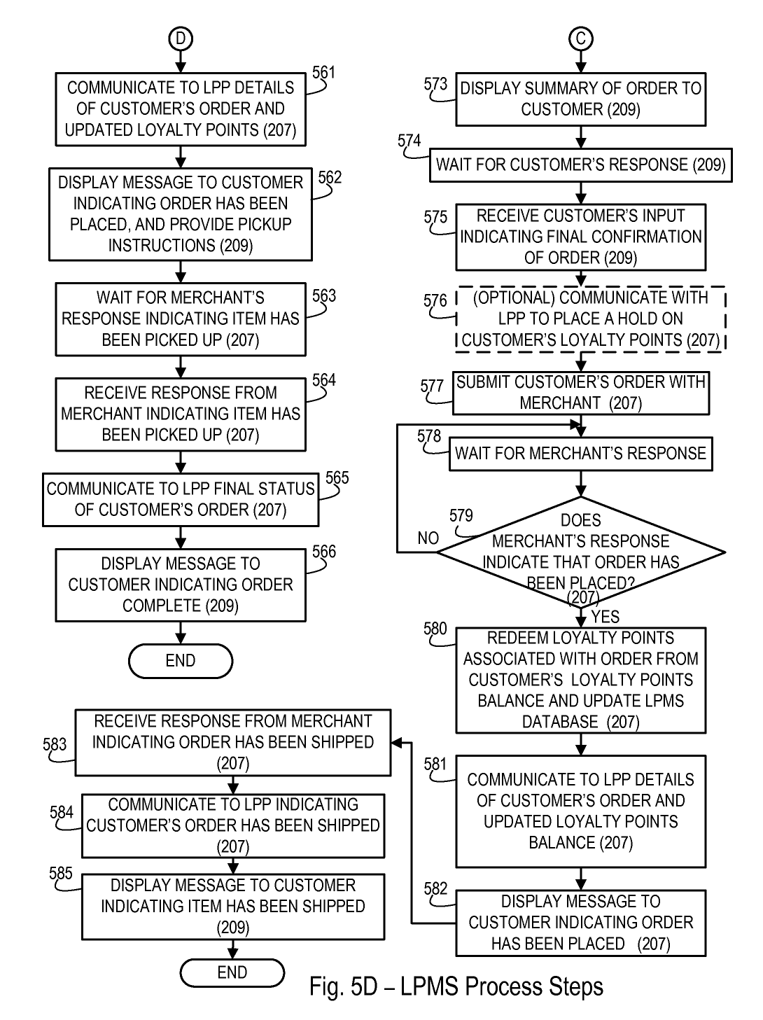

Generally, by way of example, and not by way of limitation, a high level summary of actions involved in an exemplary loyalty points transaction is shown in FIG. 1, with the help of a sequence of numbered steps indicated as steps “1” through “7”. The steps are annotated as circled numbers in the drawing itself, while actions corresponding to these steps are spelt out in the bottom of the drawing. As will be understood and appreciated by a person skilled in the art, because of the real-time nature of the transaction, steps involved in a loyalty points transaction can be performed while the customer is inside a store location, or alternatively, the customer can elect to pick up items by traveling to a store location. Detailed steps involved in the interactions between the various components involved such as customers 101, an embodiment of the LPMS 117, a LPP 123, and a merchant 109 will be explained with a sequence diagram in connection with FIG. 3. Furthermore, details of the computer-implemented method steps performed by an embodiment of the LPMS in processing a loyalty points transaction will be discussed in FIG. 5.

According to one aspect of the present disclosure, a loyalty points transaction involves customers 101 accessing their loyalty points redemption program account administered by the LPMS 117, through an exemplary LPMS user interface 103. Management and administration of loyalty points redemption program account involves, among other things, keeping a balance of loyalty points balance (or, loyalty points accounts balance) for members of loyalty points redemption program. In connection with FIG. 1, the customer 101 exemplarily called “John Doe” is a member of a particular loyalty points redemption program offered by a fictitious LPP 123 called ABC Airline Inc., the loyalty points redemption program being managed and administered by the LPMS 117. It can be further seen from FIG. 1, an exemplary loyalty points table 115 (stored in LPP 123 and LPMS 117) indicates that John Doe has a loyalty points balance of 50000 (fifty thousand) at the beginning of an exemplary loyalty points transaction. Eventually, when customer John Doe picks up items from store 113, the loyalty points transaction is complete, the balance of John Doe's loyalty points reducing to 20000 (twenty thousand). Further details of the steps included in a loyalty points transaction will be described with a detailed sequence diagram and a flowchart in FIG. 3 and FIG. 5 respectively.

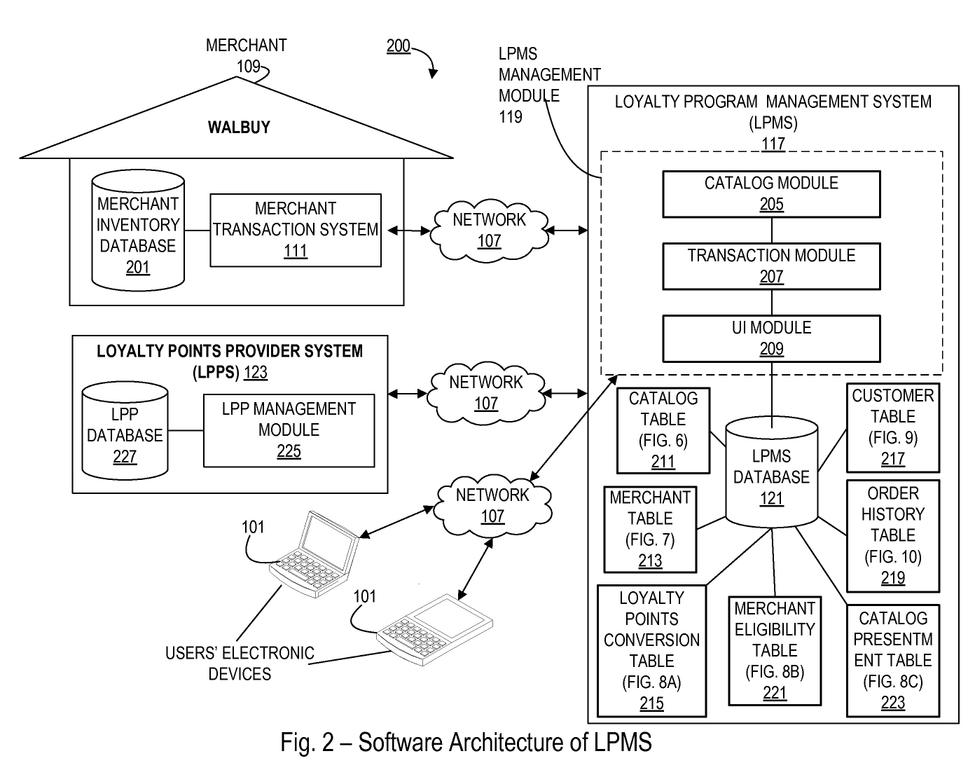

As shown in FIG. 1, an embodiment of the LPMS 117 includes a LPMS management module 119 and an LPMS database 121 for performing the tasks of managing loyalty points redemption programs of a plurality of LPPs 123, and will be described in greater detail in this disclosure. Generally, the LPMS management module 119 includes various software algorithms and sub-modules for purposes of hosting/administration of LPMS user interfaces, management of customer information including authentication of valid customers, management of multiple catalogs of eligible goods and services for a variety of loyalty points redemption programs offered by various LPPs 123, enablement of various real-time electronic status exchanges related to a customer's transaction involving the LPP 123 and the merchant 109, and various other such aspects. Architectural details of one embodiment of the LPMS 117 showing constituent software modules/components of the LPMS management module 119 are shown in FIG. 2.

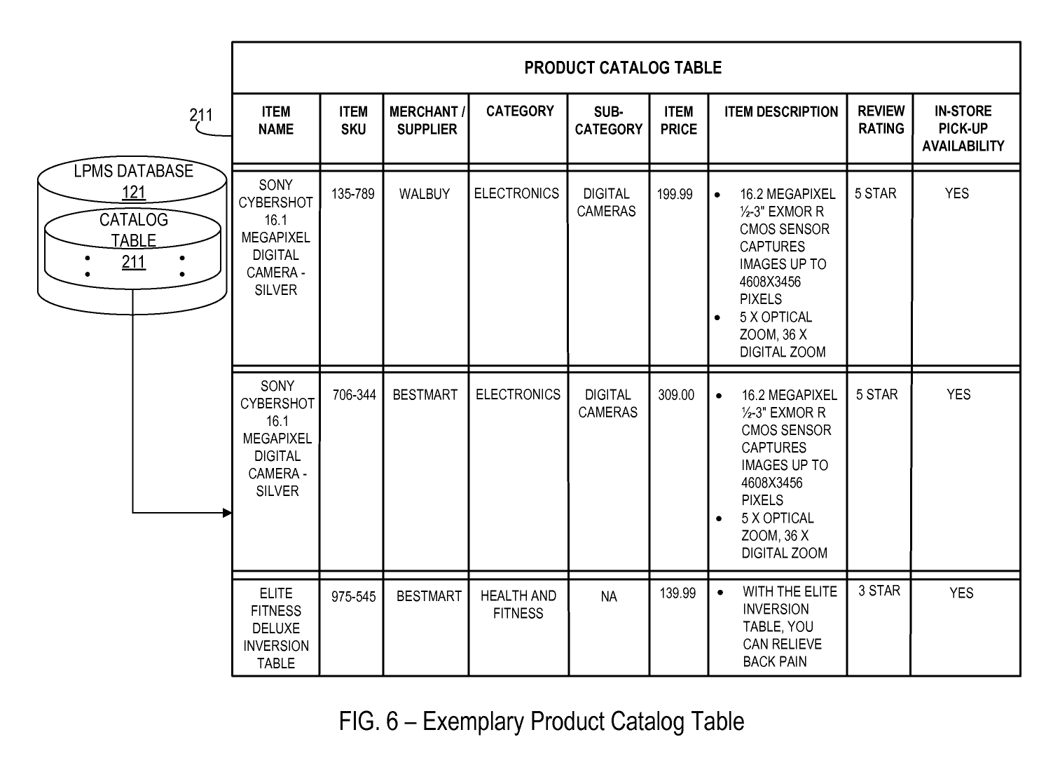

According to aspects of the present disclosure, data processed by various software modules/components of the LPMS management module 119 and pertaining to loyalty points transactions along with other information relating to the LPMS are stored in a LPMS database 121. Examples of such data include (but are not limited to) various loyalty points redemption programs from a variety of LPPs 123, item catalog related attributes such as item SKU number, technical specification, availability of items, pricing, customer information, history of previous transactions performed by customers, etc. Illustrative data tables stored in the LPMS database 121 and storing such exemplary data are indicated in FIG. 2. Additional details of the illustrative data tables will be discussed in connection with FIG. 6-FIG. 10.

According to an aspect of the present disclosure, a loyalty points transaction begins with customers 101 accessing the LPMS 117 using a LPMS user interface 103 hosted by the LPMS 117, via network connections 107 using devices such as computers (e.g. laptops, desktops, severs, tablet computers, etc.) or mobile computing devices (e.g. smart phones) capable of accessing the world wide web. Generally speaking, and as will be understood by a person skilled in the art, the LPMS interface 103 is a webpage owned by the LPMS 117, accessible through a software program such as a web browser by members of a loyalty points redemption program. Members of a loyalty points redemption program can review their loyalty points balance, history of previous transactions and can also perform transactions involving loyalty points, if they desire. Examples of commonly used web browsers include but are not limited to well known software programs such as Microsoft's Internet Explorer, Mozilla Firefox, Apple Safari, Google Chrome, and others.

According to one embodiment of the present disclosure, the LPMS interface 103 can also be configured as a mobile device application (app) such as that available for the popular Apple® iPhone® and Google® Android® mobile device operating systems, for allowing a customer to log on to their loyalty points redemption program account, and perform transactions involving loyalty points, if they desire. According to another embodiment, the LPMS user interface configured as a mobile device application can co-exist jointly with the LPMS user interface accessible through a web browser.

According to one aspect of the present disclosure, the LPMS user interface 103 is hosted in an embodiment of the LPMS 117 that is installed on a physical server or a general purpose computer in a facility, the LPMS 117 being accessible via one or more network connections 107. According to another embodiment, the LPMS 117 is hosted on a virtual computer (connected to one or more network connections 107) housed in a facility. According to yet another embodiment, the LPMS 117 resides in a third party server in a cloud computing environment and communicates with LPPs 123, merchants 109, and customers 101 via one or more network connections 107.

Furthermore, it will be understood by one skilled in the art that communication over network connections 107 typically involves the usage of one or the other services, e.g., a Web-deployed service with client/service architecture, a corporate Local Area Network (LAN) or Wide Area Network (WAN), or through a cloud-based system. Further, as will be understood and appreciated, various networking components like routers, switches, hubs etc., are typically involved in communications involving the customer 101, the LPMS 117, the LPP 123, and the merchant 109. Although not shown in FIG. 1, it can also be further understood that such communication may include one or more gateways/firewalls and encryption methods that provide information security from unwarranted intrusions and cyber attacks. Detailed steps included in the (possibly real-time) communications in connection with a loyalty points transaction involving customers 101, an embodiment of the LPMS 117, a LPP 123, and a merchant 109 are explained with a sequence diagram in FIG. 3. Various actions described in connection with the exemplary loyalty points transaction of FIG. 1 will now be described next.

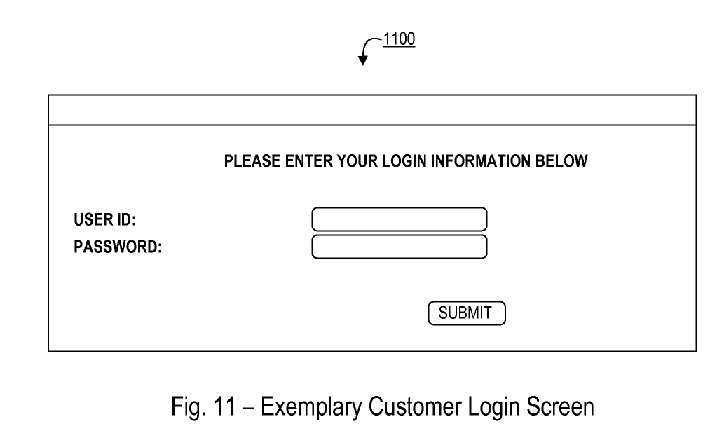

As indicated by step 1 shown in FIG. 1, customers 101 access their loyalty points redemption program accounts administered by the LPMS 117, through an exemplary LPMS user interface 103 for a loyalty points transaction. It will be understood that customers access their loyalty points redemption program account and can perform loyalty points transactions using Internet enabled computing devices such as laptops, desktops, smart phones etc. Moreover, it will also be understood that customers can access their loyalty points redemption program accounts and perform loyalty points transactions anywhere and anytime, and not limited to a store location as displayed exemplarily in FIG. 1. For instance, customers can perform loyalty points transactions while at work, or from home, or other places and can later travel to a store location to pickup the goods/services redeemed by the loyalty points transaction. Alternatively, customers can have the goods/services delivered via a shipping service. Detailed steps of a process performed by an embodiment of the LPMS 117 in an exemplary customer transaction involving loyalty points including options for in-store pickup and shipping delivery, are shown with a flowchart in FIG. 5. An exemplary login screen of a LPMS user interface 103 is shown with a screenshot in FIG. 11. After successful login by a customer 101, the LPMS 117 displays (at step 2) a webpage containing a catalog 105 of eligible goods and services to the customer 101.

As will be understood and appreciated, a catalog of goods and services typically comprises a redemption catalog displaying a list of eligible goods and services, wherein the redemption catalog is associated with a particular loyalty points redemption program, and is dynamically assembled by the LPMS 117 in real-time. In other words, loyalty points redemption programs can have different catalogs of eligible goods and services, associated with different loyalty points redemption programs, offered by the same or different LPPs, wherein the goods and services are offered by a variety of suppliers, retailers and merchants. The catalog displayed to a customer is specific to a loyalty program and is associated with specific eligible merchants who provide specific eligible products via specific methods of delivery. According to one aspect, the LPMS 117 is equipped to handle different loyalty points redemption programs offered by a multitude of LPPs, wherein the loyalty programs can offer. Customers who are members of such loyalty points redemption programs can redeem eligible goods and services from a variety of suppliers, if such items are available from the respective suppliers.

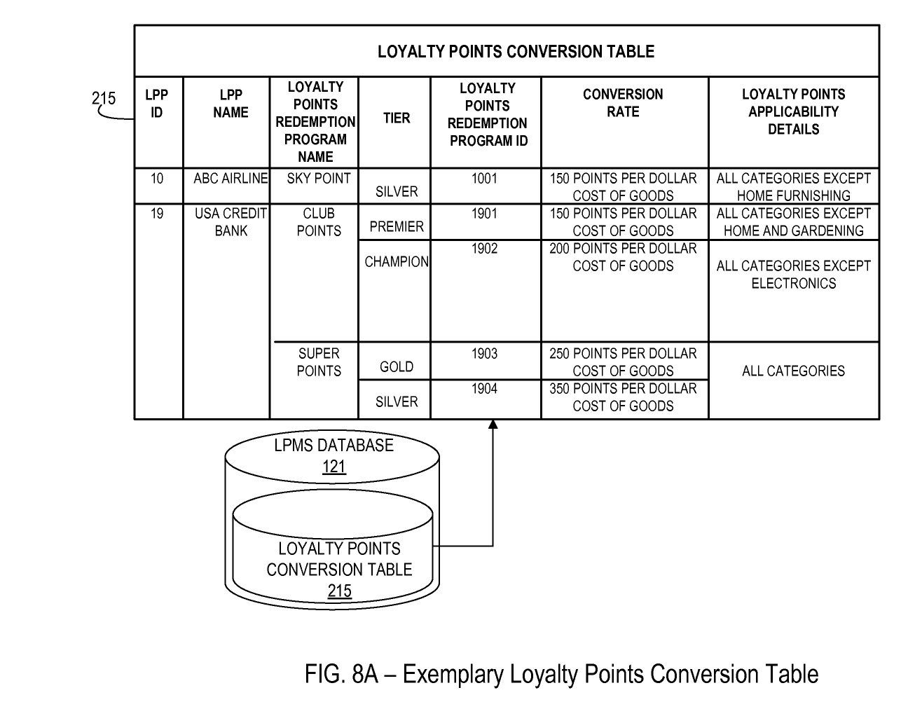

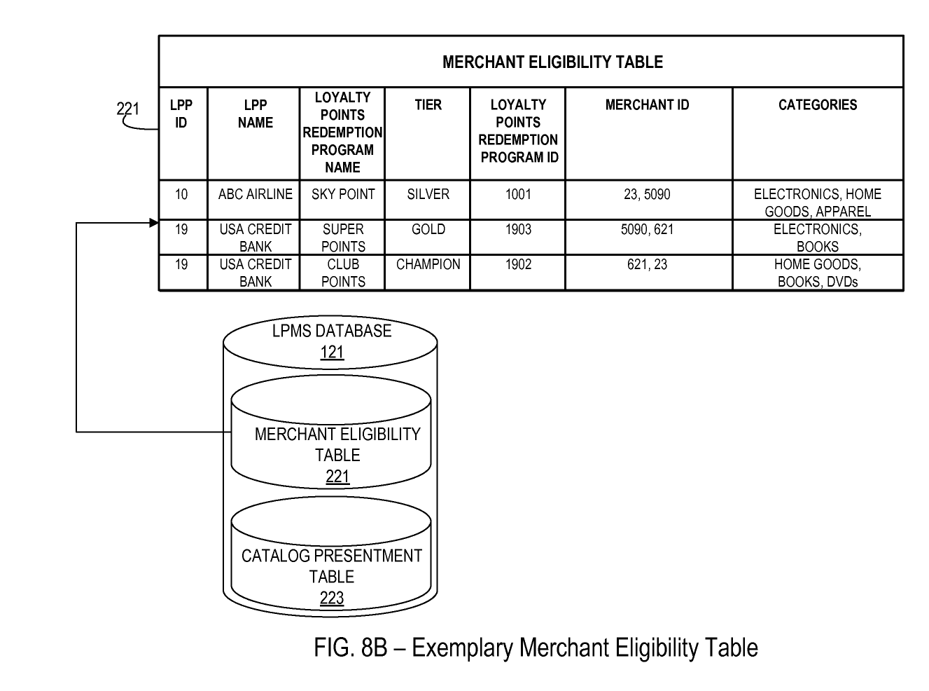

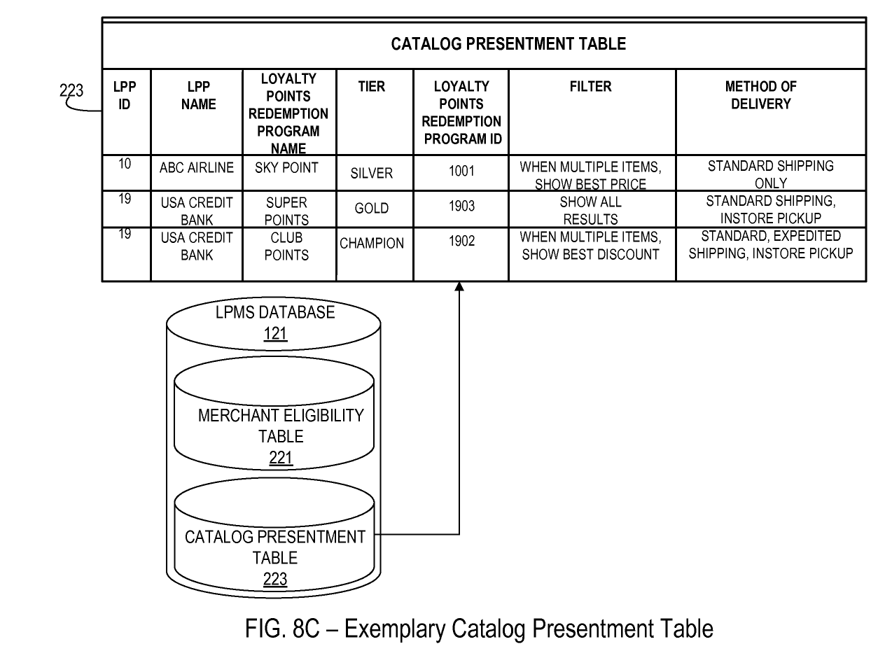

It will be apparent to those skilled in the art that, according to aspects of the present disclosure, the LPMS 117 allows selection of items (by customers) based upon their eligibility as well as their availability. Generally speaking, eligibility of an item is decided on the basis of various criteria or business rules (for example, discussed exemplarily in connection with FIG. 8C) that are predetermined by the LPP and/or the participating merchants (suppliers) associated with the loyalty programs offered by the LPPs. As refereed to herein, redeemable items are generally synonymous with eligible or program-eligible items. Further, eligibility also applies to merchants (suppliers) who are qualified (on the basis of business rules) as participating merchants (suppliers) to offer items to customers via a loyalty points program. On the other hand, it will be understood that the concept of availability applies to an eligible item being available from participating merchants (suppliers) to customers for in-store pickup or drop-ship delivery. Thus, as will be better understood from the discussions that follow, the LPMS 117 is involved in real time and non-real time communications with suppliers, merchants and retailers for updating the catalog at the LPMS, and also for inventory management at the suppliers, merchants and retailers. As will be further understood, the catalog 105 is updated by the LPMS 117 frequently to reflect changes in availability, quantity, pricing, or any inventory changes as communicated by the supplying merchants and retailers.

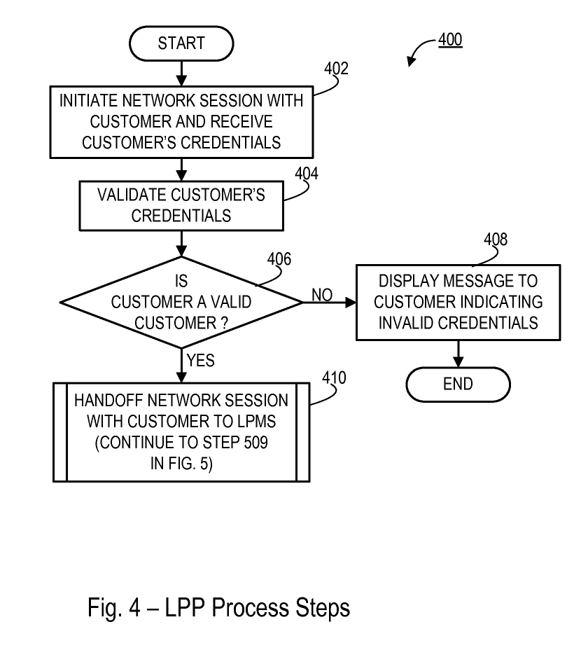

Although not shown in FIG. 1, it will be understood that in an alternate embodiment of the present disclosure, customers 101 can access their loyalty points redemption program using a user interface hosted by the LPP 123 for a loyalty points transaction. In such a case, the LPP routes the customer session for the rest of the transaction to the LPMS 117 after successful authentication of the customer's login credentials. Steps involved in routing the customer session will be discussed in connection with a flowchart in FIG. 4. It will be further understood that the routing of a customer session is performed seamlessly in such a manner that the customer lands in a webpage displaying the catalog 105 of eligible goods and services, and thereafter the customer session is handled by the LPMS 117.

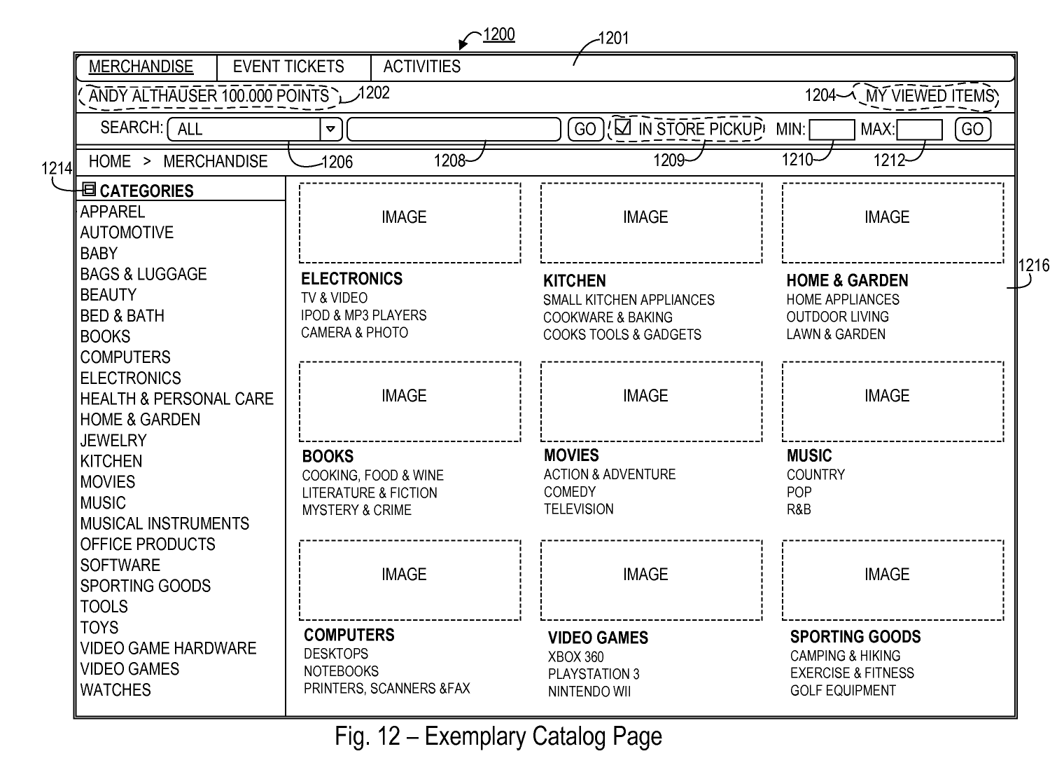

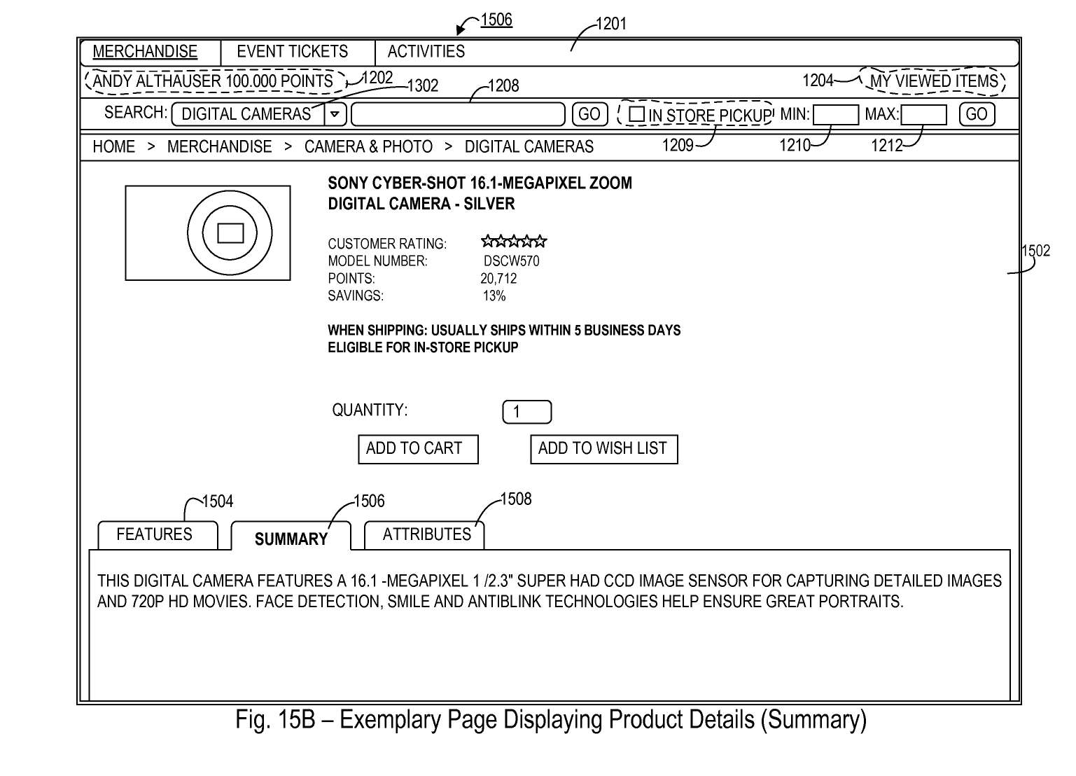

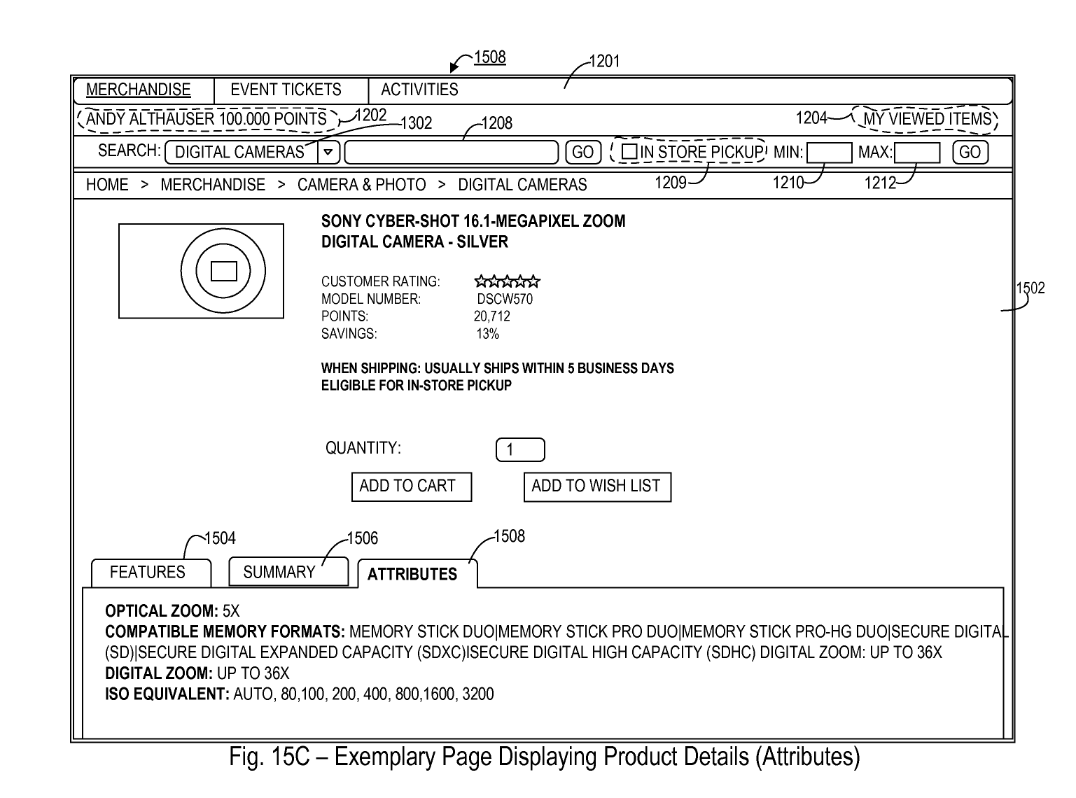

Still referring to FIG. 1, after the catalog 105 is displayed (at step 2) to customers 101, customers 101 browse through the catalog 105 by selecting one or more eligible items of goods and services. As will be understood by a person of ordinary skill, customers can review cost of items, detailed specification of items, opinions about items provided by other customers, and various other item related attributes displayed in the catalog. Exemplary screenshots showing a catalog of eligible goods and services, along with additional product information is shown in connection with FIG. 12-FIG. 15 (including FIG. 15A, FIG. 15B, and FIG. 15C).

It will be appreciated that according to one aspect of the present disclosure, customers can be allowed to obtain additional product information through various other mechanisms as well. Such means include, for example, scanning inventory related attributes readable from a UPC bar code, SKU, QR code, RFID tag or other such identifiers on an item, using a camera on a mobile device or direct entry by customers into their mobile devices while in-store to determine if that item is in the online catalog 105 of eligible goods and services. According to another aspect, electronic readers provided by the store 113 provide additional product information.

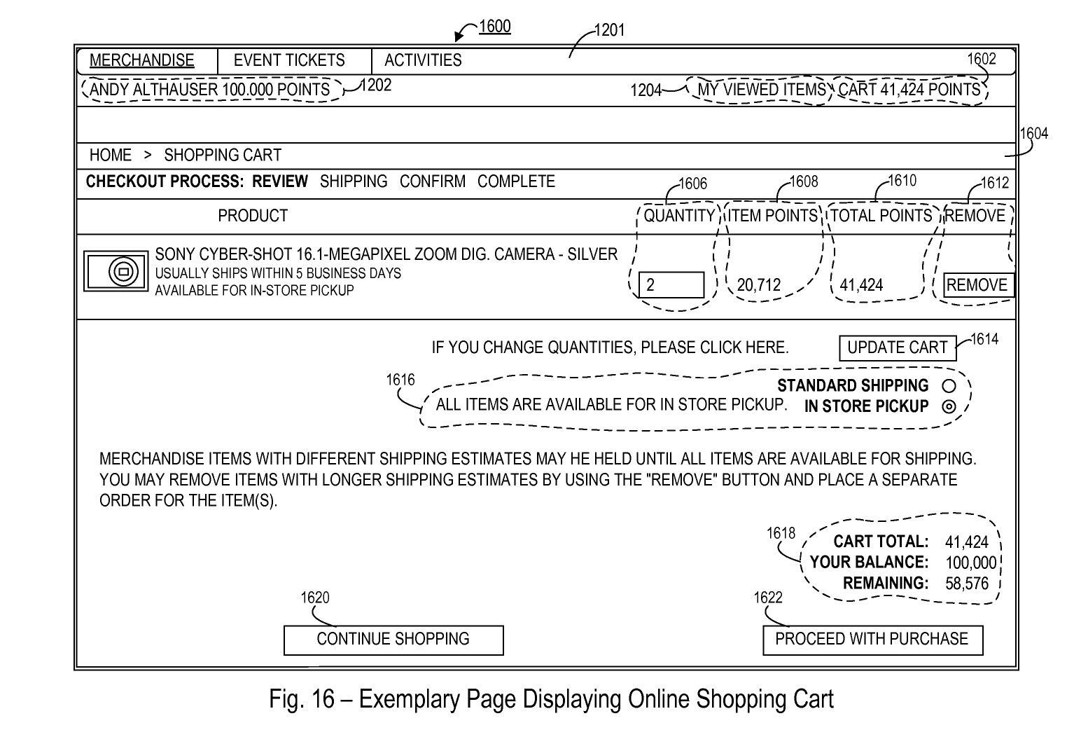

As will be understood, after obtaining information about one or more products, a customer typically would select one or more such products to redeem, and would also provide quantity of items (from the selected products) desired, and a method of delivery of items in the customer's order. A customer can choose different options for delivery, including either in-store pick up or drop-ship to a suitable location. A screenshot showing an exemplary order prior to the order being placed, is shown in FIG. 16. Consequently, after selecting items, and the delivery methods of the selected item, a customer submits an order to the LPMS 117 for processing at step 3, as shown in FIG. 1. (As will be understood, at step 3, customers can alternatively choose to cancel an order, in which case the online catalog 105 will be re-displayed to the customer by the LPMS 117.) It will be also understood that the total cost (in terms of loyalty points) of items in the customer's order cannot exceed the loyalty points balance (or, loyalty points accounts balance) of the customer, in which case the LPMS 117 will generate a message and inform the customer accordingly. In many scenarios, the customer can elect to pay the cost difference in dollars, usually with use of an accepted credit card or debit card, in the event that the number of customer's loyalty points are less the amount needed to redeem the item(s) in the customer's order.

As recited previously in step 3, when placing an order a customer chooses a method of delivery for the order. If the customer chooses to drop-ship items in the order, the customer has to specify a location where the items will be shipped to. However, if the customer chooses an in-store pickup method of delivery, the customer specifies a preferred store location in the form of zip codes or a city/state corresponding to the customer's desired store pick-up location. According to one aspect, a location identification mechanism (such as GPS, or any other positioning technology) embedded in the mobile application associated with the LPMS user-interface 103 provides details of the customer's current location to the LPMS 117. According to another aspect, if the customer uses a POS system at the store to access the LPMS 117, then the POS system automatically provides the customer's current location. In yet another aspect, electronic tablet computing devices (such as an Apple® Ipad®) can also be used at the store to provide the customer's location to the LPMS 117.

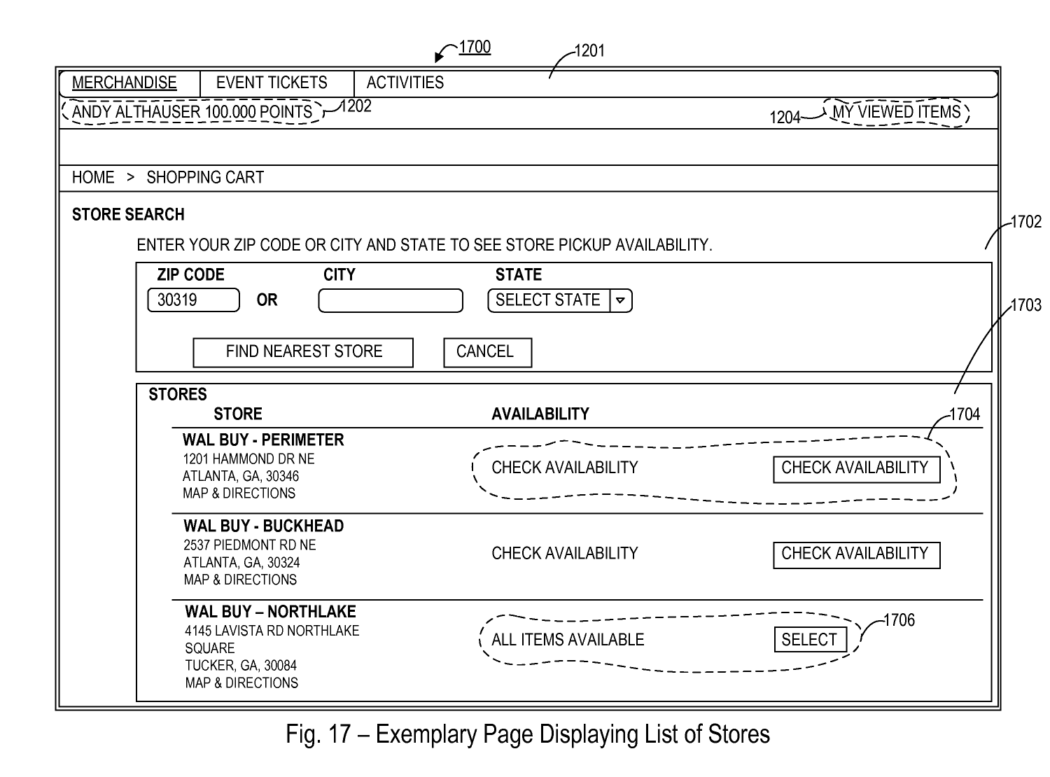

Accordingly, after receiving the customer's location, the LPMS 117 displays a list of stores around a fixed distance of the customer's selected location. According to one embodiment, a list of stores can be pre-stored in the LPMS 117 as available from suppliers, merchants and retailers, and such a list is updated intermittently or periodically. According to another embodiment, the LPMS 117 queries the merchant 109 in real time for a list of stores corresponding to the customer's location. An exemplary screenshot of a list of nearby stores corresponding to a customer's location is shown in FIG. 17.

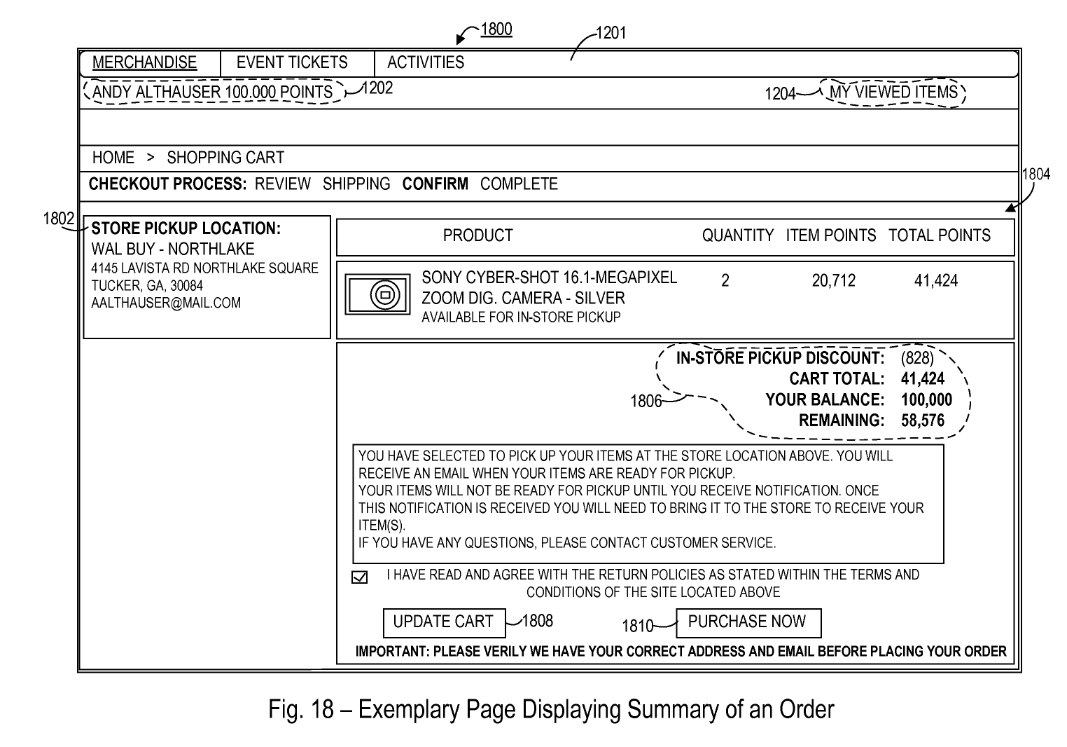

Although not shown in FIG. 1, it will be understood that upon reviewing the list of stores corresponding to the customer's location, the customer selects a store and confirms the order to be placed with the LPMS 117. A screenshot showing an exemplary order placement page including a summary of the customer's order, is shown in FIG. 18.

If customer places the order, then, after receiving the order from the customer, the LPMS 117 confirms (at step 4) the customer's loyalty points balance corresponding to cost of items in customer's order, and thereafter submits the order with the respective merchant(s) 109 offering the items in the customer's order. It will be understood that submitting the order, in one embodiment, also entails the LPMS 117 exchanging item availability and order status detail information with the respective merchant (supplier). According to one alternate exemplary aspect, the LPMS places (at step 4) a hold on an appropriate number of loyalty points from customer's loyalty points balance (or, loyalty points accounts balance), corresponding to cost of items in customer's order, and thereafter submits the order with the respective merchant(s) 109 offering the items in the customer's order. It will be understood that in alternate embodiments of the present system, the LPMS does not necessarily need to place a hold during a loyalty points transaction, as shown in step 4. Alternately, the LPMS 117 can confirm with the LPP 123 that the customer has enough loyalty points corresponding to the cost of items in customer's order. Accordingly, the LPMS can update a customer's loyalty points while a transaction is in process, or alternately, after a transaction is complete.

According to one embodiment of the present disclosure, the LPMS 117 submits the customer's order with suppliers 109 via supplier-provided APIs (Application Programming Interfaces). According to another embodiment, the LPMS 117 submits the order with suppliers by transmitting an email message containing details of the order. In yet another embodiment, the LPMS 117 transmits a formatted XML file containing details of the customer's order to the merchants. Detailed steps of a process performed by an embodiment of the LPMS 117 in an exemplary customer's order involving loyalty points, will be shown with a flowchart in connection with FIG. 5.

A merchant receives a real-time request related to the customer's order from the LPMS 117, and thereby starts processing the order at step 5. It will be understood that, if the customer 101 has indicated the delivery method for the items in the order to be picked up from a respective store location, then the merchant 109 first verifies that the items are available at the respective store location 113, and subsequently submits the order to be picked up from the respective store location (say, for example store 113). In turn, the store 113 processes the order, and responds back to the merchant 109 with availability information of items in the customer's order, along with pick up information if the items are available. Consequently, the merchant reverts back to an embodiment of the LPMS 117 with the information provided by the store 113.

If the customer 101 has chosen the item to be drop-shipped at step 3, then in that case, the customer provides a shipping address when placing the order which is provided to the merchant 109 by the LPMS 117, and the merchant 109 verifies availability of shipping option to the location specified in the customer's order. Additionally in that case, the merchant also verifies that the items are available at the warehouse locations from where the items are supposed to be shipped to the customer. Then, the merchant 109 reverts back to the LPMS 117 with the availability of shipping and additional tracking information.

In case the items are available (either for drop-ship or store pickup), the LPMS 117 deducts (at step 6) the appropriate number of loyalty points from customer's loyalty points balance (or, loyalty points accounts balance). In case a hold was placed earlier, then, after the appropriate points are deducted from the customer's loyalty points balance, the hold is released. Further, the LPMS 117 informs the LPP 123 details relating to the customer's order and current loyalty points balance.

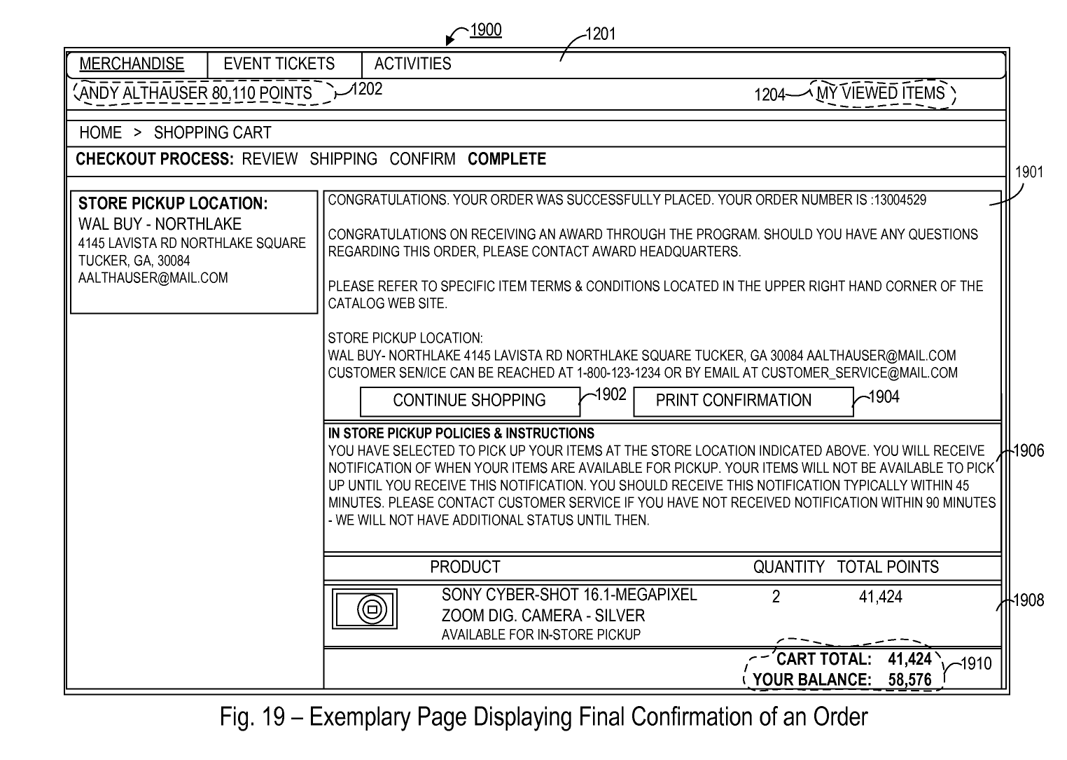

If the customer has specified in-store pickup as the method of delivery when placing the order at earlier step 3, then in step 7, the LPMS 117 provides instructions to the customer related to store pickup information or shipping information, as applicable to the customer's order. It will be recalled that the pickup information was provided to the LPMS 117 by the merchant 109 at an earlier instance. (An exemplary screenshot illustrating instructions related to store pickup information of an exemplary order is shown in FIG. 19.) Upon receiving these instructions, customer picks up items from the store 113 and thereby a loyalty points transaction is completed. Although not shown in FIG. 1, according to one aspect, a final status of the customer's order and relevant loyalty points information is provided to the LPP 123 by the LPMS 117, after the merchant (supplier) associated with the customer's order successfully processes the customer's order. In an exemplary loyalty points transaction involving a customer, an exemplary loyalty points table 115 shown in FIG. 1 indicates that customer John Doe had a balance of fifty thousand (50,000) loyalty points before a transaction, which reduces to twenty thousand (20,000) loyalty points after the transaction is completed.

It will be noted that in the event that the items are unavailable at the store where the customer desires to pick up the items in the order, or, are unable to be shipped for some reason, loyalty points are not deducted from the customer. According to one embodiment of the LPMS 117, the LPMS 117 queries the customer for providing alternate store locations, or alternate methods of delivery, and the process continues as recited previously. According to another embodiment, in case an item is unavailable, the LPMS 117 requests the customer 101 to provide alternate locations where the customer desires to pickup the item, and further after receiving the customer's input, the LPMS 117 communicates the customer's selection to the merchant (supplier). Detailed steps of a process performed by an embodiment of the LPMS 117 in an exemplary loyalty points transaction involving loyalty points, is shown with a flowchart in FIG. 5.

According to aspects of the present disclosure, loyalty points (a generic unit of currency) is converted into dollars according to predetermined conversion rates decided by the LPP and the entity that hosts the LPMS. For example, in one particular loyalty points redemption program offered by a particular LPP, the points-to-dollars conversion rate is 150 loyalty points per one dollar cost of goods and services, whereas in another loyalty points redemption program, the conversion rate is 250 loyalty points per one dollar cost of goods and services. Therefore, in the LPMS database 121 a loyalty points conversion table 215 (shown in FIG. 2 and FIG. 8A) stores different points-to-dollars conversion rates for various loyalty points redemption programs offered by different LPPs. Dollars obtained from the conversion of members' loyalty points are provided by LPPs to the LPMS that in effect, enables the redemption of eligible goods and services from various merchants and retailers who are suppliers of goods and services associated with the respective loyalty points redemption programs. In one aspect, the LPMS 117 handles the conversion of loyalty points to dollars used for payment to such suppliers, merchants and retailers, and thereafter pays such suppliers, merchants and retailers using dollars obtained from the LPP after the conversion.

As recited previously, loyalty points redemption programs are associated with specific suppliers, merchants and retailers who offer eligible goods and services for sale to customers via the respective loyalty program. Data relating to such suppliers, merchants and retailers and the respective loyalty points redemption program they are associated with, in addition to eligible goods and services they offer to members of loyalty points redemption programs are stored in merchant eligibility table 221, exemplarily shown in FIG. 2 and FIG. 8B.

It will occur to one of ordinary skill that the same items of eligible goods and services can be offered by more than one merchant. Consequently, in such scenarios, the LPMS 117 then applies criteria on how to manage conflicts. A catalog presentment table 223 (shown in FIG. 2 and FIG. 8C) contains criteria used in making a determination of which items to show members of loyalty programs when presenting a catalog, in what order, from which merchant, etc.

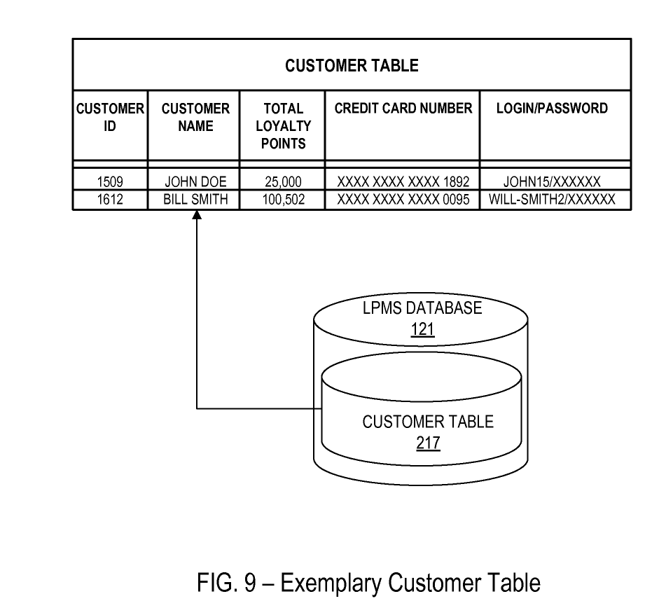

It will be understood and appreciated that in one embodiment of the present disclosure, customers can choose to redeem items using a combination of a dollar amount and redeemable loyalty points. An exemplary customer table 217 (stored in LPMS database 121) showing pre-stored credit card information for customers who have redeemed program-eligible items using a combination of a dollar amount and loyalty points, is shown in FIG. 2 and FIG. 9.

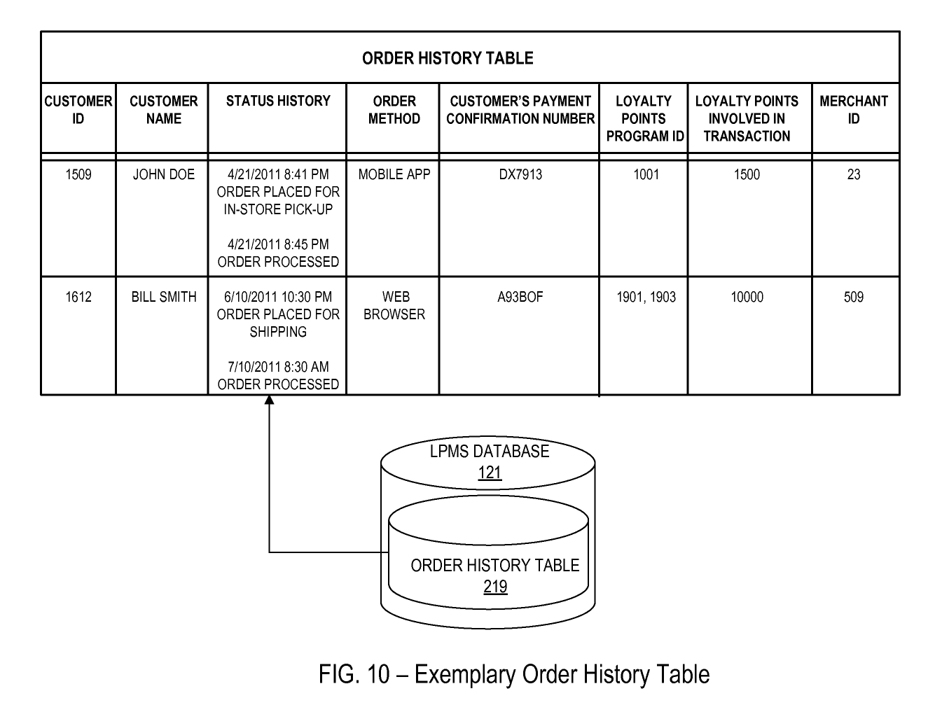

Additionally, it will be further understood that various other kinds of information can also be stored in the LPMS database 121. Examples of such information includes customers' order history information in the LPMS database 121. An exemplary order history table 219 showing customers' order history information is shown in FIG. 2 and FIG. 10.

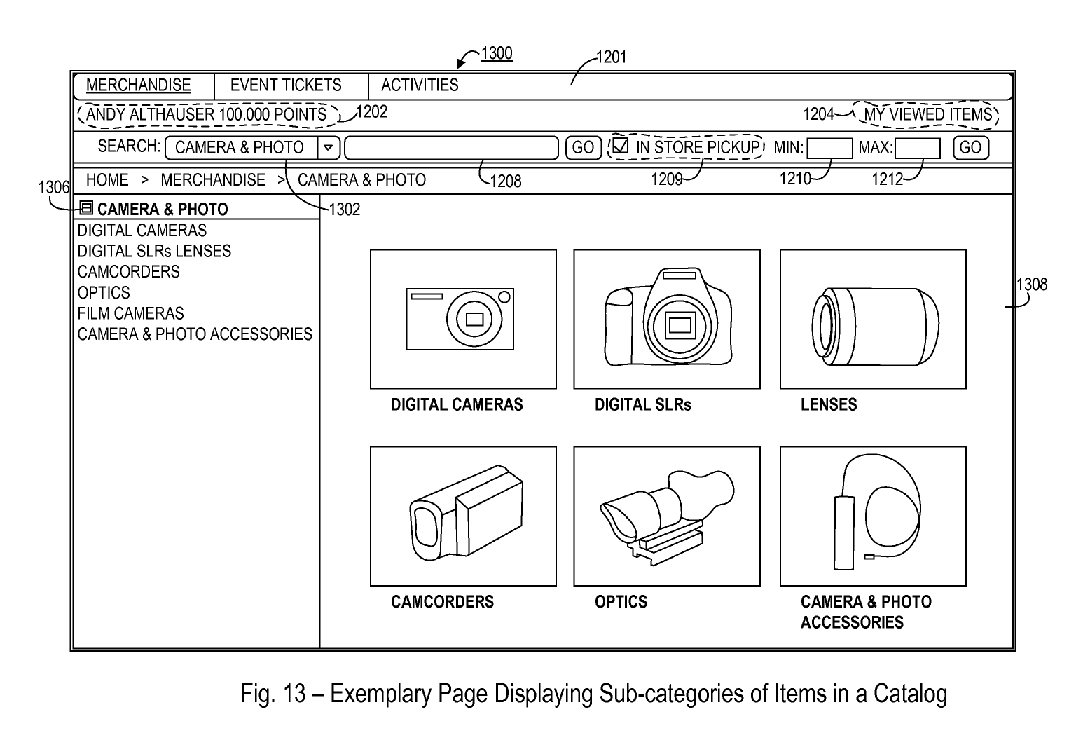

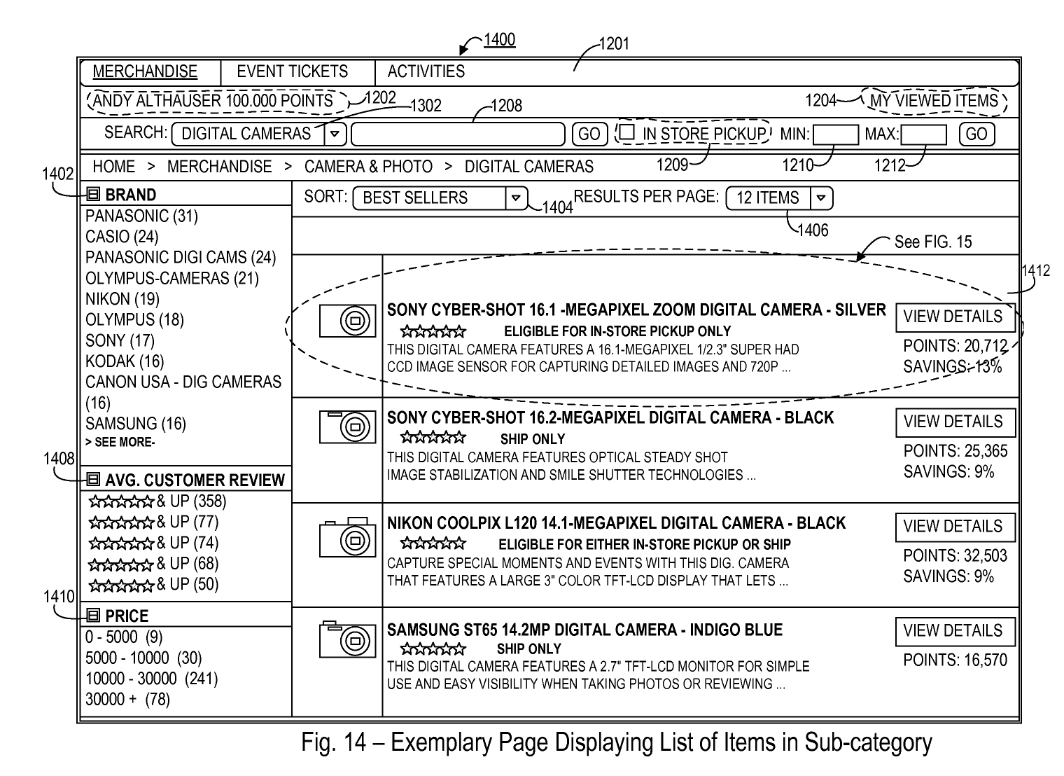

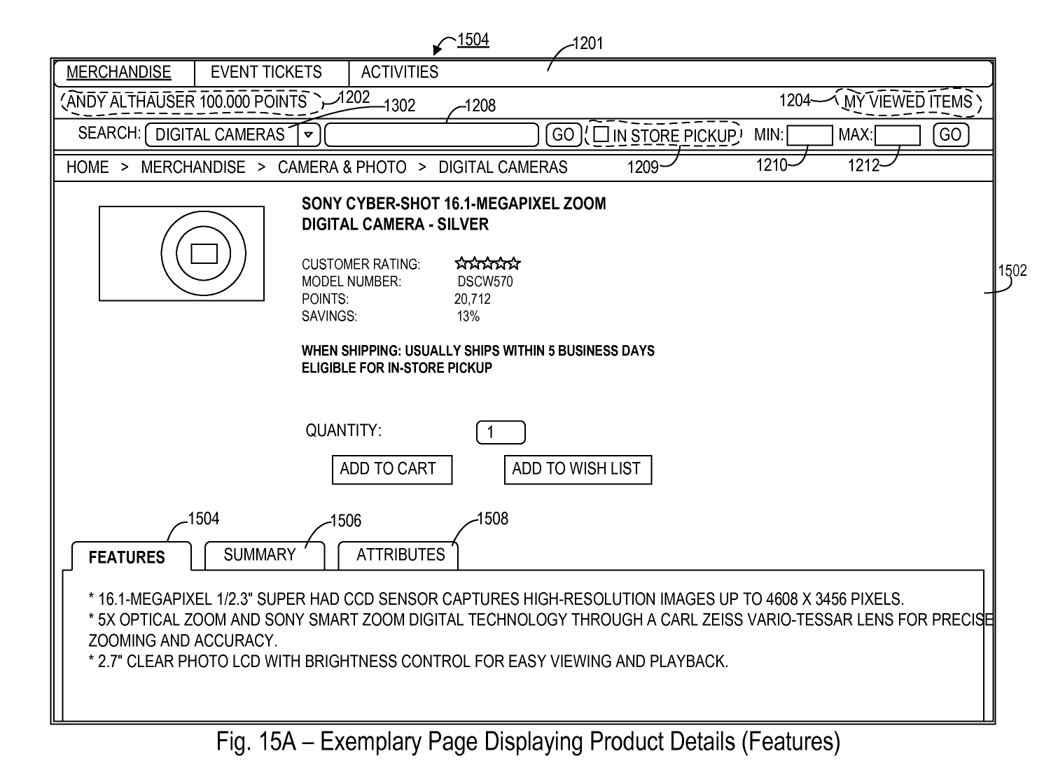

Exemplary screenshots of various embodiments of a LPMS interface are illustrated in FIGS. 11-19. In particular, FIG. 11 illustrates an exemplary screenshot displaying a login screen for members of a loyalty points redemption program to enter their login credentials. After successful login, members of a loyalty points redemption program, also referred to herein as customers, browse a catalog of eligible goods and services. Exemplary screenshots showing a catalog comprising categories and sub-categories therein, of eligible goods and services, along with additional product information are shown in connection with FIG. 12, FIG. 13, FIG. 14, FIG. 15A, FIG. 15B, and FIG. 15C.

As will be understood and appreciated by one skilled in the art, if a customer decides to redeem one or more items listed in a catalog, then the customer begins a “checkout” process of those items. This entails the customer selecting the items and placing them in an online “shopping cart”. An exemplary screenshot illustrating an online shopping cart prior to placing an order is shown in FIG. 16. After the items are placed in a shopping cart, the customer specifies a method of delivery, including either pick-up from a store or drop-ship to a shipping location. If the customer specifies in-store pickup then the LPMS displays a list of nearby stores corresponding to a current location of the customer. An exemplary screenshot showing a list of nearby stores is shown in FIG. 17. After the customer selects a store, then the LPMS verifies with the merchant associated with the customer's order that the item is available at the customer selected store. Upon successful verification, the LPMS displays an order placement page to the customer. An exemplary order placement page including a summary of the customer's order is shown in FIG. 18. After the customer places the order, the LPMS displays a final order confirmation page (exemplarily shown in FIG. 19) containing instructions for pickup.

As will be understood and appreciated, the screenshots displaying various LPMS user interfaces shown in FIGS. 11-19 are for exemplary purposes only. Although the accompanying screenshots discuss an exemplary scenario wherein a customer is a member of a single loyalty points redemption program, it will be understood that a customer can be a member of multiple loyalty points redemption programs.

Furthermore as will be understood from the discussions in connection with FIG. 6-FIG. 9, merchants and suppliers associated with particular loyalty programs satisfy certain eligibility conditions imposed by the entity that hosts the LPMS 117 in conjunction with the LPP 123 to provide goods/services to customers of loyalty points redemption programs. Even further, such goods/services have to be available, and additionally have to satisfy certain criteria (for example, only goods from electronics products category are applicable, or goods that are available for in-store pick-up are eligible, etc.). Such criteria is decided by the eligible suppliers, the associated LPPs 123, and the entity that hosts the LPMS 117. The retail price of such available, program-eligible goods/services (a\k\a redemption items) are transformed into loyalty points based on different loyalty points conversion rates, predetermined by the LPP 123 and the entity that hosts the LPMS 117, and consequently such goods/services are then available to be redeemed by members of loyalty points redemption programs.

The materials discussed above in association with FIG. 1 merely provide an overview of an embodiment of the present system for loyalty points management and redemption, for purposes of fulfillment of loyalty points redemption program rewards. Hence, the discussions and accompanying drawings are not intended to limit in any way the scope of the present disclosure. For example, in an alternate embodiment customers can choose to have items drop-shipped to a convenient shipping location. Such an embodiment will be discussed in greater detail in connection with FIG. 5. Accordingly, further embodiments of the systems and methods and more detailed discussions thereof is provided below and in the accompanying figures.

### EXEMPLARY EMBODIMENTS

Generally, one form of the present disclosure describes a system and method for the transformation of loyalty points (associated with loyalty points redemption programs) offered by a variety of LPPs, such as (but not limited to) airline companies, hotels, restaurants, credit card companies, financial institutions, etc. into fulfillment rewards earned by members of loyalty points redemption programs, wherein members of the loyalty points redemption programs are able to select eligible goods and services from suppliers, merchants and retailers in real-time by the use of a mobile device while inside the premises of the establishments of suppliers, merchants and retailers. It will be understood that the present system allows customers to access their loyalty points redemption program account and perform loyalty points transactions using Internet enabled computing devices such as laptops, desktops, smart phones etc. Moreover, it will also be understood that the system allows customers to access their loyalty points redemption program accounts and perform loyalty points transactions anywhere and anytime, and not limited to a store location as displayed exemplarily in FIG. 1. For instance, customers can perform loyalty points transactions while at work, or from home, or other places and can later travel to a store location to pickup the goods/services redeemed by the loyalty points transaction. Alternatively, customers can have the goods/services delivered via a shipping service. The disclosed system, herein referred to as the LPMS, determines the availability and eligibility of goods and services to members of loyalty points redemption programs.

As will be understood and appreciated, the LPMS 117 administers and manages loyalty points redemption programs for multiple LPPs, each loyalty points redemption program subjected to predetermined rules and regulations that determine conditions for transactions involving loyalty points. Further, the LPMS can administer multiple loyalty points redemption programs offered by a LPP. Also, as can be understood, customers 101 can be members of more than one loyalty points redemption program, offered by the same or different LPPs. Generally, examples of LPPs may include (but not limited to) retailers, merchants, corporate organizations, car dealerships, banks or financial institutions, airline companies, and the like.

Turning to FIG. 2, an exemplary LPMS architecture 200 is shown, comprising a LPMS management module 119 and an exemplary LPMS database 121. The LPMS management module 119 further comprises various software modules and components involved in administering and managing loyalty points redemption program, and will be discussed in detail later. The LPMS database 121 stores exemplary data tables (which will be discussed in detail later) containing LPMS related data and manipulated/processed by software modules and components that comprise the LPMS 117. Examples of LPMS data include (but are not limited to) multiple catalogs of eligible goods and services for a variety of loyalty points redemption programs offered by various LPPs 123, history of previous transactions performed by customers, and the like. (Detailed steps of a process performed by an embodiment of the LPMS 117 in an exemplary customer transaction involving loyalty points, will be discussed with a flowchart in connection with FIG. 5.)

In the embodiment shown in FIG. 2, it is seen that the LPMS 117 further comprises a catalog module 205, a transaction module 207, and a user interface (UI) module 209. Catalog module 205 is responsible for assimilating inventory information from various suppliers (merchants) to be sorted and combined into a single consolidated format. As will be understood by a person of ordinary skill in the art, communication between the catalog module 205 and the merchants 109 typically proceeds via one of the following: supplier-provided APIs, email messages, or XML formatted messages. It will be understood that the catalog module is also responsible for normalizing the heterogeneous information received from a variety of suppliers in different formats and different merchant-identifying parameters into a single standardized format. Examples of such heterogeneous information include (but are not limited to) product name, product description, product price, product availability, shipping availability, product image, customer review/rating, and the like. The catalog module 205 operates in association with a transaction module 207 which will be described next.

Transaction module 207 interacts with LPPs and suppliers (of loyalty points redemption program eligible goods and services) for purposes of handling loyalty points transactions. In interacting with LPPs, the transaction module 207 performs various functions such as informing LPPs of customers' orders (and optionally, the loyalty points redeemed with the respective orders), creating orders based on inputs received from customers, etc. In addition to the above-mentioned tasks, the transaction module 207 interacts with suppliers to place customer's orders, monitoring the statuses of customer's orders while they are being processed by the suppliers in various stages. As will be understood, various other functions can be performed by the transaction module 207, as will occur to one of ordinary skill in the art. Conversion rate is a critical function on this table however many business rules apply and are applied by the LPMS as they pertain to each individual LPP.

The functions of the UI module 209 generally include, among other things, serving the LPMS portal (and its associated pages, responses, data, and other content) to consumers 101 who access the LPMS 117 using the web, a mobile device or otherwise. Detailed steps and processes performed by the constituent modules of the LPMS 117 e.g., catalog module 205, transaction module 207, and UI module 209 will be further discussed in connection with FIG. 5. Furthermore, various steps shown in FIG. 5 have been annotated with the reference numerals 205, 207, and 209 to associate the steps with at least one of the software modules, e.g, catalog module 205, transaction module 207, and UI module 209, in one exemplary embodiment of the LPMS 117. As will be understood by one skilled in the art, various other modules and components (different from the ones described in FIG. 2) can comprise the LPMS 117 in alternate embodiments.

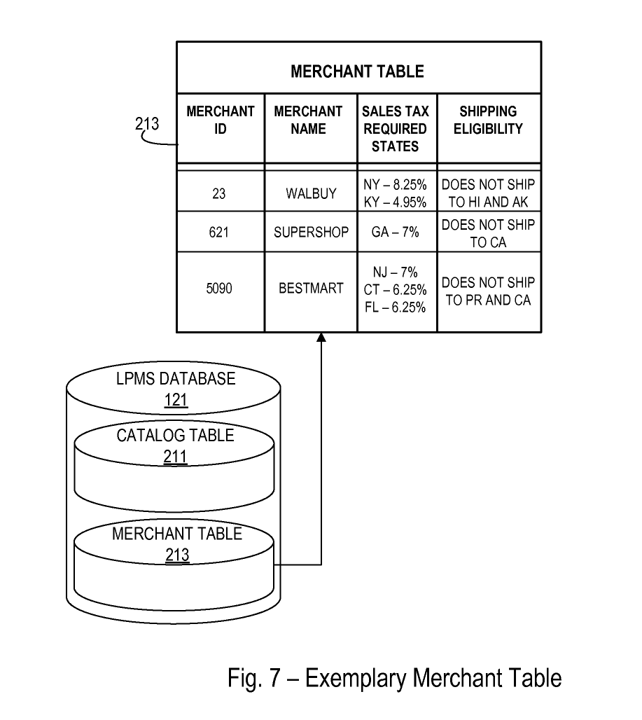

Further, it can be seen that the LPMS database 121 comprises data tables such as a catalog table 211, a merchant table 213, a loyalty points conversion table 215, a customer table 217, an order history table 219, a merchant eligibility table 221, and a catalog presentment table 223. Exemplary data entries stored in these data tables will be discussed in connection with FIG. 6, FIG. 7, FIG. 8A, FIG. 8B, FIG. 8C, FIG. 9, and FIG. 10 respectively. A brief description of the above-mentioned data table follows next.

Catalog table 211 stores product related information such as a list of eligible goods and services that are available through a particular loyalty program offered by a LPP, technical specification of products, pricing, name of merchant(s) who offers the products for sale, etc.

Merchant table 213 stores merchant related data such as local sales taxes charged in various states where the merchant operates, merchant's capability of providing shipping or in-store pick up of goods redeemable by loyalty points redemption programs, etc.

As will be understood by one of ordinary skill in the art, different loyalty points redemption programs offer different rates of conversion of members' loyalty points into dollars that are used by members to redeem eligible goods or services. For example, in one particular loyalty points redemption program offered by a particular LPP, the points-to-dollars conversion rate is 150 loyalty points per one dollar cost of goods and services, whereas in another loyalty points redemption program, the conversion rate is 250 loyalty points per one dollar cost of goods and services. Therefore, in the LPMS database 121 a loyalty points conversion table 215 stores different points-to-dollars conversion rates for various loyalty points redemption programs offered by different LPPs. Furthermore, different rates of conversion of members' loyalty points into dollars or vice-versa, are typically applied in conjunction with various business rules that will be discussed in FIG. 8C.

As will be understood, loyalty points redemption programs are associated with specific suppliers, merchants and retailers who offer eligible goods and services for sale to customers via the respective loyalty program. Data relating to such suppliers, merchants and retailers and the respective loyalty points redemption program they are associated with, in addition to eligible goods and services they offer to members of loyalty points redemption programs are stored in merchant eligibility table 221. In other words, (and as will be understood better from the discussions in connection with FIG. 6-FIG. 9), merchants and suppliers associated with particular loyalty programs satisfy certain eligibility conditions imposed by the entity that hosts the LPMS 117 in conjunction with the LPP 123 to provide goods/services to customers of loyalty points redemption programs. Even further, such goods/services have to be available, and additionally have to satisfy certain criteria (for example, only goods from electronics products category are applicable, or goods that are available for in-store pick-up are eligible, etc.). Such criteria is decided by the eligible suppliers, the associated LPPs 123, and the entity that hosts the LPMS 117. The retail price of such available, program-eligible goods/services (a\k\a redemption items) are transformed into loyalty points based on different loyalty points conversion rates, predetermined by the LPP 123 and the entity that hosts the LPMS 117, and consequently such goods/services are then available to be redeemed by members of loyalty points redemption programs.

It will occur to one of ordinary skill that the same items of eligible goods and services can be offered by more than one merchant. Consequently, in such scenarios, the LPMS 117 then applies criteria on how to manage conflicts. A catalog presentment table 223 (shown in FIG. 8C) contains criteria used in making a determination of which items to show members of loyalty programs when presenting a catalog, in what order, from which merchant, etc. For example, the LPMS is able to present an item from only one supplier when an item is available from multiple suppliers by utilizing predetermined business rules, or can present an item multiple times when the same item is available from more than one supplier. Furthermore, in another example, business rules associated with LPPs and merchants/suppliers, the LPMS also presents various options of delivery of redemption items to customers.

Information pertaining to members of loyalty points redemption programs are stored in a customer table 217. Examples of such information include (but are not limited to) members' names, members' credit card numbers for members who obtained goods and services using a combination of redeemable loyalty points and a dollar amount, and several other member-related attributes. In one exemplary embodiment of the LPMS, transaction history information of members associated with a loyalty points redemption program are stored in a order history table 219 in the LPMS database 121. As recited previously, additional details of loyalty points conversion table 215, merchant eligibility table 221, catalog presentment table 223, customer table 217, and order history table 219, will be discussed later in connection with FIG. 8A, FIG. 8B, FIG. 8C, FIG. 9, and FIG. 10 respectively.

Also shown in FIG. 2, is the LPP 123 which further comprises a LPP management module 225 and a LPP database 227. It will be understood that the LPP 123 owns and operates a computer system called as the Loyalty Points Provider System (LPPS). For purposes of the discussions herein and the accompanying drawings, the terms LPP and LPPS have been used interchangeably. The functions of the LPP management module 225 include, among other things, monitoring and handling loyalty points accounts (including members' loyalty points balance, details of loyalty points transactions performed etc.) of individual members, tracking members' activities in connection with earning loyalty points and communicating the same to the LPMS 117, and several other functions. Data pertaining to the functions of the LPP management module 225 is stored in the LPP database 227.

As can be seen from FIG. 2, the architecture 200 includes the LPMS 117, a merchant 109 (exemplarily called Walbuy), wherein the merchant 109 comprises a merchant inventory database 201 (that typically stores the merchant's inventory information such as pricing, quantity, availability, store locations, etc.) and a merchant transaction system 111 that processes customer orders communicated via the network 107 by the LPMS 117, subsequent to the LPMS receiving such orders from customers 101 through their end devices (such as computers and smart phones, as shown for example in FIG. 2).

In other words, it will be understood that customers 101 use their end devices (generally shown in FIG. 2 with the reference numeral 101) over a network 107, to access the LPMS 117 for a loyalty points transaction via a LPMS user interface 103 that is hosted in the UI module 209. As will be understood, the communication protocol between the end devices and the LPMS, between the LPP 123 and the LPMS 117, and also between the merchants 109 and the LPMS 117 as shown via networks 107 in FIG. 2 may vary depending on the type of network (cellular 3G, cellular 4G, Wimax, Wi-Fi, etc.), and the type of device (GSM technology based, CDMA technology based, or other various other communications standards based).

As will be understood by one of ordinary skill in the art, various other modules, software engines, and data tables can comprise an embodiment of the LPMS 117. The modules, software engines, and data tables discussed in connection with FIG. 2 are for exemplary purposes only, alternate embodiments are not limited to the specific modules and software engines discussed herein. It will be further understood and appreciated that the single merchant 109 shown in FIG. 2 is for the purpose of illustration only. According to one aspect, functionalities of the Catalog module 205 and the Transaction Module 207 can be merged into a single module. According to another aspect, functionalities of the UI Module 209, Catalog module 205, and the Transaction Module 207 can be configured in a manner such that communications/processing involving the LPMS 117, the LPPs 123, and the merchants 109 are handled by a single module, whereas communications with the customer including display of various interfaces is handled by another module. Although the description in FIG. 2 indicates a single LPP 123 and a single merchant 109, it will be understood that the LPMS manages multiple loyalty points redemption programs offered by a plurality of LPPs, the loyalty points redemption programs being associated with a plurality suppliers, merchants and retailers, wherein members of one or more loyalty points redemption programs can redeem loyalty points to obtain loyalty points redemption program-eligible goods and services offered by multiple merchants who satisfy eligibility conditions determined by the LPMS and/or the LPPs. Additional details and exemplary eligibility conditions for merchants (suppliers) as well as various goods/services offered by them will be discussed with exemplary data tables in connection with FIG. 6-FIG. 8 (including FIG. 8A, FIG. 8B, and FIG. 8C).

FIG. 3 is an exemplary sequence diagram illustrating the steps involved in the interactions between various components of an embodiment of the present system, for purposes of fulfillment of loyalty points rewards to members of a loyalty points redemption program, wherein the present embodiment provides to customers the benefit of picking up the fulfillment items while the member is shopping inside the premises of a merchant store. In the embodiment discussed in FIG. 3, a LPMS 117 provides manages and administers various aspects of a loyalty points redemption program offered by a LPP 123 in order to provide fulfillment of loyalty points rewards to customers 101 who are members of a loyalty points redemption program. Such fulfillment rewards include eligible goods and/or services offered by merchants 109 that are associated with particular loyalty points redemption programs.

As will be understood, embodiments of the present disclosure are not limited to a single LPP, a single merchant and a single customer. Alternate embodiments can involve the LPMS managing multiple loyalty points redemption programs offered by a plurality of LPPs, the loyalty points redemption programs being associated with a plurality suppliers, merchants and retailers, wherein members of one or more loyalty points redemption programs can redeem loyalty points to obtain loyalty points redemption program-eligible goods and services. In the description that follows, various real-time electronic status exchanges related along with various computer implemented processes involved in a customer's transaction involving the customer 101, the LPMS 117, the LPP 123, the merchant 109, and the merchant store 113 will be explained with the help of a sequence diagram.

Starting at step 1a in FIG. 3, a customer 101 logs (using customer's login credentials) into the LPMS via a user interface (exemplarily shown in FIG. 11) using an end device such as a laptop computer or a smartphone. As will be understood, in an alternate instance customers may also log into the LPP 123 at step 1b1, and thereafter the LPP 123 will handoff (at step 1b2) the customer session to the LPMS 117 after successful login. It will be further understood that customers who log in to the LPMS 117 or the LPP 123 can perform loyalty points transaction to redeem eligible goods/services, or alternatively, customers can browse a catalog without redeeming goods/services, or even further, customers can review their loyalty points account to obtain information related to loyalty points balance, history of previous loyalty points transactions, etc. Detailed steps of a process performed by an embodiment of the LPMS 117 in an exemplary loyalty points transaction to redeem eligible goods/services, are shown with a flowchart in FIG. 5.

At step 2, the LPMS 117 displays to the customer a page containing a catalog (more specifically, a redemption catalog) of eligible goods/services associated with the loyalty points redemption program that the customer is a member of. In other words, loyalty points redemption programs can have different catalogs of eligible goods and services, associated with different loyalty points redemption programs (for example, as shown in FIG. 8A, FIG. 8B and FIG. 8C) offered by the same or different LPPs, wherein the goods and services are offered by a variety of suppliers, retailers and merchants. As will be further understood, the catalog is updated by the LPMS 117 frequently to reflect changes in availability, quantity, pricing, or any inventory changes as communicated by suppliers, merchants and retailers. Generally, the catalog is a products catalog stored as a data table in the LPMS database 121, as shown exemplarily in FIG. 6. It will be understood that the catalog displayed to a customer is a result of the application of various criteria or business rules (for example, discussed exemplarily in connection with FIG. 8C) on a products catalog.

After the catalog 105 is displayed, customers 101 browse through the catalog 105 and places an order (at step 3) by selecting one or more items to redeem. In one embodiment, after the customer 101 selects an item, the LPMS 117 queries (at step 4) the merchant 109 who offers the item selected by the customer for sale, for additional product information relating to the selected item. Examples of additional information include detailed specification, item eligibility of being fulfilled in-store, opinions and reviews on the selected item provided by other customers, item availability etc. Exemplary screenshots showing a catalog of eligible goods and services, along with additional product information is shown in connection with FIG. 12-FIG. 15 (including FIG. 15A, FIG. 15B, and FIG. 15C).

Still referring to FIG. 3, at step 5, the merchant 109 provides additional product information in response to the LPMS's query at previous step 4. At the next step 6, the LPMS 117 displays additional product information to the customer 101, and waits for the customer's response. In turn, at step 7, the customer indicates the desire to buy one or more items by placing an order for the item(s) in an online shopping cart. (An exemplary screenshot displaying an online shopping cart with options for in-store pickup as displayed to a customer is shown in FIG. 16.) Consequently, on receiving the customer's order in the online shopping cart, the LPMS 117 begins (at step 8) the checkout process.

In one embodiment of the LPMS 117, customers can browse items in a catalog without logging into the LPMS 117. In such scenarios, the LPMS 117 verifies that the customer is a valid customer (by asking the customer to enter the customer's login credentials) during the checkout process. If the customer has already been successfully validated (for example, at step 1b1 or at step 1a in FIG. 3), then no further validation is necessary.

At step 9, customer 101 indicates to the LPMS 117 a preferred method of delivery of the item(s) selected earlier in step 3. In one embodiment of the present system, the customer can pick up the item(s) while inside the premises of a merchant store location, or, can opt to pick up the item(s) by travelling to the store location at a later time. In another embodiment, the present system allows the customer to select a drop-ship method of delivery of the selected item(s), via a suitable shipping service. In the description of FIG. 3 that follows, it will be assumed that the customer intends to pick-up item(s) in-store while inside the premises of a merchant store location, and indicates such an intention to the LPMS 117 at step 9.

In one embodiment of in-store pickup of selected item(s), the customer further specifies a current location in the form of zip codes or a city/state corresponding to the customer's desired store pick-up location. According to one aspect, a location identification mechanism (such as GPS, or any other positioning technology) embedded in the mobile application associated with a LPMS user-interface provides details of the customer's selected location to the LPMS 117. According to another aspect, if the customer uses a POS system at the store to access the LPMS 117, then the POS system automatically provides the customer's current location.

Based on the customer's location obtained via customer's input or a location identification mechanism (such as GPS), the LPMS 117 displays a list of stores around a fixed distance of the customer's current location where the items are potentially available. According to one embodiment, a list of stores can be pre-stored in the LPMS 117 as available from suppliers, merchants and retailers, and such a list is updated intermittently or periodically.

According to another embodiment, the LPMS 117 queries (at step 10) the merchant 109 in real-time for a list of store locations where the item(s) is (are) available. According to one embodiment of the present disclosure, it will be understood and appreciated that the LPMS 117 communicates with suppliers via supplier-provided APIs (Application Programming Interfaces).

As shown in FIG. 3, at step 11, the merchant 109 provides a response via a respective merchant API to the LPMS 117 with a list of store locations where the item(s) is (are) usually available. The LPMS 117 displays such a list to the customer 101 at step 12. It will be understood and appreciated that if the selected item(s) are not available at any store location, then the merchant 109 would indicate the unavailability to the LPMS in step 10, and the LPMS would further indicate that to the customer at step 12. An exemplary screenshot illustrating a list of merchant store locations, as displayed to a customer is shown in FIG. 17).

If the item(s) are available for in-store pickup at one or more store locations, at step 13, then the customer 101 selects a corresponding store from the displayed list of stores. The LPMS receives the customer's response, and subsequently at step 14 the LPMS 117 displays a summary (exemplarily shown in FIG. 18) of the customer's order to the customer, and thereafter at step 15, the customer 101 confirms the order.

After receiving the order from the customer, the LPMS 117 places (at step 16) a hold on an appropriate number of loyalty points from customer's loyalty points balance, corresponding to cost of items in customer's order, and submits the order with the merchant 109 at step 17. (Detailed steps of a process performed by an embodiment of the LPMS 117 in an exemplary customer's order involving loyalty points, are shown with a flowchart in FIG. 5.) It will be apparent to one skilled in the art that in alternate embodiments of the present system, the LPMS does not necessarily need to place a hold during a loyalty points transaction, as shown in step 17. Alternately, the LPMS can confirm with the LPP that the customer has enough loyalty points corresponding to cost of items in customer's order. Accordingly, the LPMS can update a customer's loyalty points after a transaction is complete, or even, after an order has been processed successfully by a merchant (supplier).

Continuing with the description of FIG. 3, a merchant receives a real-time request related to the customer's order from the LPMS 117, and thereby starts processing the order. Processing the customer's order by the merchant, involves among other things, the merchant 109 verifying that the items are available at the respective store location 113. In case the items are available, at step 18, the merchant 109 submits the order with the respective store 113. In turn, the store 113 processes the order, and responds (at step 19) back to the merchant 109 with availability information of items in the customer's order, alongwith pick up information if the items are available. Consequently, the merchant reverts back to an embodiment of the LPMS 117 with the information provided by the store 113, as shown in step 20 of FIG. 3.

In case the items are available, at following step 21, the LPMS 117 deducts the appropriate number of loyalty points from customer's loyalty points balance that were placed on hold earlier (at step 17). Further, the LPMS 117 informs (at step 22) the LPP 123 of the customer's order and current loyalty points balance. In one exemplary embodiment, the LPP 123 displays an order confirmation message to the customer 101 at step 23. Then, in the next step 24, the LPMS 117 provides instructions to the customer related to pickup information of the selected items from the store 113. It will be recalled that the pickup information was provided to the LPMS 117 by the merchant 109 at an earlier instance, for example at step 20 as shown in FIG. 2. An exemplary screenshot illustrating instructions related to store pickup information of an exemplary order is shown in FIG. 19. Upon receiving these instructions, customer picks up items from the store 113 and completes the loyalty points transaction at step 25.

Still referring to FIG. 3, at step 26, the store 113 communicates to the merchant 109 that the customer has picked up the item(s). In turn, the merchant 109 informs (at step 27) the LPMS 117 that the customer has picked up the item(s). A final status of the customer's order and current (updated) loyalty points balance is provided to the LPP 123 by the LPMS 117 at step 28. Eventually, at step 29, the LPMS 117 displays a message to the customer that the loyalty points transaction is complete. In one exemplary aspect, various status exchanges (and/or messages) related to a customer's transaction involving the LPMS 117, the LPP 123, the merchant 109, and the customers are typically stored in a LPMS database.

As will be understood and appreciated, embodiments of the present disclosure are not limited to the specific processes or sequences for loyalty points transaction as described in FIG. 3, and other embodiments may implement other processes as will occur to one of ordinary skill in the art. As will be understood and appreciated, embodiments of the present disclosure are not limited to the specific processes or sequences for management of loyalty points redemption programs as discussed herein, and other embodiments may implement other sequences as will occur to one of ordinary skill in the art. For example, various steps as shown in the sequence diagram are “sequence agnostic,” that is, various steps do not necessarily be carried out in particular order or sequence, but may be effected in varying orders and sequences for specific purposes, as will be understood by those skilled in the art. Likewise, it will be appreciated that certain steps are optional, such as, for example, those involving determining or updating a customer's loyalty points balance, determining availability of a redemption item, retrieving detailed item information, determining a loyalty points price of an item, and the like. It will be apparent to those skilled in the art that in alternate embodiments of the present system, the LPMS does not necessarily need to place a hold during a loyalty points transaction, as shown in FIG. 3. Alternately, the LPMS can update a customer's loyalty points after a transaction is complete, or even, after the LPMS is informed by a merchant that the merchant has placed an order for the item. Additionally, the LPMS can communicate can with the LPP in real-time while a customer's transaction is in process, or alternately, after a transaction is complete.

Further, embodiments of the present disclosure are applicable on any number of loyalty points redemption programs offered by a variety of LPPs in association with different suppliers, merchants and retailers who offer their items for sale to customers who are members of one or several loyalty points redemption programs. Even further, various messages that are displayed to the customer can be in the form of email communication, on-screen display, text messages sent to a customer's phone or any combination of the above.

As recited previously, according to aspects of the present disclosure, customers can access their loyalty program account directly by logging into the LPMS 117 portal either using a mobile phone application software installed on a smart phone, or alternatively via a web browser on any Internet enabled computing device, including computers and smart phones.

Turning now to FIG. 4, a flowchart is shown illustrating computer-implemented steps 400 performed in an exemplary customer session with the LPP 123, specifically from the perspective of the LPP Management Module 225. Customers can choose to log into a web portal hosted by the LPMS 117 or by the LPP 123 for various tasks associated with their loyalty points account. Examples of such tasks include obtaining information related to their loyalty points balance, reviewing history of previous loyalty points transactions, performing a loyalty points transaction, and various other tasks. As recited previously, aspects of the present system allow for fulfillment of loyalty points rewards to members of loyalty points redemption programs offered by various LPPs, wherein customers can choose to pick up the fulfillment items while shopping inside the premises of a merchant store. Examples of LPPs include airline companies, hotels, restaurants, credit card companies, financial institutions, etc. In what follows, details of the computer-implemented steps 400 performed in an exemplary customer session will be described next.

Starting at step 402, a network session is initiated with a customer during which the customer's credentials are received by the LPP 123. As recited previously, customers can log into the LPP 123 portal either using a mobile phone application software installed on a smart phone, or alternatively via a web browser on any Internet enabled computing device, including computers and smart phones. After receiving the customer's credentials, the LPP 123 validates the customer's credentials at step 404. Then, at step 406, the LPP 123 determines whether the customer is a valid customer or not. If the LPP 123 determines that the customer is not a valid customer, then the LPP displays (at step 408) a message to the customer indicating that the credentials provided by the customer are not valid.

If the LPP determines at step 406 that the customer's credentials are valid, then the LPP 123 hands off the customer's network session to the LPMS 117. With reference to the disclosure as presented herein, the customer session after hand off continues to be handled by a LPP process, particularly onwards from step 509 of FIG. 5. As will be understood and will be described in greater detail in the next paragraph, FIG. 5 indicates a flowchart showing details of computer-implemented steps performed by an embodiment of the LPMS in processing a loyalty points transaction, wherein at step 509 the LPMS 117 assembles a catalog of eligible goods and services associated with a particular loyalty program offered by a particular LPP, the catalog being the result of application of various business rules on a generic products catalog that is usually a master collection of goods and services from all suppliers affiliated with the LPMS. An exemplary products catalog and various exemplary business rules applicable on the items in a product catalog will be discussed in connection with FIG. 6 and FIG. 8C respectively. Exemplary screenshots showing various goods and services associated with a particular loyalty program are shown in FIG. 12-FIG. 14. It will be further understood that the hand off of the customer session (at step 410 in FIG. 4) is performed seamlessly in such a manner that the customer lands in a webpage displaying (step 510 of the process described in FIG. 5) the catalog 105 of eligible goods and services, and thereafter the customer session is handled by the LPMS 117. It will be understood by one of ordinary skill in the art that various encryption methods and data transfer protocols are involved in a hand off of a customer session.

Referring to FIG. 5 (consisting of FIG. 5A, FIG. 5B, FIG. 5C, and FIG. 5D), a flowchart 500 is shown illustrating steps and processes performed by various software modules and components of an embodiment of the LPMS 117. It will be recalled from FIG. 2 that the LPMS 117 comprises a LPMS management module 119 which further comprises a catalog module 205, a transaction module 207, and a user interface (UI) module 209. In the embodiment discussed in FIG. 5 a flowchart is shown wherein various steps of the flowchart have been annotated with either of the reference numerals 205, 207, 209 enclosed within parenthesis, indicative of the particular step being performed by one of the above-mentioned software modules, in an exemplary loyalty points transaction involving a customer, a LPP 123 and a merchant 109.

It will be recalled from our previous discussions that a merchant 109 is a supplier of goods and services associated with the loyalty points redemption program that is offered by the LPP 123 to the customer, wherein the loyalty points redemption program is managed and administered by the LPMS 117. According to an aspect of the present disclosure, the LPMS maintains a catalog of eligible items of goods or services that are redeemable by customers' loyalty points. It will be understood that the LPMS (more particularly, the catalog module 205) is also responsible for normalizing the heterogeneous information received from a variety of suppliers in different formats and different merchant-identifying parameters into a single standardized format before presenting as a catalog to customers. Examples of such heterogeneous information include (but are not limited to) product name, product description, product price in terms of a rewards currency, product availability, shipping availability, product image, customer review/rating, and the like.

Customers who are members of a loyalty points redemption program can access the catalog associated with the loyalty points redemption program via a browser on a customer's electronic device (such as laptops, desktops, tablets, smart phones, PDAs, etc.) or through an app on a customer's mobile device. The system, communicates with the LPMS to display the loyalty points available, and an online catalog maintained by the LPMS, and further allows the customer to view details of selected items that are available in the catalog for redemption using the customer's loyalty points. If the customer selects one or more items and places an order, the LPMS communicates with one or more merchants (suppliers) that provide such items (eligible goods and services) to ensure that the items are still available and begins processing the customer's order. Customers can elect via the mobile device to pick up the item while in store (real-time) or upon travel to that particular store. It will be noted that an entire loyalty points transaction takes place in real-time, allowing the customer the benefit of picking up redemption items while inside the premises of a merchant's store location, if the customer desires to do so and places the order while shopping at the merchant's store location. Alternately, customers can place an order via an electronic device and choose to have item(s) in the order drop-shipped to a convenient location.

In one embodiment, customers can access their loyalty points redemption program account via a web browser on a laptop, desktop or any computing device that is Internet-enabled. Subsequently, customers can select one or more items and place an order for fulfillment items, which the LPMS communicates to one or more merchants (suppliers) that provide the fulfillment items (eligible goods and services) to ensure that the items are still available and begins processing the customer's order. If the items are available, customers can elect to travel to the store and pickup their order, or can alternatively opt to have the items delivered via a shipping service. In what follows, detailed steps involved in management and redemption of loyalty points for purposes of fulfillment of loyalty points redemption program reward, as performed by an embodiment of the LPMS with options for in-store pickup or alternatively shipping delivery, will be described.

Starting at step 502 in FIG. 5A, a network session is initiated with a customer during which the customer's credentials (for example, a login and a password combination) are received by the LPMS 117. As recited previously, customers can log into the LPMS 117 portal either using a mobile phone application software installed on a smart phone, or alternatively via a web browser on any Internet enabled computing device, including computers as well as smart phones. It will be understood that customers can be at any place when logging into the LPMS portal, e.g., customer's home, place of work, on the road, a store location, or any other place. Although not shown in FIG. 5A, it will be understood that the LPMS 117 identifies the loyalty points redemption program(s) (and, correspondingly the associated LPPs 123) that a customer is associated with, based on the customer's unique login credentials.

After receiving (through an interface as shown exemplarily in FIG. 11) the customer's credentials, the LPMS 117 validates the customer's credentials at step 504. Then, at step 506, the LPMS 117 determines whether the customer is a valid customer or not. If the LPMS 117 determines that the customer is not a valid customer, then the LPMS 117 displays (at step 508) a message to the customer indicating that the credentials provided by the customer are not valid, and the process ends thereafter.

If the LPMS 117 determines at step 506 that the customer's credentials are valid, then at step 509, the LPMS 117 assembles a catalog (more, specifically a redemption catalog) of eligible goods and services associated with a particular loyalty program offered by a particular LPP, the redemption catalog being the result of application of various business rules on a generic products catalog, wherein a products catalog is usually a master collection of all goods and services offered by all suppliers affiliated with the LPMS. An exemplary products catalog and various exemplary business rules applicable on the items in a product catalog will be discussed in connection with FIG. 6 and FIG. 8C respectively. Then at step 510 in FIG. 5A, the LPMS displays a page containing the redemption catalog (or simply, catalog) of eligible goods and services to the customer, and further waits (at step 512) for the customer's response. Although not shown in FIG. 5A, it will be understood that in one embodiment, the LPMS 117 retrieves (from a LPMS database 121) and further displays the customer's name and the customer's loyalty points balance (pre-stored in a LPMS database 121), on the page wherein the catalog is displayed, as shown exemplarily in region 1202 in FIG. 12-FIG. 18. In another embodiment, the LPMS 117 communicates in real-time with the LPP(s 123 associated with the loyalty points redemption program(s) that the customer is a member of, to retrieve the customer's loyalty points balance. In yet another embodiment, a customer is able to browse a catalog page and review loyalty points redemption program catalogs, maintained by the LPMS 117 without logging in to the LPMS portal, but cannot perform a loyalty points transaction unless the customer's login credentials are validated.

As will be recalled from FIG. 1, loyalty points redemption program catalogs are updated by the LPMS 117 frequently to reflect changes in availability, quantity, pricing, or any inventory changes as communicated by suppliers, merchants, wholesalers, and retailers. Exemplary screenshots showing a catalog of eligible goods and services that are displayed to a customer who is performing a loyalty points transaction, along with additional product information are shown in connection with FIG. 12-FIG. 14.

Next, the customer provides a response which is received by the LPMS 117. Thus, at step 514, the LPMS 117 determines whether the customer's response indicates customer has selected an item and further desires to obtain additional information for the selected item. If the LPMS 117 determines that the customer's response indicates the customer has selected an item and further desires to obtain additional information for the selected item, then at step 516, the LPMS 117 communicates with the respective merchant (supplier) to obtain additional information for the item selected by the customer, wherein the selected item is offered for sale by the respective merchant. Such additional information comprises price of item, eligibility of item for in-store pickup, customer reviews, item availability, etc. Communication between the LPMS 117 and the merchants typically proceeds via merchant-provided APIs or via email, or even via formatted XML documents, as recited previously.

At step 518 in FIG. 5A, the LPMS 117 receives additional information for the item selected by the customer from the merchant, then displays this additional information to the customer at step 520, and subsequently waits for the customer's response at step 522. (Exemplary screenshots displaying additional product information is shown in FIG. 15A, FIG. 15B, and FIG. 15C.) In turn, the customer reviews the additional information for the item, and provides a response. If the customer desires to redeem the selected item, then the customer inserts the selected item in an online shopping cart to indicate that the customer desires to redeem the selected item. Consequently, at step 524 the LPMS 117 determines from the customer's response if the customer desires to redeem the selected item. If the LPMS 117 determines that the customer does not desire to redeem the selected item, then the LPMS 117 goes back to the earlier step 510 in order to re-display the page containing the catalog of goods and services, to the customer.

However, if the LPMS 117 determines at step 524 that the customer's response indicates desire to redeem the selected item (in other words, the selected item is inserted in the online shopping car by the customer), then the process moves to next step 526 as shown in FIG. 5B. At step 526, the LPMS 117 displays an online shopping cart along with a price of the selected item, as well as available method(s) of delivery available for the selected item, and then waits for the customer's response thereafter at step 528. Screenshot of an exemplary LPMS user interface illustrative of an online shopping cart prior to placement of an order by customers, is shown in FIG. 16. As will be understood and appreciated, information displayed in the online shopping cart is retrieved from pre-stored information in the LPMS database 121 in addition to the additional information received from the merchant at earlier step 518.

The customer reviews the online shopping cart (exemplarily shown in FIG. 16) prior to placing an order and selects a method of delivery for the selected item. As previously noted, according to aspects of the present disclosure, available methods of delivery for items offered for sale by merchants (suppliers) include an in-store pickup by the customer, or drop-ship via a suitable shipping service. According to one aspect, an order includes information comprising selection of a certain number of loyalty points, selection of an available method of delivery, and selection of one or more redemption items. For example, redemption items may be available for in-store pickup only, drop-ship only, or via both in-store as well as drop-ship delivery options. The price of a redemption items vary depending on the supplier, method of delivery, and various other factors. Typically, available methods of delivery for items offered for sale are decided by suppliers beforehand in time. Such decisions are provided to the LPMS 117, and pre-stored in an exemplary merchant table in the LPMS database 121, as shown in FIG. 7. However, in alternate embodiments, suppliers can make such a decision regarding available methods of delivery for items offered for sale, on the fly in real-time while a loyalty points transaction is being processed.

Still referring to FIG. 5B, at step 532, the LPMS 117 determines whether or not the customer's response indicates the preferred method of delivery as in-store pickup by the customer. It will be understood that according to an alternate aspect of the present disclosure and as recited previously, the customer can choose to have drop-ship of the item as the preferred method of delivery. Details of the steps implemented by the LPMS 117 if the customer chooses drop-ship as the preferred method of delivery will be described later (starting at step 567) herein. In what follows, details of the steps implemented by the LPMS 117 if the customer chooses in-store pickup as the preferred method of delivery, will be described next.

If the customer's response indicates in-store pickup, then the LPMS 117 communicates (at step 534) with the merchant to enquire about item availability and list of store locations where the item is available, and thereafter receives a corresponding response from the merchant at step 536. Consequently, at step 538 the LPMS 117 determines whether the merchant's response indicates item availability. If the merchant's response indicates that the item is unavailable, then the LPMS 117 displays (at step 540) a message to the customer indicating that the item is unavailable. As will be understood, an item is unavailable when the merchant is out of stock for the item selected by the customer.

As mentioned previously, if the customer chooses in-store pickup as the preferred method of delivery then the customer specifies a current location in the form of zip codes or a city/state corresponding to the customer's desired store pick-up location. According to one aspect, a location identification mechanism (such as GPS, or any other positioning technology) embedded in the mobile application associated with the LPMS user-interface 103 provides details of the customer's current location to the LPMS 117. According to another aspect, if the customer uses a POS system at the store to access the LPMS 117, then the POS system automatically provides the customer's current location. In yet another aspect, electronic tablet computing devices (such as an Apple® Ipad®) can also be used at the store to provide the customer's location to the LPMS 117.

Continuing with the description of step 538 in FIG. 5B, if the LPMS 117 determines that the item is available, then the process moves on to step 542 (as shown in FIG. 5C) in which the LPMS 117 displays the item's availability information to the customer along with a list of store locations, and waits for the customer's response thereafter at step 544 to select a particular store. As will be understood, the item's availability information to the customer along with a list of store locations, was provided to the LPMS 117 by the merchant at an earlier instance at step 536. A screenshot of an interface displaying a list of store locations is shown in FIG. 17.

As will occur to one of ordinary skill in the art, in many scenarios stores might undergo changes in inventory due to items being purchased or moved, and as a result, the list of store locations provided to the LPMS 117 by the merchant could potentially be outdated as it might not reflect the most recent inventory or item availability information. Consequently, it will be seen at a later step in the flowchart that the LPMS 117 communicates with the merchant again to verify that the item is available at the customer-selected store when submitting the final order.

Still continuing with the description of FIG. 5C, after the customer reviews a list of store locations where the selected item is available for pickup, the customer selects a particular store, which is received by the LPMS at step 546. An exemplary LPMS interface used by the customer to select a particular store is shown in FIG. 17. After receiving the customer's selection of a particular store, the LPMS 117 displays a summary of the order to the customer at step 548, and waits for the customer's response thereafter at step 550.

In turn the customer reviews the summary of the order, and provides a final confirmation of the order which is received by the LPMS 117 at step 552. Upon receiving the customer's confirmation, the LPMS 117 communicates (at step 554) with the LPP to place a hold on an appropriate number of loyalty points from the customer's loyalty points balance, corresponding to cost of items in customer's order. It will be understood that in alternate embodiments of the present system, the step 554 is an optional step which is usually performed at the discretion of the LPP, as indicated in the flowchart, and shown with a dotted rectangle. Next, at step 556, the LPMS 117 submits the order with the merchant (supplier) that is offering the items in the customer's order. After the order is placed with the merchant, the LPMS 117 waits for the merchant's response at step 557 in connection with the merchant's processing of the customer's order. In the following paragraph, various scenarios that govern the merchant's response in connection with the availability of the item will be described next.

It will occur to one of ordinary skill in the art that in many scenarios stores might undergo changes in inventory due to items being purchased or moved, and as a result, item availability information (received by the LPMS 117 at step 536) from the merchant could potentially be outdated as it might not reflect the most recent inventory. Thus, at step 558, the LPMS 117 receives the merchant's response and determines from the merchant's response whether or not the merchant has successfully placed an order for the item selected by the customer with the store location selected by the customer.

Still continuing with the description of FIG. 5C, if the merchant's response indicates that the merchant has not placed an order for the item selected by the customer at the particular store selected by the customer, then at step 559, the LPMS 117 communicates to the customer that the order has not been placed. According to one aspect, the LPMS 117 requests the customer to provide one or more alternate store locations where the customer desires to pickup the item. According to another aspect, the LPMS 117 reverts back to step 534 and communicates with the merchant requesting for an alternate list of store locations where the item is available.

If, however, the merchant's response indicates that the merchant has placed an order for the item selected by the customer at the particular store selected by the customer, then the LPMS redeems (deducts) loyalty points corresponding to the customer's order from the customer's loyalty points balance at step 560, and thereby updates the customer's loyalty points balance for the customer's loyalty points account in the LPMS database 121.

Further, as shown in FIG. 5D, at the next step 561, the LPMS 117 communicates details of the customer's order (the confirmation of which was received from the customer at an earlier step 552) and the customer's updated loyalty points balance, to the LPP, and whereby the LPP will update the customer's loyalty points balance in its database. According to one aspect, details of the customer's order that is communicated to the LPP is considered as an order placed transaction, or an order placed communication.

At step 562, the LPMS 117 displays a message to the customer indicating that the item is ready to be picked up at the merchant's store location that was selected (and received by the LPMS at earlier step 546) by the customer for pickup. Additionally, the LPMS 117 also provides to the customer instructions for pickup of the item. After the customer receives this message, the customer picks up the item from the store. It will be understood that the customer can be in premises of the store, browse a catalog, select an item, submit an order and thereby pickup the item in the order—the entire transaction taking place while the customer is inside the premises of the store. Alternatively, the customer can browse a catalog, select an item, submit an order earlier at a location other than the store, and then travel to the store for pickup later. It will be understood that the LPMS 117 waits (at step 563) for the merchant's response indicating that the customer has picked up the items from the store. Accordingly, the LPMS 117 receives such a response at step 564 after the customer has picked up the items from the store. Eventually, a final status of the customer's order and current loyalty points balance is provided to the LPP 123 by the LPMS 117 at step 565. Additionally, a message is also displayed (at step 566) to the customer by the LPMS 117 indicating that the transaction is complete. According to one aspect, such a message is displayed as an order complete message. In one exemplary aspect of the present disclosure, there may be a time lag between the time an in-store pickup order is placed, and a subsequent time when the item is available for pickup. Generally, such a time lag can depend on various factors such as merchant policies, time necessary to prepare an item for pickup, etc. In such scenarios, the LPMS could also inform the customer that the customer's order has been placed successfully with the merchant. Additionally, the LPMS receives intermediate order status information from the merchant, and the LPMS also notifies the customer (and/or the LPP) of the intermediate order status information until the item is available for pickup.

In various alternate embodiments, the LPP also notifies the customer of the final status of the customer's order and loyalty points balance. Various modifications of the embodiment of the LPMS 117 described in the foregoing will occur to those of ordinary skill in the art. Such modifications will be apparent from, or suggested by, the description above without departing from the substance or scope of the present disclosure.

Now reverting back to the description of FIG. 5B, the steps implemented by the LPMS 117 when the customer chooses drop-ship as the preferred method delivery, will be described in greater detail. It will be recalled that at step 532, the LPMS 117 determines whether the customer's response indicates the preferred method of delivery as in-store pickup by the customer, or not. In other words, the customer can choose to have the selected items drop-shipped to a convenient location via a suitable shipping service, instead of choosing in-store pickup as the preferred method of delivery. Thus, after determining at step 532 that the customer has chosen drop-ship as the preferred method of delivery, at next step 567 the LPMS 117 waits for the customer's response to provide a shipping address where the selected item will be drop-shipped. Consequently, the customer provides a shipping address that is received by the LPMS 117 (at step 568), and then the LPMS 117 communicates at step 569 the customer-provided address to the merchant who is offering the item selected by the customer, for sale. The merchant receives the address communicated by the LPMS 117 and then responds back to the LPMS 117 with the availability of drop-shipping to the customer-provided address. Response from the merchant related to availability of shipping option is received at step 570 from the merchant. If the merchant's response indicates that shipping option is unavailable, then this is further communicated to the customer by the LPMS 117 at step 572, and the LPMS process reverts back to an earlier step 567 in which the customer has the option of providing an alternate shipping address, and the process continues as described previously.

Still referring to FIG. 5B, if however, the merchant's response (received by the LPMS 117 at step 571) indicates that shipping option is available, then the process moves to next step 573 (shown in FIG. 5D) in which the LPMS 117 displays a summary of the order to the customer at step 573, and waits for the customer's response thereafter at step 574.

Referring to FIG. 5D, in turn the customer reviews the summary of the order, and provides a final confirmation of the order which is received by the LPMS 117 at step 575. Upon receiving the customer's confirmation, the LPMS 117 communicates (at optional step 576) with the LPP to place a hold on an appropriate number of loyalty points from the customer's loyalty points balance, corresponding to cost of items in customer's order, and thereafter submits (at step 577) the order with the merchant (supplier) offering the items in the customer's order. In the disclosed embodiment, the entity that hosts the LPMS 117 makes a payment to the merchant in real-time using a credit card. In a separate transaction, the LPP settles with the entity that hosts the LPMS, under pre-existing financial terms of agreement. It will be understood that in alternate embodiments, the LPMS can also make payments to the merchant in a batch mode, for example, on a weekly/monthly basis, or some other convenient time period.

After the order is placed with the merchant, the LPMS 117 waits for the merchant's response at step 578 indicating that the item in the customer's order has been placed. Accordingly, the LPMS 117 receives the merchant's response and determines from the response whether or not the item in the customer's order has been processed successfully by the merchant. If the LPMS 117 determines that the item in the customer's order has not yet been processed successfully by the merchant, then the LPMS 117 goes back to step 578 and waits for a response from the merchant indicating that the merchant has processed the customer's order.

On the other hand, if the LPMS 117 determines from the merchant's response at step 579 that the merchant has processed (placed) the customer's order, then the LPMS 117 redeems (deducts) loyalty points corresponding to the customer's order from the customer's loyalty points balance at step 580, and thereby updates the customer's loyalty points balance for the customer's loyalty points account in the LPMS database 121. Then, at the next step 581, the LPMS 117 communicates details of the customer's order (the confirmation of which was received from the customer at an earlier step 552) and the customer's updated loyalty points balance, to the LPP, and whereby the LPP will update the customer's loyalty points balance in its database. Then the LPMS 117 (at step 582) displays a message to the customer indicating that the customer's order has been processed, and thereafter the LPMS 117 waits for the merchant's response indicating that the item in the customer's order has been shipped. Accordingly, the LPMS 117 receives such a response at step 583 that the item in the customer's order has been shipped. Eventually, a final status of the customer's order and current loyalty points balance is provided to the LPP 123 by the LPMS 117 at step 584. Additionally, a message is also displayed (at step 585) to the customer by the LPMS 117 indicating that the transaction is complete. It will be apparent to one of ordinary skill that the time lag between the time an order is placed, and the time when the item is actually shipped may depend on several factors. Such factors can be related to item availability, merchant policies, chosen shipping carrier, type of shipping method chosen, etc. Therefore, in one aspect, merchants continue to update the LPMS with intermediate statuses of a customer's order, that in turn, is communicated by the LPMS to the LPP and/or the customer, until the item is shipped.

As will be understood and appreciated, the steps of the process shown in FIG. 5 (consisting of FIG. 5A, FIG. 5B, FIG. 5C and FIG. 5D) are not necessarily completed in the order shown, and various processes of the LPMS 117 may operate concurrently and continuously. Accordingly, the steps shown in FIG. 5 are generally asynchronous and independent, computer-implemented, tied to particular machines (including various modules/engines of the LPMS management module 119, LPMS servers, and end devices), and not necessarily performed in the order shown. As will be understood and appreciated, embodiments of the present disclosure are not limited to the specific processes or sequences for management of loyalty points redemption programs as discussed herein, and other embodiments may implement other processes as will occur to one of ordinary skill in the art. For example, various steps as shown in the flowchart are sequence-agnostic, and even optional, such as those involving updating a customer's loyalty points balance. It will be apparent to those skilled in the art that in alternate embodiments of the present system, the LPMS does not necessarily need to place a hold during a loyalty points transaction, as shown in FIG. 5. Alternately, the LPMS can update a customer's loyalty points after a transaction is complete. Additionally, the LPMS can communicate with the LPP and/or the customer in real-time in an interim stage while a customer's transaction is in process, e.g. by providing an order status information such that the order has been placed, availability information, price information, incomplete order information, current stage of processing or delivery, and the like. As will be understood, steps indicated as optional in the flowchart (by dotted rectangles) are for exemplary purposes only. Various other steps in the flowchart can be sequence-agnostic and/or optional, as will occur to one of ordinary skill in the art. Further, embodiments of the present disclosure are applicable on any number of customers, LPPs, suppliers, merchants and retailers.

Now referring to FIG. 6, an exemplary catalog table 211 (stored in an LPMS database 121) storing a collection of information related to goods and services available to members of loyalty points redemption programs, is shown. As recited previously, according to aspects of the present disclosure, the system presents to members of particular loyalty points redemption programs a single consolidated catalog containing goods and services across multiple suppliers, merchants and retailers. Such a catalog is updated by the LPMS 117 frequently to reflect changes in availability, quantity, pricing, or any inventory changes as communicated by suppliers who offer goods and services redeemable by loyalty points of customers. Customers who are members of a loyalty points redemption program can access the catalog associated with that loyalty points redemption program via a browser on a mobile device or through an app on the mobile device. Various columns and data stored in the catalog table will now be described.

As shown, catalog table 211 comprises the following exemplary columns: “Item Name”, “Item SKU”, “Merchant”, “Category”, “Sub-category”, “Item Price”, “Item Description”, “Review Rating”, “In-store Pickup Availability”. Various data stored in these columns will be better understood with the help of exemplary screenshots shown in FIG. 12-FIG. 15 (including FIG. 15A, FIG. 15 B, and FIG. 15C). A brief description of the data stored in these columns follows next.

Item Name indicates name of an item that is available for redemption by members of loyalty points redemption programs, the item being identified uniquely by an Item SKU, wherein the item is associated with a supplier (additional details of suppliers are stored in merchant table 213 shown in FIG. 7) and an item category and a sub-category. Price of the item is indicated in an Item Price column, and the specification for the item is described in an Item Description column. Reviews (rating) provided by other customers in connection with the item (identified by the Item SKU) are typically stored in the Review Rating column in the catalog table 211. Since an item can be eligible for in-store pickup such information is usually stored in an In-store Pickup Availability.

In exemplary catalog table 211 it can be seen that an item having an Item SKU “135-789” with an Item Name “Sony Cyber-shot 16.1 Megapixel Digital Camera—Silver” with a Review Rating “5 Star”, the item being classified in category “Electronics”, sub-category “Digital Cameras”, offered by a merchant “Walbuy” at a price of “$199.99” and available for in-store pickup.

As will be understood, information relating to availability of an item from one or more suppliers can vary. According to one embodiment, an item can be available from multiple suppliers at different prices. For example, as shown in FIG. 6, an item called “Sony Cyber-shot 16.1 Megapixel Digital Camera—Silver” is available with two different merchants called Walbuy and BestMart. However, it is also shown that the prices of the item is $199.99 at Walbuy and $309.00 at BestMart, and these items are identified with two different Item SKU. In such scenarios, wherein multiple merchants offer the same item at different prices, it will be understood that the LPMS typically applies various pre-specified criteria (conditions) pertaining to business rules prior to presenting a catalog for display to customers. Such business rules are usually specified by the LPMS, the participating merchants and/or the LPPs. Further discussions involving business rules will be recited again in connection with FIG. 8. It will be understood by one having ordinary skill in the art, the catalog table 211 is presented for illustrative purposes only, and embodiments of the present system 117 are not limited to data, information, and fields in the specific data table shown.

Now turning to FIG. 7, an exemplary merchant table 213 for storing data relating to several suppliers, merchants and retailers who provide goods and services to members of loyalty programs, is shown. As shown, merchant table 213 stores various exemplary columns such as “Merchant ID”, “Merchant Name”, “Sales Tax Required States”, and “Shipping Eligibility”. A brief description of the data stored in these columns follows next.

Merchant ID column indicates a unique number identifying a merchant whose name is stored in the column titled Merchant Name. According to one aspect, suppliers, merchants and retailers who offer eligible goods and services to members of loyalty points redemption programs conduct business in various states which charge different local sales taxes. Thus, the Sales Tax Required States column stores local sales tax charged by different states, as a percentage of the price of the item. Additionally, it will be generally understood that merchants (suppliers) can be localized in some states and therefore have limited capabilities of shipping items to other states or regions. The Shipping Eligibility column specifies the merchant's ability to ship items to addresses (provided by customers).

For example, as can be seen, a merchant named Walbuy, having a Merchant ID 23 does not ship to Hawaii and Alaska. Further, it is also seen that the local sales tax for items sold by Walbuy are 8.25% and 4.95% in New York and Kentucky respectively.

As recited previously, dollars are converted into loyalty points (a generic unit of currency), or vice-versa, according to predetermined conversion rates decided by the LPP and the entity that hosts the LPMS. Therefore, in the LPMS database 121 a loyalty points conversion table 215 shown in FIG. 8A stores different points-to-dollars conversion rates for various loyalty points redemption programs offered by different LPPs, and will be discussed next.

As can be seen, loyalty points conversion table 215 comprises the following columns: “LPP ID”, “LPP Name”, “Loyalty points redemption program Name”, “Tier” “Loyalty points redemption program ID”, Conversion Rate”, and “Loyalty Points Applicability Details”. LPP ID is a unique identifying number indicating a particular LPP offering loyalty points redemption programs and having a name that is indicated in a corresponding LPP Name column. It will be understood and appreciated that loyalty points redemption programs can be further subdivided into different tiers or segments that are offered by the same LPP, but are generally associated with slightly different criteria, such as but not limited to differences in catalog availability, or different points-to-dollars conversion rates, as discussed herein. It will be further understood that the different tiers or segments are inherently loyalty points redemption programs in their own merit. Customers can typically qualify to move from one tier to another one based on their degree of business they generate for the LPP, or their amount of involvement with the LPP's growth or various other business/marketing specific criteria, as will occur to one of ordinary skill in the art. Thus, the Tier column lists various tiers or segments of a loyalty points redemption program. Loyalty points redemption programs are identified by a unique number, typically called the Loyalty points redemption program ID, and associated with a unique LPP (or, equivalently a unique LPP ID) in one embodiment of the present disclosure. It will be understood that various tiers of a loyalty points redemption program will have different Loyalty points redemption program IDs.

As recited previously, each loyalty points redemption program applies different conversion rates for converting member's loyalty points into a dollar value amount. Dollars obtained from the conversion of members' redeemable loyalty points are provided by LPPs to the LPMS that in effect, enables the redemption of eligible goods and services from various merchants and retailers who are suppliers of goods and services associated with the respective loyalty points redemption programs. In one aspect, the LPMS 117 handles the conversion of loyalty points to dollars used for payment to such merchants and retailers, and thereafter pays such merchants and retailers using dollars obtained from the LPP after conversion. As shown in FIG. 8A, different conversion rates are stored in the Conversion Rate column. In addition to different conversion rates as discussed in the foregoing, different loyalty points redemption programs can apply specific rules that define eligibility of certain types of goods and services available to members of particular loyalty points redemption programs. Such rules are listed in the Loyalty Points Applicability Details column as shown in FIG. 8A. Exemplary data stored in connection with the loyalty points conversion table will be described next.

A hypothetical LPP called ABC Airline, identified by a LPP ID 10 with a Loyalty points redemption program Name called Sky Point having a Loyalty points redemption program ID 1001 that is single tiered, e.g. Silver Tier associated with a Conversion Rate of 150 points per one dollar cost of redeemable goods to members of Sky Point who are in the Silver tier. Further, the aforementioned loyalty points redemption program allows members to redeem all categories of goods and service from participating suppliers (which will be described in greater detail in connection with merchant eligibility table 221 in FIG. 8B), excluding home furnishings.

In another example, it can be seen from FIG. 8A that a hypothetical LPP called USA Credit Bank, identified by a Loyalty points redemption program ID 1901 with a Loyalty points redemption program Name called Club Points that is double tiered, e.g., a Premier Tier having a Loyalty points redemption program ID 1901, and a Champion Tier having a Loyalty points redemption program ID 1902. In the aforementioned example, Conversion Rate for members of the Premier Tier is 150 points per one dollar cost of redeemable goods except for items in home and gardening categories. On the other hand, Conversion Rate for members of the Champion Tier is 200 points per dollar cost of redeemable goods excluding items in an electronics category.

It can also be seen from FIG. 8A that USA Credit Bank has another loyalty points redemption program name called Super Points, in addition to the Club Points loyalty points redemption program. Super Points is also a double tiered loyalty points redemption program, i.e. a Gold Tier having a Loyalty points redemption program ID 1903, and a Silver Tier having a Loyalty points redemption program ID 1902. The loyalty points conversion rate for these above-mentioned tiers are 250 and 300 points respectively per one dollar cost of redeemable goods, and are applicable to goods and services in all categories offered by suppliers who are associated with the loyalty points redemption program, including various tiers of the loyalty points redemption program (if any).

It will be understood that suppliers who offer eligible goods and services for sale to customers via a loyalty points redemption program (including the constituent tiers of the loyalty points redemption program), in certain scenarios are required to satisfy certain eligibility conditions based on specific business rules created by the LPP 123 and the LPMS 117. For instance, some merchants (suppliers) are eligible to supply some specific kinds of goods and services, and even further, only to members of some particular loyalty points redemption programs (or the constituent tiers). A table storing a list of eligible merchants and suppliers who are associated with particular loyalty points redemption programs (and the constituent tiers) will be discussed next in connection with FIG. 8B.

In FIG. 8B, a merchant eligibility table 221 storing various rules and conditions for eligibility of merchants and suppliers associated with particular loyalty points redemption programs, is shown. As shown, merchant eligibility table 221 comprises various columns entitled, “LPP ID”, “LPP Name”, “Loyalty points redemption program Name”, “Tier”, “Loyalty points redemption program ID”, “Merchant ID”, and “Categories”. A brief description of the data stored in these columns follows next.

LPP ID is a unique identifying number indicating a particular LPP offering loyalty points redemption programs and having a name that is listed in the LPP Name column, wherein the name of the loyalty points redemption program is indicated in the Loyalty points redemption program Name. As mentioned previously, loyalty points redemption programs can be further subdivided into different tiers or segments that are offered by the same LPP, but are generally associated with slightly different criteria. It will be understood that the different tiers or segments are inherently loyalty points redemption programs in their own merit. Thus, the Tier column lists various tiers or segments of a loyalty points redemption program. For example, a LPP called USA Credit Bank with a LPP ID 19, offers two tiers called Gold and Champion tiers that are associated with loyalty points redemption programs called Super Points and Club Points respectively. Further details of the loyalty points conversion rates for these tiers was discussed previously in connection with FIG. 8A. Merchants offering specific types of goods and services to members of these tiers (loyalty points redemption programs) are described next.

As shown in FIG. 8B, loyalty points redemption programs are identified by a unique number, typically called the Loyalty points redemption program ID, and associated with a unique LPP (or, equivalently a unique LPP ID). Eligible merchants (suppliers) associated with particular loyalty programs are identified by a number indicated in the Merchant ID column. Further, specific goods and services offered by these merchants to members of loyalty points redemption programs are indicated in the Categories column of FIG. 8B. It will be noted that more than one merchant can be associated with a single loyalty points redemption program. For example, it can be seen that merchants (suppliers) identified as 5090 and 621 both offer items in electronics and books categories to members of Gold Tier associated with the Super Points loyalty points redemption program offered by USA Credit Bank that is identified by a LPP ID 19. On the other hand, it can also be seen that merchants (suppliers) identified as 621 and 23 both offer items in home goods, books and DVD categories to members of Champion Tier associated with the Club Points loyalty points redemption program offered by USA Credit Bank identified by a LPP ID 19. It can further be verified from the merchant table 213 discussed previously in connection with FIG. 7 that the names of merchants (suppliers) identified as 5090, 621, and 23 are BestMart, SuperShop, and Walbuy respectively. As seen from the above illustrative example, the same items of eligible goods and services can be offered by more than one merchant. Consequently, in such scenarios, the LPMS 117 applies criteria on how to manage conflicts. Such criteria will be discussed in connection with a catalog presentment table 223 discussed next.

Referring to FIG. 8C, a catalog presentment table 223 containing various criteria in the form of filters in connection with display of items in a redemption catalog to members of loyalty points redemption programs, according to one embodiment of the present disclosure. It can be seen that catalog presentment table 223 contains several exemplary columns entitled “LPP ID”, “LPP Name”, “Loyalty points redemption program Name”, “Tier”, “Loyalty points redemption program ID”, “Filter”, and “Method of Delivery”. It will be recalled that data stored in some of the aforementioned columns e.g. “LPP ID”, “LPP Name”, “Loyalty points redemption program Name”, “Tier”, and “Loyalty points redemption program ID” have been explained in previously connection with FIG. 8A and FIG. 8B. It is believed that further discussion on these columns is not necessary herein. Those skilled in the art will further understand that methods of construction of these data tables (and the data tables) are pretty standard practice in relational databases which can be used to construct various data tables as exemplarily discussed in the disclosure. It will be further understood that the aforementioned data tables share common data with each other and are mapped to each other by the same column names (a\k\a known as identifiers or records).

As shown in FIG. 8C, the catalog presentment table 223 contains a “Filter” column and a “Method of Delivery” column. It will be understood that the Filter column contains criteria used by the LPMS 117 in making a determination of which items to show members of loyalty points redemption programs when presenting a catalog, in what order, from which merchant, etc. For example, when the same item is available from multiple suppliers associated with the Silver tier of the Sky Point loyalty points redemption program offered by ABC Airline (identified as LPP ID 10), then the Filter column indicates that only the item with the best price will be shown first.

Furthermore, it will be understood that the Method of Delivery column specifies the method of delivery of items that are redeemed by members of a loyalty points redemption program. Continuing with the previously mentioned example, members associated with the Silver tier of the Sky Point loyalty points redemption program are eligible to obtain standard shipping only. In a different example, it can be seen from FIG. 8C that members associated with the Gold tier of the Super Points loyalty points redemption program offered by USA Credit Bank are eligible to obtain standard shipping as well as in-store pickup, and no preset criteria is applied by the LPMS 117 for displaying items in a redemption catalog to Gold tier members of that loyalty points redemption program, i.e. all results are shown to Gold tier members of that loyalty points redemption program. From the above discussions, it will be generally understood that the Filter, Method of Delivery columns in FIG. 8C and/or other columns (for example, Category, Sub-category, Item Price, and In-Store Pickup Availability columns in FIG. 6) are indicative of various criteria (conditions) pertaining to business rules that are implemented by the LPMS in connection with presentment of a catalog to customers. As will be generally understood, a (products) catalog is typically considered to be a collection of products from multiple merchants (suppliers). On the other hand, a redemption catalog is generally a subset of the products catalog, wherein a redemption catalog is dynamically assembled in real-time for presentment to customers, by the application of various business rules on a generic products catalog (displayed exemplarily in FIG. 6). In one embodiment of the present system, conditions associated with various business rules are pre-specified by a LPMS administrator (human being) through a LPMS user interface. In other embodiments, conditions associated with various business rules are pre-specified by merchants (suppliers) and/or the LPP.

Although not shown in FIG. 8C, it will be understood that according to one aspect, information relating to availability of an item from one or more suppliers can vary. According to one embodiment, an item can be available from multiple suppliers, however, the method of delivery of the item can differ from one supplier to another. For example, an item can be offered by one supplier for in-store pickup only, whereas the same item is available from another supplier for drop-ship delivery only. In such scenarios, wherein multiple merchants offer the same item with different methods of delivery, according to one aspect, the LPMS displays the same item twice to the customer, but with different methods of delivery. Accordingly, store location information where the item is available will also be displayed. It will be understood by one with ordinary skill in the art that the catalog presentment table 223 (and the accompanying discussions) presented herein are for illustrative purposes only, and embodiments of the present system are not limited to data, information, and fields in the specific data table shown.

Now turning to FIG. 9, a customer table 217 is shown, storing information of members of loyalty points redemption programs. As will be recalled from the previous discussion, customers can choose to redeem items using a combination of a dollar amount and loyalty points. In one embodiment of the present disclosure, the LPMS 117 stores credit card information for customers who have obtained items using a combination of a dollar amount and redeemable loyalty points. As shown in FIG. 9, the customer table 217 comprises “Customer ID”, “Customer Name”, “Total Loyalty Points”, “Credit Card Number”, and “Login/Password”. For example, it can be seen from FIG. 9, a customer whose Name is John Doe, identified by a Customer ID 1509 has a Total Loyalty Points of 25,000. Further, it can also be seen that the last four digits of the credit card number of that customer are 1892 (the rest of the digits in the credit card number are masked for security purposes). Also, the login of that customer is john15, the password of the customer also being masked for security purposes.

Turning now to FIG. 10, an exemplary order history table 219 indicating transaction history information of members associated with a loyalty points redemption program administered by the LPMS, is shown. As shown in FIG. 10, the order history table 219 comprises exemplary columns entitled “Column ID”, “Customer Name”, “Status History”, “Order Method”, “Customer's Payment Confirmation Number”, “Loyalty points redemption program ID”, “Loyalty Points Involved in Transaction”, and “Merchant ID”. Representative data stored in the above-mentioned columns will now be described next.

Customer ID column stores a unique ID for every customer identifying a member of a loyalty points redemption program and who has ordered one or more items through the LPMS 117 before. Customer Name indicates a name of a customer corresponding to the unique Customer ID. Status History column typically comprises dates, times and predetermined actions taken with respect to a customer's previous order. For example it can be seen from FIG. 10, a customer with a Customer Name John Doe identified by Customer ID 1509 placed an order for in-store pickup at 8:41 pm on Apr. 21, 2011 as indicated in the Status History column. Further, Status History also indicates that the above order for processed at 8:45 μm on Apr. 21, 2011.

Order Method column indicates the way a customer placed an order. It will be recalled from the earlier discussions that a customer can place orders using any Internet enabled computing device such as desktops, laptops, smart phones etc. by logging into the LPMS portal through a web browser. Alternatively, customers can also place orders via a user interface of a smart phone application (app) program that communicates directly with the LPMS 117. Accordingly, exemplary data in Order Method column indicates entries such as Mobile App, and Web Browser corresponding to two possible ways of placing orders, as discussed herein. As will be understood, other possible ways to place an order can include placing an order via a store kiosk or a retailer's POS system, utilizing the services of a customer services representative affiliated with the LPP or LPMS via phone, or any other mechanism that allows interfacing with a networked or web environment.

As shown in FIG. 10, a Customer's Payment Confirmation Number is an electronic identifier that uniquely represents confirmation of payment by a customer, either based on the customer's redeemable loyalty points, or a combination of dollar amounts and customer's redeemable loyalty points. Loyalty Program ID and Merchant ID column were previously discussed in connection with FIG. 8B. Loyalty Points Involved in Transaction column indicates the number of customer' redeemable loyalty points involved in a particular order transaction. For example, it can be seen from FIG. 10 that customer John Doe associated with a loyalty program identified by Loyalty Program ID 1001 (i.e. exemplary ABC Airline as can be further verified from FIG. 8B) performed a loyalty points transaction that involved 1500 loyalty points for obtaining goods/services from a supplier identified as Merchant ID 23, wherein the Customer's Payment Confirmation Number associated with this exemplary transaction is DX7913.

Again, it will be understood that the types of data and information shown in connection with data tables as illustrated in FIG. 6, FIG. 7, FIG. 8A, FIG. 8B, FIG. 8C, FIG. 9, and FIG. 10 are presented merely for exemplary purposes only, and other types of data may be included. From the foregoing it will be understood and appreciated that the LPMS 117 is able to offer flexible loyalty points redemption programs, and further streamline such programs based on different eligibility conditions on merchants (suppliers), good/services offered by them, and even provide greater granularity by dividing a loyalty points redemption program into various tiers for different kinds of customers. In the discussions that follow, various user interfaces of the LPMS portal will be described with exemplary screenshots.

FIG. 11 illustrates an exemplary login interface 1100 for the LPMS portal as displayed on a customer's computing device. As shown, customers can enter their credentials via a “User ID” and a “Password” field on this interface. Although the accompanying screenshots discuss an exemplary scenario wherein a customer is a member of a single loyalty points redemption program, it will be understood that customers can be members of multiple loyalty points redemption programs. Further, in one exemplary scenario, customers can use a single User ID/Password combination for logging into multiple loyalty points redemption programs.

After typing in their User ID and Password, customers click on a “Submit” button to submit their information to the LPMS 117. As recited previously, customers can log into the LPMS portal either using a mobile phone application software installed on a smart phone, or alternatively via a web browser on any Internet enabled computing device, including computers and smart phones. It will be understood that customers can be at any place when logging into the LPMS portal, e.g., customer's home, place of work, on the road, a store location, or any other place.

As will be recalled from FIG. 2, UI module 209 is responsible for hosting and serving the LPMS portal and interacting with the customer through this interface. After submitting their credentials, the UI module 209 validates the customer's credentials and upon successful validation the UI module 209 displays a page to the customer containing a catalog of eligible goods and services. An exemplary screenshot of such a page will be described next in FIG. 12.

Referring to FIG. 12, an exemplary catalog page 1200 is shown, as displayed to a customer. As seen in FIG. 12, region 1201 displays a selection menu for various kinds of goods and services such as merchandise, event tickets, and activities that are available to members of a loyalty points redemption program. In screenshot 1200, a “merchandise” menu is indicated as highlighted. It is seen from region 1202 in FIG. 12 that the LPMS 117 displays the catalog page 1200 to a customer called “Andy Althauser” who has a loyalty points balance of 10,000 (ten thousand). As will be understood, in the screenshots that follow in FIG. 13 through FIG. 19, region 1202 will indicate that the customer associated with the screenshots is named “Andy Althauser” who has a loyalty points balance of 10,000 (ten thousand). However, it will be understood that such a customer is for exemplary purposes only, and different customer names and loyalty points balance will be displayed for other customers who log in to the LPMS portal.

In an embodiment of the present system, the LPMS stores a history of a customers interactive session with the LPMS portal. For example, in one scenario, customers who have clicked on one or more items displayed on the catalog page are able to review such items. Region 1204 displays a “My Viewed Items” menu that allows a customer to review items displayed on the catalog page that the customer has particularly shown interest in, by clicking on the respective items. It will be understood that allowing the customer to review such items usually implies that the LPMS 117 stores a history of items recently viewed by the customer.

As shown in FIG. 12, a first search box 1206 allows a customer to search for specific items under specific categories and sub-categories in the catalog. For example, if a customer chooses to search for digital cameras listed under sub-category Camera and Photo, wherein the sub-category is further listed under a category Electronics, a drop-down menu in the first search box 1206 provides such a functionality to the customer. In addition to the first search box 1206, a second search box 1208 allows the customer to type in text corresponding to the item that the customer is searching for.

It will be recalled from the earlier discussions that according to one aspect, the present system provides the benefit of in-store pickup of items redeemed by customers. A check box or a selection box 1209 (as seen on screenshot 1200) allows customers to select in-store pickup option only. Box 1209 allows customers to select redemption items (for example, cameras) that are available for in-store pickup only. Deselecting the box allows customers to review redemption items that are available for either, or both in-store pickup as well as drop-ship delivery options.

In addition to the search options discussed above in connection with screenshot 1200, customers can further specify a minimum and a maximum price range that would filter the results of the customer's search according to the customer-specified minimum and maximum price ranges. Boxes 1210 and 1212 as displayed on the interface shown in FIG. 12 are used by customers to specify a minimum and a maximum price range of the item that the customer is searching for.

As will be understood, screenshot 1200 displays a catalog of eligible goods and services, associated with a particular loyalty points redemption program. In one embodiment, such goods and services are listed under categories and sub-categories. Examples of categories (as displayed in region 1214 of FIG. 12) include apparel, automotive, baby, electronics and many more. It will be further understood that items under a category are further listed under sub-categories, and stored in an exemplary catalog table 211 as shown in FIG. 6. Examples of sub-categories for the category electronics include TV and video, Ipod and mp3 players, camera and photo etc. Exemplary sub-categories and their corresponding categories are displayed in region 1216 of screenshot 1200. As can be seen from FIG. 12, region 1214 displays a listing of various categories. These categories along with the corresponding sub-categories are displayed in region 1216. It will be understood that various attributes (categories, sub-categories, display boxes, etc.) indicated in screenshot 1200 are for exemplary purposes only. Various modifications of the attributes that are displayed can be possible, as will occur to one of ordinary skill. Next, further details of an exemplary sub-category listed under an exemplary category will now be discussed.

FIG. 13 is a screenshot 1300 of an exemplary LPMS user interface displaying various product sub-categories in a catalog of eligible goods and services, associated with a particular loyalty points redemption program, according to one embodiment of the present system. It will be understood that the screenshot 1300 will be displayed when a customer has clicked on the sub-category named camera and photo corresponding to an electronics category in FIG. 12. Accordingly, the LPMS automatically populates the search box 1302 with camera and photo, and displays further details of the camera and photo sub-category in region 1306 and 1308 respectively. As can be seen from FIG. 13, exemplary sub-categories include digital cameras, lenses, camcorders, digital slr's (single lens reflex) etc. It will be understood that when customers click on a sub-category, various items listed in the sub-category will be displayed to a customer. In the discussions that follow, a customer clicks on the sub-category digital cameras, and accordingly an exemplary page (as shown in FIG. 14) listing several digital cameras is displayed to the customer.

Turning to FIG. 14, an exemplary screenshot 1400 is shown of an exemplary LPMS user interface displaying a list of items in a product sub-category in a catalog of eligible goods and services, associated with a particular loyalty points redemption program. As mentioned previously, a customer typically reviews such an interface after clicking on a product sub-category (for example, digital cameras) as shown in FIG. 13. As shown in FIG. 14, region 1402 displays various brands of digital cameras, such as Panasonic, Casio and many others. A number enclosed in parenthesis next to the brand names indicates a number of items available for that particular brand. For example, there are 31 (thirty-one) digital cameras belonging to the Panasonic brand, and 24 (twenty-four) digital cameras belonging to the Casio brand. In one embodiment, the LPMS 117 allows customers to sort the items displayed based on several criteria such as best-selling items, price of items from a high price to a low price, average customer review, and various other criteria as will occur to one of ordinary skill. Therefore, it can be seen in screenshot 1400, a sort box 1404 having a drop-down option for selection of various sort criteria, is provided. Further, customers also have the option of controlling the number of items displayed in a page based on a “Results Per Page” box 1406. In screenshot 1400, the results per page is indicated as 12 (twelve) items per page.

It will be recalled from FIG. 6 that an exemplary catalog table (in LPMS database 121) stores various item related information such as customer review, price etc. In one embodiment of the present system, such information is displayed in regions 1408 and 1410 respectively. It will be noted that the price as displayed to a customer is in terms of loyalty points, instead of the dollar value of the item. As will be understood and appreciated, there is a dollar to points conversion involved in the process of displaying price of an item in terms of loyalty points to customers of loyalty points redemption programs. As will be understood, merchants (suppliers) of goods and services first specify a dollar value cost of items. Then, the LPMS 117 applies loyalty points conversion criteria (for example, as displayed in FIG. 2 and FIG. 8A) to transform a dollar value cost to an equivalent loyalty points cost, that is eventually displayed to the customer. As will occur to one of ordinary skill in the art, the same item can be priced differently depending on the profit margins of different suppliers. Even if the item is priced identically at more than one supplier, different conversion rates of dollars-to-loyalty points can result in a scenario where the item is priced differently (in terms of loyalty points) at different merchants. It will be understood that suppliers have different business relationships with the LPPs and/or the entity that hosts the LPMS, thus resulting in different conversion rates of dollars-to-loyalty points.

It will be recalled from the previous discussion on loyalty points conversion, in the LPMS database 121 a loyalty points conversion table 215 (shown in FIG. 2 and FIG. 8A) stores different points-to-dollars conversion rates for various loyalty points redemption programs offered by different LPPs. Dollars obtained from the conversion of members' loyalty points are provided by LPPs to the LPMS that in effect, enables customers to redeem eligible goods and services from various merchants and retailers who are suppliers of goods and services associated with the respective loyalty points redemption programs. In one aspect, the LPMS 117 handles the conversion of loyalty points to dollars used for payment to such suppliers, merchants and retailers, and thereafter pays such suppliers, merchants and retailers using dollars obtained from the LPP, such dollars being generated from the result of conversion of members' loyalty points.

It will be further recalled from the earlier discussions that merchants and suppliers associated with a loyalty points redemption program satisfy certain program eligibility conditions, for example as discussed in connection with a merchant eligibility table 221 shown in FIG. 2 and FIG. 8B. Thus, it will be understood and appreciated that items displayed to customers on a catalog page (for example, as shown in FIG. 14) are the result of the transformation between item prices specified by merchants (suppliers) in dollars to loyalty points, based on the conversion rates in a loyalty points conversion table in conjunction with merchant eligibility conditions specified in a merchant eligibility table.

In many scenarios, the same items of eligible goods and services can be offered by more than one merchant. Consequently, and as noted previously, in such scenarios, the LPMS 117 then applies criteria on how to manage conflicts. A catalog presentment table 223 (shown in FIG. 2 and FIG. 8C) contains criteria used in making a determination of which items to show members of loyalty points redemption programs when presenting a catalog, in what order, from which merchant, etc. Thus, it will be understood and appreciated that various items displayed to customers on a catalog page are the result of applying various presentment criteria to the items prior to them being displayed to customers. Examples of catalog present criteria can further include average customer reviews, price of an item etc. As shown in FIG. 14, region 1408 displays average customer review (in terms of average number of stars, for example), and region 1410 displays various price ranges and the items in the respective price ranges. As shown in region 1410, the number of digital cameras that cost between 0 (zero) and 50000 (fifty thousand) loyalty points are 9 (nine) in quantity.

It will be understood and appreciated that in one embodiment of the present disclosure, customers can choose to redeem items using a combination of a dollar amount and loyalty points. An exemplary customer table 217 (stored in LPMS database 121) showing pre-stored credit card information for customers who have redeemed items using a combination of a dollar amount and loyalty points, is shown in FIG. 2 and FIG. 9.

In many scenarios, customers obtain a discount on the retail price of an item when they redeem items through the LPMS portal using their loyalty points, as opposed to buying items directly from suppliers, merchants and retailers. Region 1412 in FIG. 14 displays that a customer obtains a discount of 13% (thirteen percent) of the actual retail price of an item called “Sony Cyber-Shot 16.1 Megapixel Zoom Digital Camera—Silver”, wherein the item costs 19,884 (nineteen thousand eight hundred and eighty four) loyalty points to a customer, the item being eligible for in-store pickup only. Moreover, it can be seen that region 1412 displays summarized item information for many other digital cameras, with some of the cameras being available for in-store pickup while some other cameras available for drop-ship only, while yet some other cameras are available via both in-store pickup as well as drop-ship delivery. Accordingly, it will be understood that box 1209 will allow customers to select redemption items (for example, cameras) that are available for in-store pickup only. Deselecting the box (as indicated in FIG. 14) allows customers to review redemption items that are available for either, or both in-store pickup as well as drop-ship delivery options. It will be understood that when a customer clicks on an item from a list of displayed items in a sub-category, or alternatively a “View Details” button displayed next to the item, the customer will be directed to a page containing additional details of the item (for example, as shown next in FIG. 15 that further consists of FIG. 15A, FIG. 15B, and FIG. 15C).

In FIG. 15A, an exemplary screenshot 1504 indicating additional details of the item called “Sony Cyber-Shot 16.1 Megapixel Zoom Digital Camera—Silver” that was displayed in summary form in FIG. 14, will be revealed. In one aspect, these details are indicated in various user-interface tabs, for example, a “Features” tab 1504, a “Summary” tab 1506, and an “Attributes” tab 1508. As can be seen, region 1502 in FIG. 15A displays model number of the item, customer rating, price in terms of loyalty points, eligibility for in-store pickup, estimated time to ship items via standard shipping service, and various other details. For example, the above-mentioned item has a model number DSCW570, costs 20,712 loyalty points and provides a savings of 13% to customers in comparison to the retail price of the item. It is further seen from region 1502 that a customer can add the above-mentioned item in an online shopping cart by clicking on an “Add to Cart” button. Those skilled in the art will understand that the default quantity of items in the customer's online shopping cart is 1 (one). If a customer wishes to insert more items in the customer's online shopping cart, then the customer can edit the “Quantity” box in region 1502.

Features tab 1504 displays various features related to the above-mentioned item such as the item is a digital camera having 5× optical zoom and 2.7″ LCD display, and various other details. If a customer wishes to review further details of the item, then the customer clicks on a “Summary” tab 1506, or alternatively, an “Attributes” tab 1508. Details of the information displayed in these tabs will be described next in connection with FIG. 15B and FIG. 15C respectively.

FIG. 15B is an exemplary screenshot of a “Summary” tab 1506 showing a summary of the above-mentioned item. Exemplary details shown in the summary tab 1506 include 16.1 megapixel camera, ability to capture detailed images and 720P HD movies, ability of the item to have face detection, smile and anti-blink technologies and other information. In the following paragraph, an Attributes tab 1508 will be described in greater detail.

FIG. 15C is an exemplary screenshot of an “Attributes” tab 1508 displaying various attributes of the above-mentioned item (specifically, the digital camera as shown in region 1502 in FIG. 15C). Information displayed in the attributes tab include, the optical zoom, the digital zoom, the ISO equivalent and various other attributes of the above-mentioned item. It will be understood that region 1502 (and the information therein) is commonly displayed in Features tab 1504, Summary tab 1506 as well as Attributes tab 1508. A customer who wishes to redeem the exemplary, above-mentioned item clicks on “Add to Cart” button displayed in region 1502. Upon clicking on the “Add to Cart” button, the item will be placed in customer's online shopping cart, and subsequently the LPMS 117 displays the customer's online shopping cart to the customer, as will be described next. It will be understood that in alternate embodiments of the present system, various other specifications of the item can be displayed (in separate tabs, as shown in FIGS. 15A-15C, or otherwise), as will occur to one skilled in the art.

Now turning to FIG. 16, an exemplary screenshot 1600 of a customer's online shopping cart is shown. It will be understood that FIG. 16 is illustrative of the customer's online shopping cart prior to placement of an order by customers, in an exemplary loyalty points transaction. As can be seen from region 1602 in FIG. 16, the total cost of items on the customer's online shopping cart is worth 41,424 (forty-one thousand four hundred and twenty-four) loyalty points in the loyalty points transaction. This is because the customer has chosen to redeem two (2) items as indicated in the Quantity region 1606. Further, region 1604 indicates various consecutive stages in a typical checkout process. From region 1604 in the screenshot 1600, it can be seen that the “Review” stage is highlighted indicating that the customer is presently reviewing the online shopping cart. It is also seen that subsequent stages of a typical checkout process include the following consecutive stages, “Shipping”, “Confirm”, and “Complete”. Region 1608 indicates that the number of loyalty points needed for the redemption of one (1) item is 20,712 (twenty-thousand seven hundred and twelve) as was noted previously from region 1502 in FIG. 15A-FIG. 15C. Since the customer has chosen to redeem two (2) items as indicated in the Quantity region 1606, the total number of loyalty points needed to place the order, or equivalently, the cost of the items in the customer's order is 41,424 (forty-one thousand four hundred and twenty four). If the customer decides to cancel the order, then the customer can do so by clicking on a “Remove” button in “Remove” region 1612 in screenshot 1600. It will be understood that a customer can make changes to the quantity (Quantity region 1606) of items by typing in a new quantity in place of the old quantity. Then, the customer clicks on an “Update Cart” button 1614 to update the changes to the quantity of items to be redeemed by the customer.

As mentioned in several places in this disclosure, a customer can opt for in-store pickup of items that are eligible for in-store pick up, or alternatively, the customer can opt for drop-ship method of delivery of the items. As seen in FIG. 14 as well as in FIG. 15A, FIG. 15B and FIG. 15C, the above-mentioned exemplary item is eligible for in-store pickup. Hence, if the customer chooses in-store pickup, the customer indicates such a desire to the LPMS 117 by clicking the “in-store pickup” option as shown in region 1616 of FIG. 16.

Based on the quantity of items entered by the customer in region 1606, and the cost of the item (in loyalty points), the LPMS 117 computes the total loyalty points needed to complete the order. In one embodiment, the LPMS 117 also displays the previous balance of the customer's loyalty points, and the future balance at end of the current loyalty points transaction. As shown in region 1618 in FIG. 16, the customer has a balance of 100,000 (one hundred thousand) loyalty points, and this will reduce to 58,576 (fifty-eight thousand five hundred and seventy-six) after the current loyalty points transaction is completed. This is because, and as will be recalled, the cost of the items in the customer's order is 41,424 (forty-one thousand four hundred and twenty four).

If the customer decides to continue shopping, then the customer clicks on the “Continue Shopping” button 1620, in which case the items remain on the online shopping cart, and a final order is not placed. Further, upon clicking button 1620, the customer is returned to the catalog page displaying various goods and services, for example as shown in FIG. 12. If, however, the customer decides to checkout, then the customer clicks on “Proceed with Purchase” button 1622. As recited previously, according to one aspect of the present disclosure, a LPMS user interface can be configured as a mobile device application, and therefore, a location identification mechanism (such as GPS, or any other positioning technology) embedded in the mobile device application associated with a LPMS user-interface provides details of the customer's current location to the LPMS 117. Based on the customer's location obtained via customer's input or a location identification mechanism (such as GPS), the LPMS 117 displays a list of stores around a fixed distance of the customer's current location where the items in the customer's order (as displayed exemplarily in FIG. 16) are potentially available. In another aspect of the present disclosure, the customer uses a POS system at the store to access the LPMS user interface, then the POS system automatically provides the customer's current location.

In yet another aspect, and as recited previously, a customer accesses the LPMS user interface via a computing device such as a desktop or a laptop computer. In such a scenario, the customer further specifies a current location in the form of zip codes or a city/state corresponding to the customer's desired store pick-up location. In another example, the LPMS utilizes a location corresponding to a customer's default location that is pre-stored in the LPMS database, wherein the default location is stored as a part of a customer's profile information. Subsequently, a list of stores pre-stored in the LPMS 117 as available from suppliers, merchants and retailers, is displayed to the customer. It will be understood that such a list is updated intermittently or periodically.

According to one embodiment, the LPMS 117 queries the merchant involved in the customer's order in real-time for a list of store locations where the items are available. According to another embodiment of the present disclosure, it will be understood and appreciated that the LPMS 117 communicates with merchants via merchant-provided APIs (Application Programming Interfaces). In turn, the merchant provides a response via a respective merchant API to the LPMS 117 with a list of store locations where the items are available. The LPMS 117 displays such a list to the customer. An exemplary screenshot illustrating a list of merchant store locations, as displayed to a customer is shown in FIG. 17, and will be described next.

Now turning to FIG. 17, a screenshot 1700 is shown of an exemplary LPMS user interface displaying a list of merchant store locations where an item is available to be picked up. As shown in region 1702, a customer can enter a zip code (“Zip Code” box), or, a city (“City” box) and a corresponding state (“State”) where the city is located. After the customer has entered any of a zip, or, a city in conjunction with a state, the customer clicks on a “Find Nearest Store” button to query the LPMS 117 for locations where the items are available for in-store pickup. Alternatively, the customer can cancel the search, and consequently will be redirected to the catalog page displaying various goods and services available via the loyalty points redemption program, for example as displayed in FIG. 12.

If the customer clicks on the “Find Nearest Store” button in region 1702 (in FIG. 17), then the LPMS 117 displays of list of merchant store locations where an item is available to be picked up. Additionally, the LPMS 117 also provides customers a map and directions to the merchant store locations. According to one embodiment, a list of stores (where the item is potentially available) can be pre-stored in the LPMS 117 as available from suppliers, merchants and retailers, and such a list is updated intermittently or periodically.

In one aspect of the present disclosure, the LPMS 117 additionally allows customers to check availability of the items at a particular store location in real-time by clicking on “Check Availability” button 1704. Consequently, the LPMS 117 queries the merchant in real-time enquiring about the availability of the items at the particular store locations selected by the customer (previously by clicking on “Check Availability” button 1704). According to one embodiment of the present disclosure, it will be understood and appreciated that the LPMS 117 communicates with merchants via merchant-provided APIs (Application Programming Interfaces). The merchant provides a response to the LPMS 117 containing item availability at the particular store location, via a respective merchant API, and the LPMS 117 subsequently displays the availability information of the items to the customer. As shown in region 1706 in FIG. 17, if the items are available at the particular store location, then the LPMS 117 displays the availability information of the items to the customer with a message “All Items Available”.

If the items are available at the particular store location selected by the customer, then the customer clicks on the “Select” button shown in region 1706, to finalize the selection of that particular store for in-store pickup of the items. (Although not shown in FIG. 17, it will be understood that if the items are not available at a store location selected by the customer, then the LPMS 117 displays a message to the customer indicating that the items are unavailable.) For example, as shown in FIG. 17, the merchant store location finalized by the customer is “Walbuy—North Lake” located at “4145 Lavista Road, North Lake Square, Tucker, Ga. 30084”.

Still continuing with FIG. 17, the LPMS 117 receives the customer's final selection of a store (for example, as shown in region 1706) where the items are available for in-store pickup, and then displays a summary of the customer's order to the customer for a final confirmation, as will be described next in connection with FIG. 18.

Referring to FIG. 18, a screenshot 1800 of an exemplary LPMS user interface showing summary of an order, prior to redemption of items in a transaction using loyalty points, is shown. As shown in region 1804, the summary of the items to be redeemed by the customer, is displayed. It can be seen that the summary includes the item (for example, “Sony Cyber-Shot 16.1 Megapixel Zoom Digital Camera—Silver”), quantity (for example, “2”) of items, cost of item (for example, “20,712”) in terms of loyalty points, and the total cost (for example, “41,424”) of items in terms of loyalty points. Also, in region 1802, the merchant store location where the items will be picked up, is also indicated by the LPMS 117 to the customer. For the example displayed in FIG. 18, and as will be understood from the previous discussion the merchant store location finalized by the customer is “Walbuy—North Lake” located at “4145 Lavista Road, North Lake Square, Tucker, Ga. 30084”.

Summary of the customer's loyalty points balance after the loyalty points transaction is completed, is displayed in region 1806. It will be recalled that such information was displayed in region 1618 in FIG. 16, and is not repeated in the discussion herein. In certain instances, for in-store pickup of items, customers can get a discount of loyalty points on their order, depending on various factors. Such factors typically depend on the merchant that is offering the item for sale, the LPP that offers the loyalty points redemption program, the items that are on sale, and the like. Thus, in connection with FIG. 18, in region 1806, it can be seen that the customer gets an in-store pickup discount of 828 (eight hundred and twenty-eight) loyalty points.

Additionally, the LPMS user interface notifies the customer that the customer will receive an email when the items are ready for pickup, and accordingly requests the customer to verify the customer's email address. In one embodiment, the customer's email is previously provided by the LPP to the LPMS, when the customer's loyalty points account is first created in the LPMS 117. In another embodiment, the customer enters the customer's email address when asked by the LPMS to verify the customer's email address.

After reviewing the summary of the order, the customer can place the order to redeem the items by clicking on a “Purchase Now” button 1810. Alternatively, the customer can choose to modify the order by updating the items in the customer's online shopping cart. An “Update Cart” button 1808 is provided on the LPMS user interface for that purpose.

If the customer clicks on the “Purchase Now” button 1810, then the LPMS places a hold on an appropriate number of customer's loyalty balance and the order is successfully submitted with the merchant. In turn, and as mentioned previously, the merchant submits the order with the respective store location finalized by the customer for in-store pickup. Then, the merchant starts processing the order. In an exemplary embodiment, In another exemplary embodiment, the LPMS 117 displays a page showing final confirmation of the customer's order to the customer. Such a page will be described next in connection with FIG. 19.

Now turning to FIG. 19, an exemplary screenshot 1900 of a LPMS user interface displaying a final order confirmation page, as displayed to a customer is shown. As will be recalled from FIG. 3 and FIG. 5, the LPMS 117 provides instructions to the customer related to store pickup information (or shipping information), as applicable to the customer's order. It will be further recalled that the pickup information was provided to the LPMS 117 by the merchant at an earlier instance. Therefore, in FIG. 19, region 1901 displays such information to the customer in an exemplary loyalty points transaction. As shown exemplarily in region 1901, the customer Andy Althauser is informed that his order was successfully placed and is provided with an order number “13004529”.

Further, region 1901 also indicates that the customer could contact a customer service center (associated with the entity that hosts the LPMS 117) if the customer has questions or comments regarding the customer's order. The customer service center's exemplary email address and phone number is displayed. Additionally, as shown in region 1901, the customer is notified that legal terms and conditions defining rules and requirements pertaining to the customer's loyalty points redemption can be reviewed at a specific location of a page in the LPMS web interface, for example in the upper right hand corner of the catalog page.

Moreover, it can also be seen from region 1901 in FIG. 19 that the address of the store location where the customer will be picking up the order is also displayed. In the example shown, the address of the store location, as will be recalled from the earlier discussions is “4145 Lavista Road NorthLake Square, Tucker, Ga. 30084”, associated with the merchant store Walbuy.

Upon reviewing the information that is displayed to the customer and is discussed above, the customer can choose to continue shopping or, alternatively, can print confirmation information (comprising the order confirmation number and the address of the store location). If the customer chooses to continue shopping, then the customer will be redirected to the catalog page (shown exemplarily in FIG. 12) that displays eligible goods and services available to the customer through the loyalty points redemption program that the customer is a member of. Hence, respective buttons 1902 and 1904 are provided on the user interface that when clicked would allow the customer to choose to continue shopping, or alternatively print the order confirmation information.

Along with the order confirmation information, and in the embodiment shown in connection with FIG. 19, the LPMS 117 notifies (as indicated in region 1906) that the customer will receive an email informing when the item are ready to be picked up from the store. It can be appreciated that the LPMS 117 indicates that the customer will typically receive this email within the next forty-five minutes of receiving this notification. Moreover, the LPMS 117 also indicates that the customer should contact the customer service center (of the entity that hosts the LPMS 117) in the event that the customer does not receive an email within the next ninety minutes of receiving this notification. From the foregoing, it will be understood and appreciated that a loyalty points transaction using the disclosed LPMS 117 is a real-time phenomenon, happening within a very short interval of time that allows customers to redeem items while on premises at a merchant store location. That is, in general, a customer shopping at the exemplary Walbuy store will be able to order and pick up the items while shopping on premises. Alternatively, in another aspect, a customer can order items using a laptop computer or a mobile device, and can subsequently travel to the store location and pickup items thereafter.

In region 1908 in FIG. 19, the balance of the customer's loyalty points (for example, 58,576) and the total cost of (for example, 41,424) the items in the cart are displayed. As will be understood, the screenshots discussed herein are for exemplary purposes only, and other embodiments of the LPMS 117 may have different LPMS user interfaces or they may display other information as will occur to one of ordinary skill in the art. Although not shown in the screenshots displayed herein, it will be recalled (from the discussion of FIG. 1 and FIG. 5) that according to alternate aspects of the present disclosure, a customer can choose to have the items shipped to a shipping location via a convenient shipping service.

As recited repeatedly throughout this disclosure, embodiments of the LPMS are able to communicate with numerous types of electronic devices remotely via predetermined communications algorithms (e.g., device proxies). This communication often entails sending instructions to the respective devices to initiate some action with respect to the power states of the devices. It will be understood and appreciated that, in one embodiment, this control is accomplished by providing instructions to IP-enabled devices that are pre-programmed to enable remote control and functioning based on the provided instructions. As will be understood, remote control of devices can occur via any specific mechanism as will occur to one of ordinary skill in the art.

As described in detail above, aspects of the present disclosure generally relate to systems and methods for managing and monitoring a plurality of assets (in real time as well as in non-real time) using an energy management system (EMS). Additional aspects relate to easily and efficiently installing (for example, with a simple plug-and-play mechanism) an EMS to manage, monitor, and control pre-existing assets at one or more facilities. Also, aspects of the present disclosure relate to normalizing asset information across varying vendors, makes, and models of assets that are located at various geographically distributed facilities, for management of heterogeneous, distributed assets via a single interactive dashboard interface. Further, aspects of the present disclosure are directed to generating various reports containing operational information relating to the assets, actual (and projected) cost savings and greenhouse emissions based on actions taken with respect to the assets, and analytics related to energy management that are utilized by organizations (entities) and private individuals to develop strategies for optimum energy efficiency management.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

1. A method for effecting the redemption of loyalty points maintained in a networked computer-based loyalty points redemption program by a loyalty points provider to a customer via the display, selection, and acquisition of loyalty points redemption items through an online catalog of predetermined eligible redemption items available from one or more suppliers, comprising the steps of:
(i) maintaining a catalog in a network-accessible, computer-based loyalty points management system (LPMS), the catalog comprising information relating to a collection of eligible loyalty points redemption items that are eligible for redemption by customers in a loyalty points redemption program maintained by a loyalty points provider;
(ii) in response to login of a customer to the LPMS via a networked customer electronic device, identifying a loyalty points redemption program that is maintained by a loyalty points provider on behalf of the customer;
(iii) generating a user interface (UI) to the customer electronic device, the UI providing a display of the loyalty points account balance for the identified loyalty points redemption program as maintained by a loyalty points provider system (LPPS) on behalf of the customer;
(iv) assembling catalog information relating to a collection of eligible loyalty points redemption items that are eligible for redemption by customers for the identified loyalty points redemption program, the catalog information including item detail information corresponding to the items in the collection of eligible loyalty points redemption items;
(v) displaying assembled catalog information relating to the collection of eligible loyalty points redemption items via the customer electronic device;
(vi) receiving user input via the customer electronic device corresponding to selection of a redemption item in the collection;
(vii) in response to selection from displayed catalog information of a redemption item in the collection, obtaining item detail information and displaying the item detail information corresponding to the selected redemption item;
(viii) receiving user input corresponding to purchase of the selected redemption item;
(ix) displaying (a) item availability information including an instore pickup delivery method from a particular supplier as at least one option and (b) the available loyalty points balance of the customer in the identified loyalty points redemption program, and (c) the applicable loyalty points price for the selected redemption item;
(x) in response to selection of an instore pickup delivery method for the selected redemption item via user input, determining one or more locations for instore pickup of the selected redemption item from the particular supplier and displaying at least one supplier store location for instore pickup of the selected redemption item;
(xi) in response to user input indicating confirmation by the customer of a transaction for instore pickup of the selected redemption item at the selected supplier store location at the applicable loyalty points price and a selection of a number of available loyalty points in the loyalty points balance of the customer to apply against the applicable loyalty points price, communicating an instore pickup transaction with the selected supplier indicating selected instore pickup of the selected redemption item at the selected store location;
(xii) in response to a communication from the selected supplier indicating an acknowledgement that the instore pickup transaction was processed successfully, communicating an order placed transaction to the LPPS including information indicating the selected number of available loyalty points applied to the applicable loyalty points price;
(xiii) in response to a communication from the selected supplier indicating that the selected redemption item is ready for instore pickup at the selected store location, providing item pickup instructions information to the customer;
(xiv) in response to a communication from the supplier that the selected redemption item has been picked up by the customer at the selected store location, providing order complete information to the customer,
whereby the LPPS is enabled to update the loyalty points balance of the customer to reflect redemption of the selected number of loyalty points of the customer for the selected redemption item.

2. The method of claim 1, wherein the method involves communicating with a plurality of suppliers of eligible redemption items, and wherein the collection of eligible loyalty points redemption items provided in the online catalog is dispersed among the plurality of suppliers.

3. The method of claim 1, further comprising the step, prior to displaying item availability information, determining availability of items in the collection of eligible loyalty points redemption items.

4. The method of claim 1, wherein a system that effects the method is maintained independently of a loyalty points provider system (LPPS).

5. The method of claim 1, wherein a system that effects the method is integrated with a loyalty points provider system (LPPS).

6. The method of claim 1, wherein the method effects the redemption of loyalty points maintained in a plurality of loyalty points redemption programs.

7. The method of claim 6, wherein a loyalty points provider maintains a plurality of loyalty points programs via its loyalty points provider system.

8. The method of claim 6, wherein the plurality of loyalty points redemption programs is maintained by a plurality of loyalty points providers.

9. The method of claim 1, wherein the item detail information includes information indicating the availability of an item from a supplier.

10. The method of claim 9, wherein the availability information comprises information indicating that a redemption item is (a) available for instore pickup only, (b) available for shipment only, or (c) available for both instore pickup and for shipment.

11. The method of claim 1, wherein the item detail information includes information identifying a plurality of suppliers for an item.

12. The method of claim 1, further comprising the step of maintaining customer data in a database, and wherein the customer data in the database includes a loyalty points account balance of a customer with a loyalty points redemption program of a loyalty points provider.

13. The method of claim 12, further comprising the step of communicating with a loyalty points provider system (LPPS) of a loyalty points provider to obtain a current loyalty points account balance and other customer data for a customer, in response to a predetermined condition.

14. The method of claim 13, wherein the other customer data includes data selected from the group comprising: customer name, address, telephone number, email address, zip code.

15. The method of claim 13, wherein the predetermined condition is selected from the group comprising: a periodic updating interval, on demand by the customer, in response to selection of an item by a customer, at the beginning of an online session with a customer.

16. The method of claim 12, wherein the customer data includes a customer identifier for each customer, and wherein information relating to the login of the customer is used to determine the customer identifier for the customer.

17. The method of claim 16, wherein the customer identifier is used to associate a particular customer with a particular loyalty points redemption program.

18. The method of claim 16, wherein the customer identifier is used to associate a particular customer with a particular loyalty points provider.

19. The method of claim 1, further comprising the step of providing for customer selection of a particular loyalty points redemption program of a plurality of loyalty points redemption programs maintained on behalf of a customer.

20. The method of claim 1, further comprising the step of communicating with a LPPS for an identified loyalty points redemption program to retrieve a loyalty points account balance and predefined customer data associated with the customer as maintained by the LPPS.

21. The method of claim 20, wherein the LPMS is further operative to store a retrieved loyalty points account balance and said predefined customer data in a database in association with a customer identifier.

22. The method of claim 20, further comprising the step of receiving information provided by an LPPS indicating a change in a loyalty points account balance on behalf of a particular customer.

23. The method of claim 22, further comprising the step of updating a prestored loyalty points account balance and said predefined customer data stored in the database in response to information from an LPSS indicating a change in a loyalty points account balance or other predefined customer data on behalf of the particular customer.

24. The method of 1, further comprising the steps of identifying a supplier associated with an identified loyalty points redemption program, and assembling catalog information relating to a collection of eligible loyalty points redemption items from the identified supplier.

25. The method of claim 24, wherein the step of identifying a supplier comprises identifying a particular one of a plurality of suppliers associated with an identified loyalty points redemption program.

26. The method of claim 1, further comprising the steps of (a) receiving updated information from a supplier relating to the collection of eligible loyalty points redemption items available from the supplier and (b) storing the updated information in a database, thereby providing a dynamically updated catalog of available redemption items.

27. The method of claim 1, further comprising the step of receiving user input corresponding to a customer-selected secondary payment method for use in satisfying the portion of the applicable loyalty points price of the selected redemption item remaining after applying the selected number of available loyalty points in the loyalty points balance of the customer against the applicable loyalty points price

28. The method of claim 1, wherein the order complete transaction includes information identifying the selected redemption item.

29. The method of claim 1, further comprising the step of displaying a selectable delivery method for each item in the collection of eligible loyalty points redemption items, and determining a loyalty points price for items in the collection as a function of the delivery methods available for each item.

30. The method of claim 1, further comprising the step of communicating a real-time query to the supplier to determine the availability of instore pickup eligibility and available locations for a selected item, as part determining a location for instore pickup.

31. The method of claim 1, further comprising the step of displaying order status information to the customer.

32. The method of claim 31, wherein the order status information comprises one or more from the following group: information indicating that the order has been placed, information relating to availability or unavailability, information relating to price of the item, incomplete order information, and information relating to current stage of processing or delivery.

33. The method of claim 1, further comprising the step of, in response to user input by the customer corresponding to selection of a redemption item in the collection, communicating with the supplier of the selected redemption item to determine availability of the selected redemption item in the inventory of the supplier and at least one location for instore pickup of the selected redemption item from the supplier.

34. The method of claim 1, further comprising the step of providing a user interface for a customer using a wireless mobile device such as a smartphone, and wherein the user input is provided via the customer's wireless mobile device at the point-of-sale within a store for potential for real-time pickup of the selected redemption item.

35. The method of claim 34, wherein the wireless mobile device includes a data entry device, and further comprising the steps of receiving data input from the data entry device when used by a customer in a store corresponding to a particular product in the store, and determining whether the particular product is available for immediate instore pickup as a redemption item.

36. The method of claim 35, wherein the data entry device comprises a camera or scanner or bar code reader or similar point-of-sale (POS) product identification input device.

37. The method of claim 35, further comprising the step of utilizing the data input corresponding to a particular product in the store to determine whether the store is associated with a supplier that is associated with an identified loyalty points redemption program for the customer, to process the redemption order if the supplier that is associated with an identified loyalty points program for the customer, and displaying an appropriate “not available from this supplier” message to the customer in the event that the supplier that is not associated with an identified loyalty points program for the customer.

38. The method of claim 34, wherein the wireless mobile device includes a location detection device (such as GPS) that provides location information as to the real-time location of a customer using the mobile device, and
further comprising the step of receiving location information from the customer's mobile device to determine and display via the user interface the location of at least one store of a supplier that has the selected item available.

39. The method of claim 1, further comprising the steps of displaying a “Check Availability” user input control, and, in response to user selection of the “Check Availability” user input control in connection with a selected item, determining one or more locations of a store associated with the supplier at which the customer may have instore pickup of the item.

40. The method of claim 1, further comprising the step of applying predetermined business rules to affect the display of information to the customer and the manner and sequence of communications with the customer, a loyalty points provider system (LPPS), and the supplier system.

41. The method of claim 40, wherein the predetermined business rules determine the proper item and points price for presentment to the customer when a single item is available through more than one supplier within an eligible catalog.

42. The method of claim 1, further comprising the step of providing a shopping cart functionality on behalf of the customer that facilitates display of information relating to eligible loyalty points redemption items and selection of one or more items for redemption utilizing available loyalty points alone or in combination with other forms of payment.

43. The method of claim 1, further comprising the step of maintaining an LPMS database in the LPMS storing information corresponding to data items selected from the group comprising: a catalog table for catalog data, a catalog presentment table, a merchant/supplier table, a loyalty points conversion table, a merchant eligibility table, a customer table for customer data, an order history table.

44. The method of claim 43, wherein the catalog table comprises item detail information relating to a plurality of eligible loyalty points redemption items selected from the group comprising item name, item SKU, supplier, subcategory, item price, item description, review rating, and instore pickup availability.

45. The method of claim 43, wherein the step of assembling catalog information comprises selecting particular information from the catalog table for inclusion in the catalog presentment table as a function of predetermined business rules that affect the display of redemption items.

46. The method of claim 43, wherein the catalog presentment table comprises the assembled catalog information.

47. The method of claim 43, wherein the assembled catalog information comprises price information relating to items in the collection of eligible loyalty points redemption items expressed in terms of loyalty points in the customer's loyalty points program.

48. The method of claim 43, wherein the catalog presentment table comprises information relating to the selection of information provided to a customer on behalf of a particular loyalty program provider selected from the group comprising: loyalty program provider identifier, a loyalty program provider name, a loyalty points program name, a tier identifier, a loyalty points program identifier, a display filter, and a method of delivery.

49. The method of claim 48, wherein the display filter comprises information for modifying the information displayed in connection with the catalog information as a function of predetermined business rules maintained by the LPMS.

50. The method of claim 49, wherein the predetermined business rules are determined by a business rules user interface exposed for use by persons designated by an operator of the LPMS.

51. The method of claim 1, further comprising the step of maintaining a loyalty points conversion table for storing loyalty points conversion values for converting loyalty points of a particular loyalty points provider into an exchange currency.

52. The method of claim 51, further comprising the step of accessing the loyalty points conversion table to obtain the loyalty points conversion value for an identified loyalty points redemption program and determining an applicable loyalty points price for the selected redemption item in terms of loyalty points for the selected redemption item.

53. The method of claim 51, wherein the assembled catalog information includes the applicable loyalty points price for the selected redemption item.

54. The method of claim 51, wherein the applicable loyalty points price for a selected redemption item is determined by a predetermined condition including but not limited to selection of an item that is initially displayed with a price expressed in a currency other than a loyalty points price.

55. The method of claim 1, further comprising the step of maintaining a merchant eligibility table for storing information relating a particular supplier of redemption items to one or more loyalty points programs.

56. The method of claim 1, further comprising the step of maintaining an order history table for storing transaction information relating to transactions with suppliers, transactions with loyalty program providers, and customers.

57. The method of claim 1, further comprising the steps of displaying one loyalty points price for the selected item in the event of selection by the customer of an instore pickup delivery method, and displaying a different loyalty points price in the event of selection of another method of delivery of the selected item.

58. The method of claim 1, wherein information is communicated to the customer via a method selected from the group comprising: display on the customer's electronic device, display on a web site associated with the loyalty points provider, display on a web site associated with the LPMS, text message, email.

59. The method of claim 1, wherein communications between the LPMS and the supplier involve one or more of the following: Application Programming Interfaces (API's), email messages, and text messages.

60. An online system for effecting the redemption of loyalty points maintained in a loyalty points redemption program by a loyalty points provider to a customer via the display, selection, and acquisition of loyalty points redemption items through an online catalog of predetermined eligible redemption items available from a supplier, comprising:
(a) a loyalty points management system (LPMS), comprising:
(i) a catalog module for managing catalog information stored in a loyalty point management system (LPMS) database corresponding to a collection of eligible loyalty points redemption items that are eligible for redemption by customers in a loyalty points redemption program maintained by a loyalty points provider;
(ii) a transactions module for generating and communicating electronic transactions with a loyalty points provider system (LPPS) operated by the loyalty points provider, generating and communicating electronic transactions with customers to access, view, and utilize their loyalty points account balances in the loyalty points provider system (LPPS), and generating and communicating transactions with a supplier system associated with a supplier of redemption items;
(iii) a user interface (UI) module for providing a user interface (UI) to customers via networked communications to customers' electronic devices and a command component for receiving user input provided by a customers' electronic devices; and
(iv) an LPMS database for storing data corresponding to:
(A) a catalog of eligible loyalty points redemption items including item detail information comprising at least price information and delivery method availability information;
(B) customer data corresponding to customer information and a relationship of a customer to at least one loyalty points provider; and
(C) customer transactions data;
(b) the LPMS operative to:
(i) in response to login of a customer to the LPMS via a networked customer electronic device, access the customer data to identify a loyalty points redemption program that is maintained by a loyalty points provider on behalf of the customer;
(ii) invoke the UI module to generate the user interface (UI) to the customer electronic device, the UI providing a display of the loyalty points account balance for the identified loyalty points redemption program as maintained by a loyalty points provider system (LPPS) on behalf of the customer;
(iii) invoke the catalog module to access the LPMS database and assemble catalog information relating to a collection of eligible loyalty points redemption items that are eligible for redemption by customers for the identified loyalty points redemption program, the catalog information including item detail information corresponding to the items in the collection of eligible loyalty points redemption items;
(iv) invoke the UI module to display assembled catalog information relating to the collection of eligible loyalty points redemption items via the customer electronic device and to receive user input corresponding to selection of an available redemption item in the collection;
(v) in response to selection from displayed catalog information via user input of an eligible loyalty points redemption item, invoke the catalog module to access the LPMS database to obtain item detail information and invoke the UI module to display the item detail information corresponding to the selected redemption item;
(vi) receive user input corresponding to purchase of the selected redemption item;
(vii) invoke the UI module to display (a) item availability information including an instore pickup delivery method from a particular supplier as at least one option and (b) the available loyalty points balance of the customer in the identified loyalty points redemption program, and
(c) the applicable loyalty points price for the selected redemption item;
(viii) in response to selection of an instore pickup delivery method for the selected redemption item via user input, determine one or more locations for instore pickup of the selected redemption item from the particular supplier and invoke the UI module to display at least one supplier store location for instore pickup of the selected redemption item;
(ix) in response to user input indicating confirmation by the customer of a transaction for instore pickup of the selected redemption item at the selected supplier store location at the applicable loyalty points price and a selection of a number of available loyalty points in the loyalty points balance of the customer to apply against the applicable loyalty points price, invoke the transactions module to communicate an instore pickup transaction with the selected supplier indicating selected instore pickup of the selected redemption item at the selected store location;
(x) in response to communication from the selected supplier indicating an acknowledgement that the instore pickup transaction was successfully processed, invoke the transactions module to transmit a transaction placed communication to the LPPS including information indicating the selected number of available loyalty points applied to the applicable loyalty points price;
(xi) in response to a communication from the selected supplier indicating that the selected redemption item is ready for instore pickup at the selected store location, invoke the UI to provide instore pickup instruction information to the customer;
(xii) in response to a communication from the supplier that the selected redemption item has been picked up by the customer at the selected store location, invoke the UI to provide item pickup confirmation information to the customer,
whereby the LPPS is enabled to update the loyalty points balance of the customer to reflect redemption of the selected number of loyalty points of the customer for the selected redemption item.

61. The system of claim 60, wherein the system communicates with a plurality of suppliers of eligible redemption items, and wherein the collection of eligible loyalty points redemption items provided in the online catalog is dispersed among the plurality of suppliers.

62. The system of claim 60, wherein prior to displaying item availability the LPMS is further operative to determine availability of items in the collection of eligible loyalty points redemption items.

63. The system of claim 60, wherein the system is maintained independently of a loyalty points provider system (LPPS).

64. The system of claim 60, wherein the system is integrated with a loyalty points provider system (LPPS).

65. The system of claim 60, wherein the system effects the redemption of loyalty points maintained in a plurality of loyalty points redemption programs.

66. The system of claim 65, wherein a loyalty points provider maintains a plurality of loyalty points programs via its loyalty points provider system.

67. The system of claim 65, wherein the plurality of loyalty points redemption programs is maintained by a plurality of loyalty points providers.

68. The system of claim 60, wherein the item detail information includes information indicating the availability of an item from a supplier.

69. The system of claim 68, wherein the availability information comprises information indicating that a redemption item is (a) available for instore pickup only, (b) available for shipment only, or (c) available for both instore pickup and for shipment.

70. The system of claim 60, wherein the item detail information includes information identifying a plurality of suppliers for an item.

71. The system of claim 60, wherein the customer data in the LPMS database includes a loyalty points account balance of a customer with a loyalty points redemption program of a loyalty points provider.

72. The system of claim 71, wherein the LPMS is further operative to invoke the transaction module to communicate with a loyalty points provider system (LPPS) of a loyalty points provider to obtain a current loyalty points account balance and other customer data for a customer, in response to a predetermined condition.

73. The system of claim 72, wherein the other customer data includes data selected from the group comprising: customer name, address, telephone number, email address, zip code.

74. The system of claim 72, wherein the predetermined condition is selected from the group comprising: a periodic updating interval, on demand by the customer, in response to selection of an item by a customer, at the beginning of an online session with a customer.

75. The system of claim 60, wherein the customer data in the LPMS database includes a customer identifier for each customer, and wherein information relating to the login of the customer is used to determine the customer identifier for the customer.

76. The system of claim 75, wherein the customer identifier is used to associate a particular customer with a particular loyalty points redemption program.

77. The system of claim 75, wherein the customer identifier is used to associate a particular customer with a particular loyalty points provider.

78. The system of claim 60, the UI module provides for selection of a particular loyalty points redemption program of a plurality of loyalty points redemption programs maintained on behalf of a customer.

79. The system of claim 60, wherein the LPMS is further operative to invoke the transactions module to communicate with a LPPS for an identified loyalty points redemption program to retrieve a loyalty points account balance and predefined customer data associated with the customer as maintained by the LPPS.

80. The system of claim 79, wherein the LPMS is further operative to store a retrieved loyalty points account balance and said predefined customer data in the LPMS database in association with a customer identifier.

81. The system of claim 79, wherein the LPMS is further operative to receive information provided by an LPPS indicating a change in a loyalty points account balance on behalf of a particular customer.

82. The system of claim 81, wherein the LPMS is further operative to update a prestored loyalty points account balance and said predefined customer data stored in the LPMS database in response to information from an LPSS indicating a change in a loyalty points account balance or other predefined customer data on behalf of the particular customer.

83. The system of 60, wherein the LPMS is further operative to identify a supplier associated with an identified loyalty points redemption program, and to invoke the catalog module to access the LPMS database and assemble catalog information relating to a collection of eligible loyalty points redemption items from the identified supplier.

84. The system of claim 83, wherein the LPMS is further operative to identify a plurality of suppliers associated with an identified loyalty points redemption program, and to invoke the catalog module to access the LPMS database and assemble catalog information relating to a collection of eligible loyalty points redemption items available through the plurality of identified suppliers.

85. The system of claim 60, wherein the LPMS is further operative to invoke the transaction module to (a) receive updated information from a supplier relating to the collection of eligible loyalty points redemption items available from the supplier and (b) store the updated information in the LPMS database, thereby providing a dynamically updated catalog of available redemption items.

86. The system of claim 60, wherein the LPMS is further operative to invoke the UI to receive user input corresponding to a customer-selected secondary payment method for use in satisfying the portion of the applicable loyalty points price of the selected redemption item remaining after applying the selected number of available loyalty points in the loyalty points balance of the customer against the applicable loyalty points price

87. The system of claim 60, wherein the order complete transaction includes information identifying the selected redemption item.

88. The system of claim 60, wherein the LPMS is further operative to invoke the UI to display a selectable delivery method for each item in the collection of eligible loyalty points redemption items, and to determine a loyalty points price for items in the collection as a function of the delivery methods available for each item.

89. The system of claim 60, wherein the LPMS is further operative to invoke the transactions module to communicate a real-time query to the supplier to determine the availability of instore pickup eligibility and available locations for a selected item, as part of the operation to determine a location for instore pickup.

90. The system of claim 60, wherein the LPMS is further operative to invoke the UI module to display order status information and item pickup information to the customer.

91. The system of claim 90, wherein the LPMS is further operative to receive an order fulfillment message from the supplier in response to successful instore pickup of the selected redemption item at the selected store of the supplier, and to display updated order status information to the customer indicating successful instore pickup of the selected redemption item.

92. The system of claim 60, wherein the LPMS is further operative in response to user input by the customer corresponding to selection of an available redemption item in the collection, to invoke the transaction module to communicate with the supplier of the selected redemption item to determine availability of the selected redemption item in the inventory of the supplier and at least one location for instore pickup of the selected redemption item from the supplier.

93. The system of claim 60, wherein the UI module provides a user interface for a customer using a wireless mobile device such as a smartphone, and wherein the user input is provided via the customer's wireless mobile device at the point-of-sale within a store for potential for real-time pickup of the selected redemption item.

94. The system of claim 93, wherein the wireless mobile device includes a data entry device, and wherein the UI module is operative to receive data input from the data entry device when used by a customer in a store corresponding to a particular product in the store, and the catalog module is operative to determine whether the particular product is available for immediate instore pickup as a redemption item.

95. The system of claim 94, wherein the data entry device comprises a camera or scanner or bar code reader or similar point-of-sale (POS) product identification input device.

96. The system of claim 94, wherein LPMS is further operative to utilize the data input corresponding to a particular product in the store to determine whether the store is associated with a supplier that is associated with an identified loyalty points redemption program for the customer, to process the redemption order if the supplier that is associated with an identified loyalty points program for the customer, and to display an appropriate “not available from this supplier” message to the customer in the event that the supplier that is not associated with an identified loyalty points program for the customer.

97. The system of claim 93, wherein the wireless mobile device includes a location detection device (such as GPS) that provides location information as to the real-time location of a customer using the mobile device, and
wherein the LPMS is operative to receive location information from the customer's mobile device to determine and display via the user interface the location of at least one store of a supplier that has the selected item available.

98. The system of claim 60, wherein the UI module is operative to display a “Check Availability” user input control, and wherein the LPMS is operative in response to user selection of the “Check Availability” user input control in connection with a selected item to determine one or more locations of a store associated with the supplier at which the customer may have instore pickup of the item.

99. The system of claim 60, further comprising a business rules engine in the LPMS, the business rules engine operative to apply predetermined business rules that affect the display of information to the customer via the user interface and the manner and sequence of communications with the customer, a loyalty points provider system (LPPS), and the supplier system.

100. The system of claim 99, wherein the LPMS can apply a plurality of business rules to determine the proper item and points price for presentment to the customer when a single item is available through more than one supplier within an eligible catalog.

101. The system of claim 60, wherein the LPMS is further operative to provide a shopping cart functionality on behalf of the customer that facilitates display of information relating to eligible loyalty points redemption items and selection of one or more items for redemption utilizing available loyalty points alone or in combination with other forms of payment.

102. The system of claim 60, wherein the LPMS database stores information corresponding to data items selected from the group comprising: a catalog table for catalog data, a catalog presentment table, a merchant/supplier table, a loyalty points conversion table, a merchant eligibility table, a customer table for customer data, an order history table.

103. The system of claim 102, wherein the catalog table comprises item detail information relating to a plurality of eligible loyalty points redemption items selected from the group comprising item name, item SKU, supplier, subcategory, item price, item description, review rating, and instore pickup availability.

104. The system of claim 102, wherein the catalog module is operative for selecting particular information from the catalog table for inclusion in the catalog presentment table as a function of predetermined business rules that affect the display of redemption items.

105. The system of claim 102, wherein the catalog presentment table comprises the assembled catalog information.

106. The system of claim 102, wherein the assembled catalog information comprises price information relating to items in the collection of eligible loyalty points redemption items expressed in terms of loyalty points in the customer's loyalty points program.

107. The system of claim 102, wherein the catalog presentment table comprises information relating to the selection of information provided to a customer on behalf of a particular loyalty program provider selected from the group comprising: loyalty program provider identifier, a loyalty program provider name, a loyalty points program name, a tier identifier, a loyalty points program identifier, a display filter, and a method of delivery.

108. The system of claim 107, wherein the display filter comprises information for modifying the information displayed in connection with the catalog information as a function of predetermined business rules maintained by the LPMS.

109. The system of claim 108, wherein the predetermined business rules are determined by a business rules user interface exposed for use by persons designated by an operator of the LPMS.

110. The system of claim 60, wherein the LPMS database further includes a loyalty points conversion table for storing loyalty points conversion values for converting loyalty points of a particular loyalty points provider into an exchange currency.

111. The system of claim 110, wherein the LPMS is operative to access the loyalty points conversion table to obtain the loyalty points conversion value for an identified loyalty points redemption program and determine an applicable loyalty points price for the selected redemption item in terms of loyalty points for the selected redemption item.

112. The system of claim 110, wherein the assembled catalog information includes the applicable loyalty points price for the selected redemption item.

113. The system of claim 110, wherein the applicable loyalty points price for a selected redemption item is determined by a predetermined condition including but not limited to selection of an item that is initially displayed with a price expressed in a currency other than a loyalty points price.

114. The system of claim 60, wherein the LPMS database further includes a merchant eligibility table for storing information relating a particular supplier of redemption items to one or more loyalty points programs.

115. The system of claim 60, wherein the LPMS database further includes an order history table for storing transaction information relating to transactions with suppliers, transactions with loyalty program providers, and customers.

116. The system of claim 60, wherein the LPMS is operative to display one loyalty points price for the selected item in the event of selection by the customer of an instore pickup delivery method, and display a different loyalty points price in the event of selection of another method of delivery of the selected item.

117. The system of claim 60, wherein the information is communicated to the customer via a method selected from the group comprising: display on the customer's electronic device, display on a web site associated with the loyalty points provider, display on a web site associated with the LPMS, text message, email.

118. The system of claim 60, wherein communications between the LPMS and the supplier involve one or more of the following: Application Programming Interfaces (API's), email messages, and text messages.

119. A method for effecting the redemption of loyalty points maintained in a networked computer-based loyalty points redemption program by a loyalty points provider to a customer via the display, selection, and acquisition of loyalty points redemption items through an online catalog of predetermined eligible redemption items available from one or more suppliers, comprising the steps of:
(i) providing a network-accessible, computer-based loyalty points management system (LPMS) for communications with a loyalty points provider system (LPPS) operated by one or more loyalty points providers and with a system operated by one or more suppliers of redemption items;
(ii) maintaining a catalog in the (LPMS), the catalog comprising information relating to a collection of eligible loyalty points redemption items that may be selected for redemption by customers in a loyalty points redemption program maintained by a loyalty points provider;
(iii) identifying a loyalty points redemption program that is maintained by a loyalty points provider on behalf of a customer;
(iv) generating a user interface (UI) to the customer electronic device, the UI providing a display of the loyalty points account balance for the identified loyalty points redemption program as maintained by the LPPS on behalf of the customer;
(v) assembling catalog information relating to a collection of eligible loyalty points redemption items from which items may be selected for redemption by customers for the identified loyalty points redemption program;
(vi) providing a set of predetermined business rules in the LPMS that affect the display of information to customers and communications of the LPMS to the customers, loyalty points provider systems (LPPS), and supplier systems;
(vii) selecting a subset of items for display to a customer as function of an identified loyalty points program and predetermined business rules applicable to the identified loyalty points program;
(viii) displaying assembled catalog information relating to the subset of items via the customer electronic device;
(ix) receiving user input via the customer electronic device corresponding to purchase of the selected redemption item;
(x) displaying (a) item availability information, (b) the available loyalty points balance of the customer in the identified loyalty points redemption program, and (c) the applicable loyalty points price for the selected redemption item;
(xi) in response to user input indicating confirmation by the customer of a transaction to obtain the selected redemption item at the applicable loyalty points price and a selection of a number of available loyalty points in the loyalty points balance of the customer to apply against the applicable loyalty points price, communicating a purchase transaction with a supplier of the selected redemption item;
(xii) in response to a communication from the supplier that the selected redemption item has been delivered to the customer via instore pickup or shipment, providing item delivery confirmation information to the customer; and
(xiii) providing an order complete transaction to the LPPS including information indicating the selected number of available loyalty points applied to the applicable loyalty points price,
whereby the LPPS is enabled to update the loyalty points balance of the customer to reflect redemption of the selected number of loyalty points of the customer for the selected redemption item.
